(19) United States
(12) Patent Application Publication
(10) Pub. No.: US 2020/0363112 A1
(43) Pub. Date: Nov. 19, 2020

(54) AIR CONDITIONER

(71) Applicant: DAIKIN INDUSTRIES, LTD., Osaka (JP)

(72) Inventors: Keisuke Ohtsuka, Osaka (JP); Mitsushi Itano, Osaka (JP); Daisuke Karube, Osaka (JP); Yuuki Yotsumoto, Osaka (JP); Kazuhiro Takahashi, Osaka (JP); Yuzo Kamatsu, Osaka (JP); Shun Ohkubo, Osaka (JP); Tatsuya Takakuwa, Osaka (JP); Tetsushi Tsuda, Osaka (JP)

(73) Assignee: DAIKIN INDUSTRIES, LTD., Osaka (JP)

(21) Appl. No.: 16/913,454

(22) Filed: Jun. 26, 2020

Related U.S. Application Data
(63) Continuation-in-part of application No. 16/772,961.

(30) Foreign Application Priority Data
Dec. 18, 2017 (JP) 2017-242183
Dec. 18, 2017 (JP) 2017-242185
Dec. 18, 2017 (JP) 2017-242186
Dec. 18, 2017 (JP) 2017-242187
Oct. 5, 2018 (JP) PCT/JP2018/037483
Oct. 17, 2018 (JP) PCT/JP2018/038746
Oct. 17, 2018 (JP) PCT/JP2018/038747
Oct. 17, 2018 (JP) PCT/JP2018/038748
Oct. 17, 2018 (JP) PCT/JP2018/038749

(51) Int. Cl. F25B 49/02; C09K 5/04; F24F 11/88

(52) U.S. Cl. CPC F25B 49/025; F25B 2600/02; F24F 11/88; C09K 5/045

(57) ABSTRACT

In an air conditioner that uses a refrigerant mixture containing at least 1,2-difluoroethylene, high efficiency is achieved. In the air conditioner (1), a compressor (100, 200) can be driven without interposing a power conversion device between an AC power source (90, 190) and a motor (70, 170). Thus, it is possible to provide the air conditioner (1) that is environmentally friendly and has a relatively inexpensive configuration.

### TECHNICAL FIELD

The present invention relates to an air conditioner that uses refrigerant with a low global warming potential (GWP).

### BACKGROUND ART

In recent years, use of refrigerant with a low GWP (hereinafter referred to as low-GWP refrigerant) in air conditioners has been considered from the viewpoint of environmental protection. A dominant example of low-GWP refrigerant is a refrigerant mixture containing 1,2-difluoroethylene.

### SUMMARY OF THE INVENTION

### Technical Problem

However, the related art giving consideration from the aspect of increasing the efficiency of air conditioners using the foregoing refrigerant is rarely found. For example, in the case of applying the foregoing refrigerant to the air conditioner disclosed in PTL 1 (Japanese Unexamined Patent Application Publication No. 2013-124848), there is an issue of how to achieve high efficiency.

### Solution to Problem

An air conditioner according to a first aspect includes a compressor that compresses a refrigerant mixture containing at least 1,2-difluoroethylene, a motor that drives the compressor, and a connection unit that causes power to be supplied from an alternating-current (AC) power source to the motor without frequency conversion.

In the air conditioner that uses a refrigerant mixture containing at least 1,2-difluoroethylene, the compressor can be driven without interposing a power conversion device between the AC power source and the motor. Thus, it is possible to provide the air conditioner that is environmentally friendly and has a relatively inexpensive configuration.

An air conditioner according to a second aspect is the air conditioner according to the first aspect, in which the connection unit directly applies an AC voltage of the AC power source between at least two terminals of the motor.

An air conditioner according to a third aspect is the air conditioner according to the first aspect or the second aspect, in which the AC power source is a single-phase power source.

An air conditioner according to a fourth aspect is the air conditioner according to any one of the first aspect to the third aspect, in which one terminal of the motor is connected in series to an activation circuit.

An air conditioner according to a fifth aspect is the air conditioner according to the fourth aspect, in which the activation circuit is a circuit in which a positive temperature coefficient thermistor and an operation capacitor are connected in parallel to each other.

In the air conditioner that uses a refrigerant mixture containing at least 1,2-difluoroethylene, after the compressor has been activated, the PTC thermistor self-heats and the resistance value thereof increases, and switching to an operation circuit substantially by the operation capacitor occurs. Thus, the compressor enters a state of being capable of outputting a rated torque at appropriate timing.

An air conditioner according to a sixth aspect is the air conditioner according to the first aspect or the second aspect, in which the AC power source is a three-phase power source.

This air conditioner does not require an activation circuit and thus the cost is relatively low.

An air conditioner according to a seventh aspect is the air conditioner according to any one of the first aspect to the sixth aspect, in which the motor is an induction motor.

In this air conditioner, the motor is capable of high output with relatively low cost, and thus the efficiency of the air conditioner can be increased.
An air conditioner according to a eighth aspect is the air conditioner according to any of the first through seventh aspects, wherein, the refrigerant comprises trans-1,2-difluoroethylene (HFO-1132(E)), trifluoroethylene (HFO-1123), and 2,3,3,3-tetrafluoro-1-propene (R1234yf).

In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) and a coefficient of performance (COP) equal to those of R410A is used.
An air conditioner according to a ninth aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line segments BD, CO, and OA);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.
An air conditioner according to a tenth aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments GI, IA, AA′, A′B, BD, DC′, C′C, and CG that connect the following 8 points:
   point G (72.0, 28.0, 0.0),
   point I (72.0, 0.0, 28.0),
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments IA, BD, and CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.
An air conditioner according to a eleventh aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9
   points:
   point J (47.1, 52.9, 0.0),
   point P (55.8, 42.0, 2.2),
   point N (68.6, 16.3, 15.1),
   point K (61.3, 5.4, 33.3),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments BD and CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.
An air conditioner according to a twelfth aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9
   points:
   point J (47.1, 52.9, 0.0),
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segments BD and CJ);
the line segment PL is represented by coordinates (x, −0.1135x²+12.112x−280.43, 0.1135x²−13.112x+380.43)
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.
An air conditioner according to a thirteenth aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.
An air conditioner according to a fourteenth aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
   point P (55.8, 42.0, 2.2),
   point L (63.1, 31.9, 5.0),
   point Q (62.8, 29.6, 7.6), and
   point R (49.8, 42.3, 7.9),
   or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.
An air conditioner according to a fifth aspect is the air conditioner according to the eighth aspect, wherein, when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
   point S (62.6, 28.3, 9.1),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.
An air conditioner according to a sixth aspect is the air conditioner according to any of the 1 through seventh aspects, wherein, the refrigerant comprises trans-1,2-difluoroethylene (HFO-1132(E)) and trifluoroethylene (HFO-1123) in a total amount of 99.5 mass % or more based on the entire refrigerant, and
the refrigerant comprises 62.0 mass % to 72.0 mass % of HFO-1132(E) based on the entire refrigerant.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) and a coefficient of performance (COP) equal to those of R410A and classified with lower flammability (Class 2L) in the standard of The American Society of Heating, Refrigerating and Air-Conditioning Engineers (ASHRAE) is used.
An air conditioner according to a seventeenth aspect is the air conditioner according to any of the first through seventh aspects, wherein, the refrigerant comprises HFO-1132(E) and HFO-1123 in a total amount of 99.5 mass % or more based on the entire refrigerant, and
the refrigerant comprises 45.1 mass % to 47.1 mass % of HFO-1132(E) based on the entire refrigerant.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) and a coefficient of performance (COP) equal to those of R410A and classified with lower flammability (Class 2L) in the standard of The American Society of Heating, Refrigerating and Air-Conditioning Engineers (ASHRAE) is used.
An air conditioner according to a eighteenth aspect is the air conditioner according to any of the first through seventh aspects, wherein, the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
   wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
   point G (0.026a²−1.7478a+72.0, −0.026a²+0.7478a+28.0, 0.0),
   point I (0.026a²−1.7478a+72.0, 0.0, −0.026a²+0.7478a+28.0),
   point A (0.0134a²−1.9681a+68.6, 0.0, −0.0134a²+0.9681a+31.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
   point G (0.02a²−1.6013a+71.105, −0.02a²+0.6013a+28.895, 0.0),
   point I (0.02a²−1.6013a+71.105, 0.0, −0.02a²+0.6013a+28.895),
   point A (0.0112a²−1.9337a+68.484, 0.0, −0.0112a²+0.9337a+31.516),
   point B (0.0, 0.0075a²−1.5156a+58.199, −0.0075a²+0.5156a+41.801), and
   point W (0.0, 100.0−a, 0.0),
   or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
   point G (0.0135a²−1.4068a+69.727, −0.0135a²+0.4068a+30.273, 0.0),
   point I (0.0135a²−1.4068a+69.727, 0.0, −0.0135a²+0.4068a+30.273),
   point A (0.0107a²−1.9142a+68.305, 0.0, −0.0107a²+0.9142a+31.695),
   point B (0.0, 0.009a²−1.6045a+59.318, −0.009a²+0.6045a+40.682), and
   point W (0.0, 100.0−a, 0.0),
   or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
   point G (0.0111a²−1.3152a+68.986, −0.0111a²+0.3152a+31.014, 0.0),
   point I (0.0111a²−1.3152a+68.986, 0.0, −0.0111a²+0.3152a+31.014),
   point A (0.0103a²−1.9225a+68.793, 0.0, −0.0103a²+0.9225a+31.207),
   point B (0.0, 0.0046a²−1.41a+57.286, −0.0046a²+0.41a+42.714), and
   point W (0.0, 100.0−a, 0.0),
   or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
   point G (0.0061a²−0.9918a+63.902, −0.0061a²−0.0082a+36.098, 0.0),
   point I (0.0061a²−0.9918a+63.902, 0.0, −0.0061a²−0.0082a+36.098),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05), and
   point W (0.0, 100.0−a, 0.0),
   or on the straight lines GI and AB (excluding point G, point I, point A, point B, and point W).
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) and a coefficient of performance (COP) equal to those of R410A is used.
An air conditioner according to a nineteenth aspect is the air conditioner according to any of the first through seventh aspects, wherein, the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
   wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
   point J (0.0049a²−0.9645a+47.1, −0.0049a²−0.0355a+52.9, 0.0),
   point K′ (0.0514a²−2.4353a+61.7, −0.0323a²+0.4122a+5.9, −0.0191a²+1.0231a+32.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
   point J (0.0243a²−1.4161a+49.725, −0.0243a²+0.4161a+50.275, 0.0),
   point K′ (0.0341a²−2.1977a+61.187, −0.0236a²+0.34a+5.636, −0.0105a²+0.8577a+33.177),
   point B (0.0, 0.0075a²−1.5156a+58.199, −0.0075a²+0.5156a+41.801), and
   point W (0.0, 100.0−a, 0.0),
   or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
   point J (0.0246a²−1.4476a+50.184, −0.0246a²+0.4476a+49.816, 0.0),
   point K′ (0.0196a²−1.7863a+58.515, −0.0079a²−0.1136a+8.702, −0.0117a²+0.8999a+32.783),
   point B (0.0, 0.009a²−1.6045a+59.318, −0.009a²+0.6045a+40.682), and
   point W (0.0, 100.0−a, 0.0),
   or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
   point J (0.0183a²−1.1399a+46.493, −0.0183a²+0.1399a+53.507, 0.0),
   point K′ (−0.0051a²+0.0929a+25.95, 0.0, 0.0051a²−1.0929a+74.05),
   point A (0.0103a²−1.9225a+68.793, 0.0, −0.0103a²+0.9225a+31.207),
   point B (0.0, 0.0046a²−1.41a+57.286, −0.0046a²+0.41a+42.714), and
   point W (0.0, 100.0−a, 0.0),
   or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
   point J (−0.0134a²+1.0956a+7.13, 0.0134a²−2.0956a+92.87, 0.0),
   point K′ (−1.892a+29.443, 0.0, 0.892a+70.557),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05), and
   point W (0.0, 100.0−a, 0.0),
   or on the straight lines JK′, K′A, and AB (excluding point J, point B, and point W).
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) and a coefficient of performance (COP) equal to those of R410A is used.
An air conditioner according to a twentieth aspect is the air conditioner according to any of the first through seventh aspects, wherein the refrigerant comprises trans-1,2-difluoroethylene (HFO-1132(E)), difluoromethane (R32), and 2,3,3,3-tetrafluoro-1-propene (R1234yf),
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI;
the line segment IJ is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) equal to those of R410A and classified with lower flammability (Class 2L) in the standard of The American Society of Heating, Refrigerating and Air-Conditioning Engineers (ASHRAE) is used.
An air conditioner according to a twenty-first aspect is the air conditioner according to any of the first through seventh aspects, wherein the refrigerant comprises HFO-1132(E), R32, and R1234yf,
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) equal to those of R410A and classified with lower flammability (Class 2L) in the standard of The American Society of Heating, Refrigerating and Air-Conditioning Engineers (ASHRAE) is used.
An air conditioner according to a twenty-second aspect is the air conditioner according to any of the first through seventh aspects, wherein the refrigerant comprises HFO-1132(E), R32, and R1234yf,
   wherein
when the mass % of HFO-1132(E), R32, and R1234yf based on their sum in the refrigerant is respectively represented by x, y and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) equal to those of R410A and classified with lower flammability (Class 2L) in the standard of The American Society of Heating, Refrigerating and Air-Conditioning Engineers (ASHRAE) is used.
An air conditioner according to a twenty-third aspect is the air conditioner according to any of the first through seventh aspects, wherein the refrigerant comprises HFO-1132(E), R32, and R1234yf,
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) equal to those of R410A and classified with lower flammability (Class 2L) in the standard of The American Society of Heating, Refrigerating and Air-Conditioning Engineers (ASHRAE) is used.
An air conditioner according to a twenty-fourth aspect is the air conditioner according to any of the first through seventh aspects, wherein the refrigerant comprises HFO-1132(E), R32, and R1234yf,
   wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, a refrigeration capacity (may also be referred to as a cooling capacity or a capacity) equal to those of R410A and classified with lower flammability (Class 2L) in the standard of The American Society of Heating, Refrigerating and Air-Conditioning Engineers (ASHRAE) is used.
An air conditioner according to a fifth aspect is the air conditioner according to any of the first through seventh aspects, wherein the refrigerant comprises trans-1,2-difluoroethylene (HFO-1132(E)), trifluoroethylene (HFO-1123), and difluoromethane (R32),
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
   point I (72.0, 28.0, 0.0),
   point K (48.4, 33.2, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, and a coefficient of performance (COP) equal to that of R410A is used.
An air conditioner according to a twenty-sixth aspect is the air conditioner according to any of the first through seventh aspects, wherein the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4 points:
   point I (72.0, 28.0, 0.0),
   point J (57.7, 32.8, 9.5),
   point R (23.1, 67.4, 9.5), and
   point G (38.5, 61.5, 0.0),
   or on these line segments (excluding the points on the line segment GI);
the line segment IJ is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, and a coefficient of performance (COP) equal to that of R410A is used.
An air conditioner according to a twenty-seventh aspect is the air conditioner according to any of the first through seventh aspects, wherein the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
   point M (47.1, 52.9, 0.0),
   point P (31.8, 49.8, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, and a coefficient of performance (COP) equal to that of R410A is used.
An air conditioner according to a twenty-eighth aspect is the air conditioner according to any of the first through seventh aspects, wherein the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
   point M (47.1, 52.9, 0.0),
   point N (38.5, 52.1, 9.5),
   point R (23.1, 67.4, 9.5), and
   point G (38.5, 61.5, 0.0),
   or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z), and
the line segments JR and GI are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, and a coefficient of performance (COP) equal to that of R410A is used.
An air conditioner according to a twenty-ninth aspect is the air conditioner according to any of the first through seventh aspects, wherein the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
   point P (31.8, 49.8, 18.4),
   point S (25.4, 56.2, 18.4), and
   point T (34.8, 51.0, 14.2),
   or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, and a coefficient of performance (COP) equal to that of R410A is used.
An air conditioner according to a thirtieth aspect is the air conditioner according to any of the first through seventh aspects, wherein the refrigerant comprises HFO-1132(E), HFO-1123, and R32,
   wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
   point Q (28.6, 34.4, 37.0),
   point B″ (0.0, 63.0, 37.0),
   point D (0.0, 67.0, 33.0), and
   point U (28.7, 41.2, 30.1),
   or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines.
In the air conditioner that uses a refrigerant mixture containing at least 1,2-difluoroethylene, the compressor can be driven without interposing a power conversion device between the AC power source and the motor. Thus, the air conditioner that is environmentally friendly and has a relatively inexpensive configuration can also be achieved when a refrigerant having a sufficiently low GWP, and a coefficient of performance (COP) equal to that of R410A is used.

### BRIEF DESCRIPTION OF THE DRAWINGS

FIG. 1 is a schematic view of an instrument used for a flammability test.

FIG. 2 is a diagram showing points A to T and line segments that connect these points in a ternary composition diagram in which the sum of HFO-1132(E), HFO-1123, and R1234yf is 100 mass %.

FIG. 3 is a diagram showing points A to C, D′, G, I, J, and K′, and line segments that connect these points to each other in a ternary composition diagram in which the sum of HFO-1132(E), HFO-1123, and R1234yf is (100−a) mass %.

FIG. 4 is a diagram showing points A to C, D′, G, I, J, and K′, and line segments that connect these points to each other in a ternary composition diagram in which the sum of HFO-1132(E), HFO-1123, and R1234yf is 92.9 mass % (the content of R32 is 7.1 mass %).

FIG. 5 is a diagram showing points A to C, D′, G, I, J, K′, and W, and line segments that connect these points to each other in a ternary composition diagram in which the sum of HFO-1132(E), HFO-1123, and R1234yf is 88.9 mass % (the content of R32 is 11.1 mass %).

FIG. 6 is a diagram showing points A, B, G, I, J, K′, and W, and line segments that connect these points to each other in a ternary composition diagram in which the sum of HFO-1132(E), HFO-1123, and R1234yf is 85.5 mass % (the content of R32 is 14.5 mass %).

FIG. 7 is a diagram showing points A, B, G, I, J, K′, and W, and line segments that connect these points to each other in a ternary composition diagram in which the sum of HFO-1132(E), HFO-1123, and R1234yf is 81.8 mass % (the content of R32 is 18.2 mass %).

FIG. 8 is a diagram showing points A, B, G, I, J, K′, and W, and line segments that connect these points to each other in a ternary composition diagram in which the sum of HFO-1132(E), HFO-1123, and R1234yf is 78.1 mass % (the content of R32 is 21.9 mass %).

FIG. 9 is a diagram showing points A, B, G, I, J, K′, and W, and line segments that connect these points to each other in a ternary composition diagram in which the sum of HFO-1132(E), HFO-1123, and R1234yf is 73.3 mass % (the content of R32 is 26.7 mass %).

FIG. 10 is a diagram showing points A, B, G, I, J, K′, and W, and line segments that connect these points to each other in a ternary composition diagram in which the sum of HFO-1132(E), HFO-1123, and R1234yf is 70.7 mass % (the content of R32 is 29.3 mass %).

FIG. 11 is a diagram showing points A, B, G, I, J, K′, and W, and line segments that connect these points to each other in a ternary composition diagram in which the sum of HFO-1132(E), HFO-1123, and R1234yf is 63.3 mass % (the content of R32 is 36.7 mass %).

FIG. 12 is a diagram showing points A, B, G, I, J, K′, and W, and line segments that connect these points to each other in a ternary composition diagram in which the sum of HFO-1132(E), HFO-1123, and R1234yf is 55.9 mass % (the content of R32 is 44.1 mass %).

FIG. 13 is a diagram showing points A, B, G, I, J, K′, and W, and line segments that connect these points to each other in a ternary composition diagram in which the sum of HFO-1132(E), HFO-1123, and R1234yf is 52.2 mass % (the content of R32 is 47.8 mass %).

FIG. 14 is a view showing points A to C, E, G, and I to W; and line segments that connect points A to C, E, G, and I to W in a ternary composition diagram in which the sum of HFO-1132(E), R32, and R1234yf is 100 mass %.

FIG. 15 is a view showing points A to U; and line segments that connect the points in a ternary composition diagram in which the sum of HFO-1132(E), HFO-1123, and R32 is 100 mass %.

FIG. 16 is a configuration diagram of an air conditioner according to one embodiment of the present disclosure.

FIG. 17 is an operation circuit diagram of a motor of a compressor.

FIG. 18 is an operation circuit diagram of a motor of a compressor in an air conditioner according to a modification example.

### DESCRIPTION OF EMBODIMENTS

### (1) Definition of Terms

In the present specification, the term “refrigerant” includes at least compounds that are specified in ISO 817 (International Organization for Standardization), and that are given a refrigerant number (ASHRAE number) representing the type of refrigerant with “R” at the beginning; and further includes refrigerants that have properties equivalent to those of such refrigerants, even though a refrigerant number is not yet given. Refrigerants are broadly divided into fluorocarbon compounds and non-fluorocarbon compounds in terms of the structure of the compounds. Fluorocarbon compounds include chlorofluorocarbons (CFC), hydrochlorofluorocarbons (HCFC), and hydrofluorocarbons (HFC). Non-fluorocarbon compounds include propane (R290), propylene (R1270), butane (R600), isobutane (R600a), carbon dioxide (R744), ammonia (R717), and the like.
In the present specification, the phrase “composition comprising a refrigerant” at least includes (1) a refrigerant itself (including a mixture of refrigerants), (2) a composition that further comprises other components and that can be mixed with at least a refrigeration oil to obtain a working fluid for a refrigerating machine, and (3) a working fluid for a refrigerating machine containing a refrigeration oil. In the present specification, of these three embodiments, the composition (2) is referred to as a “refrigerant composition” so as to distinguish it from a refrigerant itself (including a mixture of refrigerants). Further, the working fluid for a refrigerating machine (3) is referred to as a “refrigeration oil-containing working fluid” so as to distinguish it from the “refrigerant composition.”
In the present specification, when the term “alternative” is used in a context in which the first refrigerant is replaced with the second refrigerant, the first type of “alternative” means that equipment designed for operation using the first refrigerant can be operated using the second refrigerant under optimum conditions, optionally with changes of only a few parts (at least one of the following: refrigeration oil, gasket, packing, expansion valve, dryer, and other parts) and equipment adjustment. In other words, this type of alternative means that the same equipment is operated with an alternative refrigerant. Embodiments of this type of “alternative” include “drop-in alternative,” “nearly drop-in alternative,” and “retrofit,” in the order in which the extent of changes and adjustment necessary for replacing the first refrigerant with the second refrigerant is smaller.
The term “alternative” also includes a second type of “alternative,” which means that equipment designed for operation using the second refrigerant is operated for the same use as the existing use with the first refrigerant by using the second refrigerant. This type of alternative means that the same use is achieved with an alternative refrigerant.
In the present specification, the term “refrigerating machine” refers to machines in general that draw heat from an object or space to make its temperature lower than the temperature of ambient air, and maintain a low temperature. In other words, refrigerating machines refer to conversion machines that gain energy from the outside to do work, and that perform energy conversion, in order to transfer heat from where the temperature is lower to where the temperature is higher.
In the present specification, a refrigerant having a “WCF lower flammability” means that the most flammable composition (worst case of formulation for flammability: WCF) has a burning velocity of 10 cm/s or less according to the US ANSI/ASHRAE Standard 34-2013. Further, in the present specification, a refrigerant having “ASHRAE lower flammability” means that the burning velocity of WCF is 10 cm/s or less, that the most flammable fraction composition (worst case of fractionation for flammability: WCFF), which is specified by performing a leakage test during storage, shipping, or use based on ANSI/ASHRAE 34-2013 using WCF, has a burning velocity of 10 cm/s or less, and that flammability classification according to the US ANSI/ASHRAE Standard 34-2013 is determined to classified as be “Class 2L.”
In the present specification, a refrigerant having an “RCL of x % or more” means that the refrigerant has a refrigerant concentration limit (RCL), calculated in accordance with the US ANSI/ASHRAE Standard 34-2013, of x % or more. RCL refers to a concentration limit in the air in consideration of safety factors. RCL is an index for reducing the risk of acute toxicity, suffocation, and flammability in a closed space where humans are present. RCL is determined in accordance with the ASHRAE Standard. More specifically, RCL is the lowest concentration among the acute toxicity exposure limit (ATEL), the oxygen deprivation limit (ODL), and the flammable concentration limit (FCL), which are respectively calculated in accordance with sections 7.1.1, 7.1.2, and 7.1.3 of the ASHRAE Standard.
In the present specification, temperature glide refers to an absolute value of the difference between the initial temperature and the end temperature in the phase change process of a composition containing the refrigerant of the present disclosure in the heat exchanger of a refrigerant system.

### (2) Refrigerant

### (2-1) Refrigerant Component

Any one of various refrigerants such as refrigerant A, refrigerant B, refrigerant C, refrigerant D, and refrigerant E, details of these refrigerant are to be mentioned later, can be used as the refrigerant.

### (2-2) Use of Refrigerant

The refrigerant according to the present disclosure can be preferably used as a working fluid in a refrigerating machine.

The composition according to the present disclosure is suitable for use as an alternative refrigerant for HFC refrigerant such as R410A, R407C and R404 etc, or HCFC refrigerant such as R22 etc.

### (3) Refrigerant Composition

The refrigerant composition according to the present disclosure comprises at least the refrigerant according to the present disclosure, and can be used for the same use as the refrigerant according to the present disclosure. Moreover, the refrigerant composition according to the present disclosure can be further mixed with at least a refrigeration oil to thereby obtain a working fluid for a refrigerating machine.
The refrigerant composition according to the present disclosure further comprises at least one other component in addition to the refrigerant according to the present disclosure. The refrigerant composition according to the present disclosure may comprise at least one of the following other components, if necessary. As described above, when the refrigerant composition according to the present disclosure is used as a working fluid in a refrigerating machine, it is generally used as a mixture with at least a refrigeration oil. Therefore, it is preferable that the refrigerant composition according to the present disclosure does not substantially comprise a refrigeration oil. Specifically, in the refrigerant composition according to the present disclosure, the content of the refrigeration oil based on the entire refrigerant composition is preferably 0 to 1 mass %, and more preferably 0 to 0.1 mass %.

### (3-1) Water

The refrigerant composition according to the present disclosure may contain a small amount of water. The water content of the refrigerant composition is preferably 0.1 mass % or less based on the entire refrigerant. A small amount of water contained in the refrigerant composition stabilizes double bonds in the molecules of unsaturated fluorocarbon compounds that can be present in the refrigerant, and makes it less likely that the unsaturated fluorocarbon compounds will be oxidized, thus increasing the stability of the refrigerant composition.

### (3-2) Tracer

A tracer is added to the refrigerant composition according to the present disclosure at a detectable concentration such that when the refrigerant composition has been diluted, contaminated, or undergone other changes, the tracer can trace the changes.
The refrigerant composition according to the present disclosure may comprise a single tracer, or two or more tracers.
The tracer is not limited, and can be suitably selected from commonly used tracers. Preferably, a compound that cannot be an impurity inevitably mixed in the refrigerant of the present disclosure is selected as the tracer.
Examples of tracers include hydrofluorocarbons, hydrochlorofluorocarbons, chlorofluorocarbons, hydrochlorocarbons, fluorocarbons, deuterated hydrocarbons, deuterated hydrofluorocarbons, perfluorocarbons, fluoroethers, brominated compounds, iodinated compounds, alcohols, aldehydes, ketones, and nitrous oxide (N₂O). The tracer is particularly preferably a hydrofluorocarbon, a hydrochlorofluorocarbon, a chlorofluorocarbon, a fluorocarbon, a hydrochlorocarbon, a fluorocarbon, or a fluoroether.
The following compounds are preferable as the tracer.
   FC-14 (tetrafluoromethane, CF₄)
   HCC-40 (chloromethane, CH₃Cl)
   HFC-23 (trifluoromethane, CHF₃)
   HFC-41 (fluoromethane, CH₃Cl)
   HFC-125 (pentafluoroethane, CF₃CHF₂)
   HFC-134a (1,1,1,2-tetrafluoroethane, CF₃CH₂F)
   HFC-134 (1,1,2,2-tetrafluoroethane, CHF₂CHF₂)
   HFC-143a (1,1,1-trifluoroethane, CF₃CH₃)
   HFC-143 (1,1,2-trifluoroethane, CHF₂CH₂F)
   HFC-152a (1,1-difluoroethane, CHF₂CH₃)
   HFC-152 (1,2-difluoroethane, CH₂FCH₂F)
   HFC-161 (fluoroethane, CH₃CH₂F)
   HFC-245fa (1,1,1,3,3-pentafluoropropane, CF₃CH₂CHF₂)
   HFC-236fa (1,1,1,3,3,3-hexafluoropropane, CF₃CH₂CF₃)
   HFC-236ea (1,1,1,2,3,3-hexafluoropropane, CF₃CHFCHF₂)
   HFC-227ea (1,1,1,2,3,3,3-heptafluoropropane, CF₃CHFCF₃)
   HCFC-22 (chlorodifluoromethane, CHClF₂)
   HCFC-31 (chlorofluoromethane, CH₂ClF)
   CFC-1113 (chlorotrifluoroethylene, CF₂═CClF)
   HFE-125 (trifluoromethyl-difluoromethyl ether, CF₃OCHF₂)
   HFE-134a (trifluoromethyl-fluoromethyl ether, CF₃OCH₂F)
   HFE-143a (trifluoromethyl-methyl ether, CF₃OCH₃)
   HFE-227ea (trifluoromethyl-tetrafluoroethyl ether, CF₃OCHFCF3)
   HFE-236fa (trifluoromethyl-trifluoroethyl ether, CF₃OCH₂CF₃)

The tracer compound may be present in the refrigerant composition at a total concentration of about 10 parts per million (ppm) to about 1000 ppm. Preferably, the tracer compound is present in the refrigerant composition at a total concentration of about 30 ppm to about 500 ppm, and most preferably, the tracer compound is present at a total concentration of about 50 ppm to about 300 ppm.

### (3-3) Ultraviolet Fluorescent Dye

The refrigerant composition according to the present disclosure may comprise a single ultraviolet fluorescent dye, or two or more ultraviolet fluorescent dyes.
The ultraviolet fluorescent dye is not limited, and can be suitably selected from commonly used ultraviolet fluorescent dyes.
Examples of ultraviolet fluorescent dyes include naphthalimide, coumarin, anthracene, phenanthrene, xanthene, thioxanthene, naphthoxanthene, fluorescein, and derivatives thereof. The ultraviolet fluorescent dye is particularly preferably either naphthalimide or coumarin, or both.

### (3-4) Stabilizer

The refrigerant composition according to the present disclosure may comprise a single stabilizer, or two or more stabilizers.
The stabilizer is not limited, and can be suitably selected from commonly used stabilizers.
Examples of stabilizers include nitro compounds, ethers, and amines.
Examples of nitro compounds include aliphatic nitro compounds, such as nitromethane and nitroethane; and aromatic nitro compounds, such as nitro benzene and nitro styrene.
Examples of ethers include 1,4-dioxane.
Examples of amines include 2,2,3,3,3-pentafluoropropylamine and diphenylamine.
Examples of stabilizers also include butylhydroxyxylene and benzotriazole.
The content of the stabilizer is not limited. Generally, the content of the stabilizer is preferably 0.01 to 5 mass %, and more preferably 0.05 to 2 mass %, based on the entire refrigerant.

### (3-5) Polymerization Inhibitor

The refrigerant composition according to the present disclosure may comprise a single polymerization inhibitor, or two or more polymerization inhibitors.
The polymerization inhibitor is not limited, and can be suitably selected from commonly used polymerization inhibitors.
Examples of polymerization inhibitors include 4-methoxy-1-naphthol, hydroquinone, hydroquinone methyl ether, dim ethyl-t-butylphenol, 2,6-di-tert-butyl-p-cresol, and benzotriazole.
The content of the polymerization inhibitor is not limited. Generally, the content of the polymerization inhibitor is preferably 0.01 to 5 mass %, and more preferably 0.05 to 2 mass %, based on the entire refrigerant.

### (4) Refrigeration Oil—Containing Working Fluid

The refrigeration oil-containing working fluid according to the present disclosure comprises at least the refrigerant or refrigerant composition according to the present disclosure and a refrigeration oil, for use as a working fluid in a refrigerating machine. Specifically, the refrigeration oil-containing working fluid according to the present disclosure is obtained by mixing a refrigeration oil used in a compressor of a refrigerating machine with the refrigerant or the refrigerant composition. The refrigeration oil-containing working fluid generally comprises 10 to 50 mass % of refrigeration oil.

### (4-1) Refrigeration Oil

The refrigeration oil is not limited, and can be suitably selected from commonly used refrigeration oils. In this case, refrigeration oils that are superior in the action of increasing the miscibility with the mixture and the stability of the mixture, for example, are suitably selected as necessary.
The base oil of the refrigeration oil is preferably, for example, at least one member selected from the group consisting of polyalkylene glycols (PAG), polyol esters (POE), and polyvinyl ethers (PVE).
The refrigeration oil may further contain additives in addition to the base oil. The additive may be at least one member selected from the group consisting of antioxidants, extreme-pressure agents, acid scavengers, oxygen scavengers, copper deactivators, rust inhibitors, oil agents, and antifoaming agents.
A refrigeration oil with a kinematic viscosity of 5 to 400 cSt at 40° C. is preferable from the standpoint of lubrication.
The refrigeration oil-containing working fluid according to the present disclosure may further optionally contain at least one additive. Examples of additives include compatibilizing agents described below.

### (4-2) Compatibilizing Agent

The refrigeration oil-containing working fluid according to the present disclosure may comprise a single compatibilizing agent, or two or more compatibilizing agents.
The compatibilizing agent is not limited, and can be suitably selected from commonly used compatibilizing agents.
Examples of compatibilizing agents include polyoxyalkylene glycol ethers, amides, nitriles, ketones, chlorocarbons, esters, lactones, aryl ethers, fluoroethers, and 1,1,1-trifluoroalkanes. The compatibilizing agent is particularly preferably a polyoxyalkylene glycol ether.

### (5) Various Refrigerants

Hereinafter, the refrigerants A to E, which are the refrigerants used in the present embodiment, will be described in detail.

In addition, each description of the following refrigerant A, refrigerant B, refrigerant C, refrigerant D, and refrigerant E is each independent. The alphabet which shows a point or a line segment, the number of an Examples, and the number of a comparative examples are all independent of each other among the refrigerant A, the refrigerant B, the refrigerant C, the refrigerant D, and the refrigerant E. For example, the first embodiment of the refrigerant A and the first embodiment of the refrigerant B are different embodiment from each other.

### (5-1) Refrigerant A

The refrigerant A according to the present disclosure is a mixed refrigerant comprising trans-1,2-difluoroethylene (HFO-1132(E)), trifluoroethylene (HFO-1123), and 2,3,3,3-tetrafluoro-1-propene (R1234yf).
The refrigerant A according to the present disclosure has various properties that are desirable as an R410A-alternative refrigerant, i.e., a refrigerating capacity and a coefficient of performance that are equivalent to those of R410A, and a sufficiently low GWP.
The refrigerant A according to the present disclosure is a composition comprising HFO-1132(E) and R1234yf, and optionally further comprising HFO-1123, and may further satisfy the following requirements. This refrigerant also has various properties desirable as an alternative refrigerant for R410A; i.e., it has a refrigerating capacity and a coefficient of performance that are equivalent to those of R410A, and a sufficiently low GWP.

### Requirements

Preferable refrigerant A is as follows:
When the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line CO);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3,
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.
When the requirements above are satisfied, the refrigerant according to the present disclosure has a refrigerating capacity ratio of 85% or more relative to that of R410A, and a COP of 92.5% or more relative to that of R410A.
When the mass % of HFO-1132(E), HFO-1123, and R1234yf, based on their sum in the refrigerant A according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within a figure surrounded by line segments GI, IA, AA′, A′B, BD, DC′, C′C, and CG that connect the following 8 points:
   point G (72.0, 28.0, 0.0),
   point I (72.0, 0.0, 28.0),
   point A (68.6, 0.0, 31.4),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segment CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.
When the requirements above are satisfied, the refrigerant A according to the present disclosure has a refrigerating capacity ratio of 85% or more relative to that of R410A, and a COP of 92.5% or more relative to that of R410A; furthermore, the refrigerant A has a WCF lower flammability according to the ASHRAE Standard (the WCF composition has a burning velocity of 10 cm/s or less).
When the mass % of HFO-1132(E), HFO-1123, and R1234yf based on their sum in the refrigerant according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
   point J (47.1, 52.9, 0.0),
   point P (55.8, 42.0, 2.2),
   point N (68.6, 16.3, 15.1),
   point K (61.3, 5.4, 33.3),
   point A′ (30.6, 30.0, 39.4),
   point B (0.0, 58.7, 41.3),
   point D (0.0, 80.4, 19.6),
   point C′ (19.5, 70.5, 10.0), and
   point C (32.9, 67.1, 0.0),
   or on the above line segments (excluding the points on the line segment CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.
When the requirements above are satisfied, the refrigerant A according to the present disclosure has a refrigerating capacity ratio of 85% or more relative to that of R410A, and a COP of 92.5% or more relative to that of R410A; furthermore, the refrigerant exhibits a lower flammability (Class 2L) according to the ASHRAE Standard (the WCF composition and the WCFF composition have a burning velocity of 10 cm/s or less).
When the mass % of HFO-1132(E), HFO-1123, and R1234yf based on their sum in the refrigerant according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
   point J (47.1, 52.9, 0.0),
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point D (0.0, 80.4, 19.6),
   point C′ (19.5, 70.5, 10.0), and
   point (32.9, 67.1, 0.0),
   or on the above line segments (excluding the points on the line segment CJ);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.

When the requirements above are satisfied, the refrigerant according to the present disclosure has a refrigerating capacity ratio of 85% or more relative to that of R410A, and a COP of 92.5% or more relative to that of R410A; furthermore, the refrigerant has an RCL of 40 g/m³ or more.
When the mass % of HFO-1132(E), HFO-1123, and R1234yf based on their sum in the refrigerant A according to the present disclosure is respectively represented by x, y, and z, the refrigerant is preferably a refrigerant wherein coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
   point P (55.8, 42.0, 2.2),
   point L (63.1, 31.9, 5.0),
   point M (60.3, 6.2, 33.5),
   point A′ (30.6, 30.0, 39.4),
   point B (0.0, 58.7, 41.3),
   point F (0.0, 61.8, 38.2), and
   point T (35.8, 44.9, 19.3),
   or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.
When the requirements above are satisfied, the refrigerant according to the present disclosure has a refrigerating capacity ratio of 85% or more relative to that of R410A, and a COP of 95% or more relative to that of R410A; furthermore, the refrigerant has an RCL of 40 g/m³ or more.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
   point P (55.8, 42.0, 2.2),
   point L (63.1, 31.9, 5.0),
   point Q (62.8, 29.6, 7.6), and
   point R (49.8, 42.3, 7.9),
   or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.
When the requirements above are satisfied, the refrigerant according to the present disclosure has a COP of 95% or more relative to that of R410A, and an RCL of 40 g/m³ or more, furthermore, the refrigerant has a condensation temperature glide of 1° C. or less.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
   point S (62.6, 28.3, 9.1),
   point M (60.3, 6.2, 33.5),
   point A′(30.6, 30.0, 39.4),
   point B (0.0, 58.7, 41.3),
   point F (0.0, 61.8, 38.2), and
   point T (35.8, 44.9, 19.3),
   or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.
When the requirements above are satisfied, the refrigerant according to the present disclosure has a refrigerating capacity ratio of 85% or more relative to that of R410A, a COP of 95% or more relative to that of R410A, and an RCL of 40 g/m³ or more furthermore, the refrigerant has a discharge pressure of 105% or more relative to that of R410A.
The refrigerant A according to the present disclosure is preferably a refrigerant wherein when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments Od, dg, gh, and hO that connect the following 4 points:
   point d (87.6, 0.0, 12.4),
   point g (18.2, 55.1, 26.7),
   point h (56.7, 43.3, 0.0), and
   point o (100.0, 0.0, 0.0),
   or on the line segments Od, dg, gh, and hO (excluding the points 0 and h);
the line segment dg is represented by coordinates (0.0047y²−1.5177y+87.598, y, −0.0047y²+0.5177y+12.402),
the line segment gh is represented by coordinates (−0.0134z²−1.0825z+56.692, 0.0134z²+0.0825z+43.308, z), and
the line segments hO and Od are straight lines.
When the requirements above are satisfied, the refrigerant according to the present disclosure has a refrigerating capacity ratio of 92.5% or more relative to that of R410A, and a COP ratio of 92.5% or more relative to that of R410A.
The refrigerant A according to the present disclosure is preferably a refrigerant wherein
when the mass % of HFO-1132(E), HFO-1123, and R1234yf, based on their sum is respectively represented by x, y, and z, coordinates (x,y,z) in a ternary composition diagram in which the sum of HFO-1132(E), HFO-1123, and R1234yf is 100 mass % are within the range of a figure surrounded by line segments lg, gh, hi, and il that connect the following 4 points:
   point l (72.5, 10.2, 17.3),
   point g (18.2, 55.1, 26.7),
   point h (56.7, 43.3, 0.0), and
   point i (72.5, 27.5, 0.0) or
   on the line segments lg, gh, and il (excluding the points h and i);
the line segment lg is represented by coordinates (0.0047y²−1.5177y+87.598, y, −0.0047y²+0.5177y+12.402),
the line gh is represented by coordinates (−0.0134z²−1.0825z+56.692, 0.0134z²+0.0825z+43.308, z), and
the line segments hi and il are straight lines.
When the requirements above are satisfied, the refrigerant according to the present disclosure has a refrigerating capacity ratio of 92.5% or more relative to that of R410A, and a COP ratio of 92.5% or more relative to that of R410A; furthermore, the refrigerant has a lower flammability (Class 2L) according to the ASHRAE Standard.
The refrigerant A according to the present disclosure is preferably a refrigerant wherein
when the mass % of HFO-1132(E), HFO-1123, and R1234yf based on their sum is respectively represented by x, y, and z, coordinates (x,y,z) in a ternary composition diagram in which the sum of HFO-1132(E), HFO-1123, and R1234yf is 100 mass % are within the range of a figure surrounded by line segments Od, de, ef, and fO that connect the following 4 points:
   point d (87.6, 0.0, 12.4),
   point e (31.1, 42.9, 26.0),
   point f (65.5, 34.5, 0.0), and
   point O (100.0, 0.0, 0.0),
   or on the line segments Od, de, and ef (excluding the points 0 and f);
the line segment de is represented by coordinates (0.0047y²−1.5177y+87.598, y, −0.0047y²+0.5177y+12.402),
the line segment ef is represented by coordinates (−0.0064z²−1.1565z+65.501, 0.0064z²+0.1565z+34.499, z), and
the line segments fO and Od are straight lines.
When the requirements above are satisfied, the refrigerant according to the present disclosure has a refrigerating capacity ratio of 93.5% or more relative to that of R410A, and a COP ratio of 93.5% or more relative to that of R410A.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments le, ef, fi, and il that connect the following 4 points:
   point l (72.5, 10.2, 17.3),
   point e (31.1, 42.9, 26.0),
   point f (65.5, 34.5, 0.0), and
   point i (72.5, 27.5, 0.0),
   or on the line segments le, ef, and il (excluding the points f and i);
the line segment le is represented by coordinates (0.0047y²−1.5177y+87.598, y, −0.0047y²+0.5177y+12.402),
the line segment ef is represented by coordinates (−0.0134z²−1.0825z+56.692, 0.0134z²+0.0825z+43.308, z), and
the line segments fi and il are straight lines.
When the requirements above are satisfied, the refrigerant according to the present disclosure has a refrigerating capacity ratio of 93.5% or more relative to that of R410A, and a COP ratio of 93.5% or more relative to that of R410A; furthermore, the refrigerant has a lower flammability (Class 2L) according to the ASHRAE Standard.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments Oa, ab, bc, and cO that connect the following 4 points:
   point a (93.4, 0.0, 6.6),
   point b (55.6, 26.6, 17.8),
   point c (77.6, 22.4, 0.0), and
   point O (100.0, 0.0, 0.0),
   or on the line segments Oa, ab, and bc (excluding the points 0 and c);
the line segment ab is represented by coordinates (0.0052y²−1.5588y+93.385, y, −0.0052y²+0.5588y+6.615),
the line segment bc is represented by coordinates (−0.0032z²−1.1791z+77.593, 0.0032z²+0.1791z+22.407, z), and
the line segments cO and Oa are straight lines.
When the requirements above are satisfied, the refrigerant according to the present disclosure has a refrigerating capacity ratio of 95% or more relative to that of R410A, and a COP ratio of 95% or more relative to that of R410A.
The refrigerant A according to the present disclosure is preferably a refrigerant wherein
when the mass % of HFO-1132(E), HFO-1123, and R1234yf based on their sum is respectively represented by x, y, and z,
coordinates (x,y,z) in a ternary composition diagram in which the sum of HFO-1132(E), HFO-1123, and R1234yf is 100 mass % are within the range of a figure surrounded by line segments kb, bj, and jk that connect the following 3 points:
   point k (72.5, 14.1, 13.4),
   point b (55.6, 26.6, 17.8), and
   point j (72.5, 23.2, 4.3),
   or on the line segments kb, bj, and jk;
the line segment kb is represented by coordinates
   (0.0052y²−1.5588y+93.385, y, and −0.0052y²+0.5588y+6.615),
the line segment bj is represented by coordinates
   (−0.0032z²−1.1791z+77.593, 0.0032z²+0.1791z+22.407, z), and
the line segment jk is a straight line.
When the requirements above are satisfied, the refrigerant according to the present disclosure has a refrigerating capacity ratio of 95% or more relative to that of R410A, and a COP ratio of 95% or more relative to that of R410A; furthermore, the refrigerant has a lower flammability (Class 2L) according to the ASHRAE Standard.
The refrigerant according to the present disclosure may further comprise other additional refrigerants in addition to HFO-1132(E), HFO-1123, and R1234yf, as long as the above properties and effects are not impaired. In this respect, the refrigerant according to the present disclosure preferably comprises HFO-1132(E), HFO-1123, and R1234yf in a total amount of 99.5 mass % or more, more preferably 99.75 mass % or more, and still more preferably 99.9 mass % or more, based on the entire refrigerant.
The refrigerant according to the present disclosure may comprise HFO-1132(E), HFO-1123, and R1234yf in a total amount of 99.5 mass % or more, 99.75 mass % or more, or 99.9 mass % or more, based on the entire refrigerant.
Additional refrigerants are not particularly limited and can be widely selected. The mixed refrigerant may contain one additional refrigerant, or two or more additional refrigerants.

### (Examples of Refrigerant A)

The present disclosure is described in more detail below with reference to Examples of refrigerant A. However, refrigerant A is not limited to the Examples.
The GWP of R1234yf and a composition consisting of a mixed refrigerant R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in WO2015/141678). The refrigerating capacity of R410A and compositions each comprising a mixture of HFO-1132(E), HFO-1123, and R1234yf was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
Further, the RCL of the mixture was calculated with the LFL of HFO-1132(E) being 4.7 vol. %, the LFL of HFO-1123 being 10 vol. %, and the LFL of R1234yf being 6.2 vol. %, in accordance with the ASHRAE Standard 34-2013.
   Evaporating temperature: 5° C.
   Condensation temperature: 45° C.
   Degree of superheating: 5 K
   Degree of subcooling: 5 K
   Compressor efficiency: 70%
Tables 1 to 34 show these values together with the GWP of each mixed refrigerant.

TABLE 1

| | | | Comp. | Comp. | | Example | | Comp. |
|---|---|---|---|---|---|---|---|---|
| | | Comp. | Ex. 2 | Ex. 3 | Example | 2 | Example | Ex. 4 |
| Item | Unit | Ex. 1 | O | A | 1 | A′ | 3 | B |
| HFO-1132(E) | mass % | R410A | 100.0 | 68.6 | 49.0 | 30.6 | 14.1 | 0.0 |
| HFO-1123 | mass % | | 0.0 | 0.0 | 14.9 | 30.0 | 44.8 | 58.7 |
| R1234yf | mass % | | 0.0 | 31.4 | 36.1 | 39.4 | 41.1 | 41.3 |
| GWP | — | 2088 | 1 | 2 | 2 | 2 | 2 | 2 |
| COP ratio | % (relative | 100 | 99.7 | 100.0 | 98.6 | 97.3 | 96.3 | 95.5 |
| | to 410A) | | | | | | | |
| Refrigerating | % (relative | 100 | 98.3 | 85.0 | 85.0 | 85.0 | 85.0 | 85.0 |
| capacity ratio | to 410A) | | | | | | | |
| Condensation | ° C. | 0.1 | 0.00 | 1.98 | 3.36 | 4.46 | 5.15 | 5.35 |
| glide | | | | | | | | |
| Discharge | % (relative | 100.0 | 99.3 | 87.1 | 88.9 | 90.6 | 92.1 | 93.2 |
| pressure | to 410A) | | | | | | | |
| RCL | g/m³ | — | 30.7 | 37.5 | 44.0 | 52.7 | 64.0 | 78.6 |

TABLE 2

| | | Comp. | | Example | | Comp. | Comp. | Example | Comp. |
|---|---|---|---|---|---|---|---|---|---|
| | | Ex. 5 | Example | 5 | Example | Ex. 6 | Ex. 7 | 7 | Ex. 8 |
| Item | Unit | C | 4 | C′ | 6 | D | E | E′ | F |
| HFO-1132(E) | mass % | 32.9 | 26.6 | 19.5 | 10.9 | 0.0 | 58.0 | 23.4 | 0.0 |
| HFO-1123 | mass % | 67.1 | 68.4 | 70.5 | 74.1 | 80.4 | 42.0 | 48.5 | 61.8 |
| R1234yf | mass % | 0.0 | 5.0 | 10.0 | 15.0 | 19.6 | 0.0 | 28.1 | 38.2 |
| GWP | — | 1 | 1 | 1 | 1 | 2 | 1 | 2 | 2 |
| COP ratio | % (relative | 92.5 | 92.5 | 92.5 | 92.5 | 92.5 | 95.0 | 95.0 | 95.0 |
| | to 410A) | | | | | | | | |
| Refrigerating | % (relative | 107.4 | 105.2 | 102.9 | 100.5 | 97.9 | 105.0 | 92.5 | 86.9 |
| capacity ratio | to 410A) | | | | | | | | |
| Condensation | ° C. | 0.16 | 0.52 | 0.94 | 1.42 | 1.90 | 0.42 | 3.16 | 4.80 |
| glide | | | | | | | | | |
| Discharge | % (relative | 119.5 | 117.4 | 115.3 | 113.0 | 115.9 | 112.7 | 101.0 | 95.8 |
| pressure | to 410A) | | | | | | | | |
| RCL | g/m³ | 53.5 | 57.1 | 62.0 | 69.1 | 81.3 | 41.9 | 46.3 | 79.0 |

TABLE 3

| | | Comp. | Example | Example | Example | Example | Example |
|---|---|---|---|---|---|---|---|
| | | Ex. 9 | 8 | 9 | 10 | 11 | 12 |
| Item | Unit | J | P | L | N | N′ | K |
| HFO-1132(E) | mass % | 47.1 | 55.8 | 63.1 | 68.6 | 65.0 | 61.3 |
| HFO-1123 | mass % | 52.9 | 42.0 | 31.9 | 16.3 | 7.7 | 5.4 |
| R1234yf | mass % | 0.0 | 2.2 | 5.0 | 15.1 | 27.3 | 33.3 |
| GWP | — | 1 | 1 | 1 | 1 | 2 | 2 |
| COP ratio | % (relative | 93.8 | 95.0 | 96.1 | 97.9 | 99.1 | 99.5 |
| | to 410A) | | | | | | |
| Refrigerating | % (relative | 106.2 | 104.1 | 101.6 | 95.0 | 88.2 | 85.0 |
| capacity ratio | to 410A) | | | | | | |
| Condensation | ° C. | 0.31 | 0.57 | 0.81 | 1.41 | 2.11 | 2.51 |
| glide | | | | | | | |
| Discharge | % (relative | 115.8 | 111.9 | 107.8 | 99.0 | 91.2 | 87.7 |
| pressure | to 410A) | | | | | | |
| RCL | g/m³ | 46.2 | 42.6 | 40.0 | 38.0 | 38.7 | 39.7 |

TABLE 4

| | | Example | Example | Example | Example | Example | Example | Example |
|---|---|---|---|---|---|---|---|---|
| | | 13 | 14 | 15 | 16 | 17 | 18 | 19 |
| Item | Unit | L | M | Q | R | S | S′ | T |
| HFO-1132(E) | mass % | 63.1 | 60.3 | 62.8 | 49.8 | 62.6 | 50.0 | 35.8 |
| HFO-1123 | mass % | 31.9 | 6.2 | 29.6 | 42.3 | 28.3 | 35.8 | 44.9 |
| R1234yf | mass % | 5.0 | 33.5 | 7.6 | 7.9 | 9.1 | 14.2 | 19.3 |
| GWP | — | 1 | 2 | 1 | 1 | 1 | 1 | 2 |
| COP ratio | % (relative | 96.1 | 99.4 | 96.4 | 95.0 | 96.6 | 95.8 | 95.0 |
| | to 410A) | | | | | | | |
| Refrigerating | % (relative | 101.6 | 85.0 | 100.2 | 101.7 | 99.4 | 98.1 | 96.7 |
| capacity ratio | to 410A) | | | | | | | |
| Condensation | ° C. | 0.81 | 2.58 | 1.00 | 1.00 | 1.10 | 1.55 | 2.07 |
| glide | | | | | | | | |
| Discharge | % (relative | 107.8 | 87.9 | 106.0 | 109.6 | 105.0 | 105.0 | 105.0 |
| pressure | to 410A) | | | | | | | |
| RCL | g/m³ | 40.0 | 40.0 | 40.0 | 44.8 | 40.0 | 44.4 | 50.8 |

TABLE 5

| | | Comp. | Example | Example |
|---|---|---|---|---|
| | | Ex. 10 | 20 | 21 |
| Item | Unit | G | H | I |
| HFO-1132(E) | mass % | 72.0 | 72.0 | 72.0 |
| HFO-1123 | mass % | 28.0 | 14.0 | 0.0 |
| R1234yf | mass % | 0.0 | 14.0 | 28.0 |
| GWP | — | 1 | 1 | 2 |
| COP ratio | % (relative | 96.6 | 98.2 | 99.9 |
| | to 410A) | | | |
| Refrigerating | % (relative | 103.1 | 95.1 | 86.6 |
| capacity ratio | to 410A) | | | |
| Condensation glide | ° C. | 0.46 | 1.27 | 1.71 |
| Discharge pressure | % (relative | 108.4 | 98.7 | 88.6 |
| | to 410A) | | | |
| RCL | g/m³ | 37.4 | 37.0 | 36.6 |

TABLE 6

| | | Comp. | Comp. | Example | Example | Example | Example | Example | Comp. |
|---|---|---|---|---|---|---|---|---|---|
| Item | Unit | Ex. 11 | Ex. 12 | 22 | 23 | 24 | 25 | 26 | Ex. 13 |
| HFO-1132(E) | mass % | 10.0 | 20.0 | 30.0 | 40.0 | 50.0 | 60.0 | 70.0 | 80.0 |
| HFO-1123 | mass % | 85.0 | 75.0 | 65.0 | 55.0 | 45.0 | 35.0 | 25.0 | 15.0 |
| R1234yf | mass % | 5.0 | 5.0 | 5.0 | 5.0 | 5.0 | 5.0 | 5.0 | 5.0 |
| GWP | — | 1 | 1 | 1 | 1 | 1 | 1 | 1 | 1 |
| COP ratio | % (relative | 91.4 | 92.0 | 92.8 | 93.7 | 94.7 | 95.8 | 96.9 | 98.0 |
| | to 410A) | | | | | | | | |
| Refrigerating | % (relative | 105.7 | 105.5 | 105.0 | 104.3 | 103.3 | 102.0 | 100.6 | 99.1 |
| capacity ratio | to 410A) | | | | | | | | |
| Condensation | ° C. | 0.40 | 0.46 | 0.55 | 0.66 | 0.75 | 0.80 | 0.79 | 0.67 |
| glide | | | | | | | | | |
| Discharge | % (relative | 120.1 | 118.7 | 116.7 | 114.3 | 111.6 | 108.7 | 105.6 | 102.5 |
| pressure | to 410A) | | | | | | | | |
| RCL | g/m³ | 71.0 | 61.9 | 54.9 | 49.3 | 44.8 | 41.0 | 37.8 | 35.1 |

TABLE 7

| | | Comp. | Example | Example | Example | Example | Example | Example | Comp. |
|---|---|---|---|---|---|---|---|---|---|
| Item | Unit | Ex. 14 | 27 | 28 | 29 | 30 | 31 | 32 | Ex. 15 |
| HFO-1132(E) | mass % | 10.0 | 20.0 | 30.0 | 40.0 | 50.0 | 60.0 | 70.0 | 80.0 |
| HFO-1123 | mass % | 80.0 | 70.0 | 60.0 | 50.0 | 40.0 | 30.0 | 20.0 | 10.0 |
| R1234yf | mass % | 10.0 | 10.0 | 10.0 | 10.0 | 10.0 | 10.0 | 10.0 | 10.0 |
| GWP | — | 1 | 1 | 1 | 1 | 1 | 1 | 1 | 1 |
| COP ratio | % (relative | 91.9 | 92.5 | 93.3 | 94.3 | 95.3 | 96.4 | 97.5 | 98.6 |
| | to 410A) | | | | | | | | |
| Refrigerating | % (relative | 103.2 | 102.9 | 102.4 | 101.5 | 100.5 | 99.2 | 97.8 | 96.2 |
| capacity ratio | to 410A) | | | | | | | | |
| Condensation | ° C. | 0.87 | 0.94 | 1.03 | 1.12 | 1.18 | 1.18 | 1.09 | 0.88 |
| glide | | | | | | | | | |
| Discharge | % (relative | 116.7 | 115.2 | 113.2 | 110.8 | 108.1 | 105.2 | 102.1 | 99.0 |
| pressure | to 410A) | | | | | | | | |
| RCL | g/m³ | 70.5 | 61.6 | 54.6 | 49.1 | 44.6 | 40.8 | 37.7 | 35.0 |

TABLE 8

| | | Comp. | Example | Example | Example | Example | Example | Example | Comp. |
|---|---|---|---|---|---|---|---|---|---|
| Item | Unit | Ex. 16 | 33 | 34 | 35 | 36 | 37 | 38 | Ex. 17 |
| HFO-1132(E) | mass % | 10.0 | 20.0 | 30.0 | 40.0 | 50.0 | 60.0 | 70.0 | 80.0 |
| HFO-1123 | mass % | 75.0 | 65.0 | 55.0 | 45.0 | 35.0 | 25.0 | 15.0 | 5.0 |
| R1234yf | mass % | 15.0 | 15.0 | 15.0 | 15.0 | 15.0 | 15.0 | 15.0 | 15.0 |
| GWP | — | 1 | 1 | 1 | 1 | 1 | 1 | 1 | 1 |
| COP ratio | % (relative | 92.4 | 93.1 | 93.9 | 94.8 | 95.9 | 97.0 | 98.1 | 99.2 |
| | to 410A) | | | | | | | | |
| Refrigerating | % (relative | 100.5 | 100.2 | 99.6 | 98.7 | 97.7 | 96.4 | 94.9 | 93.2 |
| capacity ratio | to 410A) | | | | | | | | |
| Condensation | ° C. | 1.41 | 1.49 | 1.56 | 1.62 | 1.63 | 1.55 | 1.37 | 1.05 |
| glide | | | | | | | | | |
| Discharge | % (relative | 113.1 | 111.6 | 109.6 | 107.2 | 104.5 | 101.6 | 98.6 | 95.5 |
| pressure | to 410A) | | | | | | | | |
| RCL | g/m³ | 70.0 | 61.2 | 54.4 | 48.9 | 44.4 | 40.7 | 37.5 | 34.8 |

TABLE 9

| | | Example | Example | Example | Example | Example | Example | Example |
|---|---|---|---|---|---|---|---|---|
| Item | Unit | 39 | 40 | 41 | 42 | 43 | 44 | 45 |
| HFO-1132(E) | mass % | 10.0 | 20.0 | 30.0 | 40.0 | 50.0 | 60.0 | 70.0 |
| HFO-1123 | mass % | 70.0 | 60.0 | 50.0 | 40.0 | 30.0 | 20.0 | 10.0 |
| R1234yf | mass % | 20.0 | 20.0 | 20.0 | 20.0 | 20.0 | 20.0 | 20.0 |
| GWP | — | 2 | 2 | 2 | 2 | 2 | 2 | 2 |
| COP ratio | % (relative | 93.0 | 93.7 | 94.5 | 95.5 | 96.5 | 97.6 | 98.7 |
| | to 410A) | | | | | | | |
| Refrigerating | % (relative | 97.7 | 97.4 | 96.8 | 95.9 | 94.7 | 93.4 | 91.9 |
| capacity ratio | to 410A) | | | | | | | |
| Condensation | ° C. | 2.03 | 2.09 | 2.13 | 2.14 | 2.07 | 1.91 | 1.61 |
| glide | | | | | | | | |
| Discharge | % (relative | 109.4 | 107.9 | 105.9 | 103.5 | 100.8 | 98.0 | 95.0 |
| pressure | to 410A) | | | | | | | |
| RCL | g/m³ | 69.6 | 60.9 | 54.1 | 48.7 | 44.2 | 40.5 | 37.4 |

TABLE 10

| | | Example | Example | Example | Example | Example | Example | Example |
|---|---|---|---|---|---|---|---|---|
| Item | Unit | 46 | 47 | 48 | 49 | 50 | 51 | 52 |
| HFO-1132(E) | mass % | 10.0 | 20.0 | 30.0 | 40.0 | 50.0 | 60.0 | 70.0 |
| HFO-1123 | mass % | 65.0 | 55.0 | 45.0 | 35.0 | 25.0 | 15.0 | 5.0 |
| R1234yf | mass % | 25.0 | 25.0 | 25.0 | 25.0 | 25.0 | 25.0 | 25.0 |
| GWP | — | 2 | 2 | 2 | 2 | 2 | 2 | 2 |
| COP ratio | % (relative | 93.6 | 94.3 | 95.2 | 96.1 | 97.2 | 98.2 | 99.3 |
| | to 410A) | | | | | | | |
| Refrigerating | % (relative | 94.8 | 94.5 | 93.8 | 92.9 | 91.8 | 90.4 | 88.8 |
| capacity ratio | to 410A) | | | | | | | |
| Condensation | ° C. | 2.71 | 2.74 | 2.73 | 2.66 | 2.50 | 2.22 | 1.78 |
| glide | | | | | | | | |
| Discharge | % (relative | 105.5 | 104.0 | 102.1 | 99.7 | 97.1 | 94.3 | 91.4 |
| pressure | to 410A) | | | | | | | |
| RCL | g/m³ | 69.1 | 60.5 | 53.8 | 48.4 | 44.0 | 40.4 | 37.3 |

TABLE 11

| | | Example | Example | Example | Example | Example | Example |
|---|---|---|---|---|---|---|---|
| Item | Unit | 53 | 54 | 55 | 56 | 57 | 58 |
| HFO-1132(E) | mass % | 10.0 | 20.0 | 30.0 | 40.0 | 50.0 | 60.0 |
| HFO-1123 | mass % | 60.0 | 50.0 | 40.0 | 30.0 | 20.0 | 10.0 |
| R1234yf | mass % | 30.0 | 30.0 | 30.0 | 30.0 | 30.0 | 30.0 |
| GWP | — | 2 | 2 | 2 | 2 | 2 | 2 |
| COP ratio | % (relative | 94.3 | 95.0 | 95.9 | 96.8 | 97.8 | 98.9 |
| | to 410A) | | | | | | |
| Refrigerating | % (relative | 91.9 | 91.5 | 90.8 | 89.9 | 88.7 | 87.3 |
| capacity ratio | to 410A) | | | | | | |
| Condensation | ° C. | 3.46 | 3.43 | 3.35 | 3.18 | 2.90 | 2.47 |
| glide | | | | | | | |
| Discharge | % (relative | 101.6 | 100.1 | 98.2 | 95.9 | 93.3 | 90.6 |
| pressure | to 410A) | | | | | | |
| RCL | g/m³ | 68.7 | 60.2 | 53.5 | 48.2 | 43.9 | 40.2 |

TABLE 12

| | | Example | Example | Example | Example | Example | Comp. |
|---|---|---|---|---|---|---|---|
| Item | Unit | 59 | 60 | 61 | 62 | 63 | Ex. 18 |
| HFO-1132(E) | mass % | 10.0 | 20.0 | 30.0 | 40.0 | 50.0 | 60.0 |
| HFO-1123 | mass % | 55.0 | 45.0 | 35.0 | 25.0 | 15.0 | 5.0 |
| R1234yf | mass % | 35.0 | 35.0 | 35.0 | 35.0 | 35.0 | 35.0 |
| GWP | — | 2 | 2 | 2 | 2 | 2 | 2 |
| COP ratio | % (relative | 95.0 | 95.8 | 96.6 | 97.5 | 98.5 | 99.6 |
| | to 410A) | | | | | | |
| Refrigerating | % (relative | 88.9 | 88.5 | 87.8 | 86.8 | 85.6 | 84.1 |
| capacity ratio | to 410A) | | | | | | |
| Condensation | ° C. | 4.24 | 4.15 | 3.96 | 3.67 | 3.24 | 2.64 |
| glide | | | | | | | |
| Discharge | % (relative | 97.6 | 96.1 | 94.2 | 92.0 | 89.5 | 86.8 |
| pressure | to 410A) | | | | | | |
| RCL | g/m³ | 68.2 | 59.8 | 53.2 | 48.0 | 43.7 | 40.1 |

TABLE 13

| | | Example | Example | Comp. | Comp. | Comp. |
|---|---|---|---|---|---|---|
| Item | Unit | 64 | 65 | Ex. 19 | Ex. 20 | Ex. 21 |
| HFO-1132(E) | mass % | 10.0 | 20.0 | 30.0 | 40.0 | 50.0 |
| HFO-1123 | mass % | 50.0 | 40.0 | 30.0 | 20.0 | 10.0 |
| R1234yf | mass % | 40.0 | 40.0 | 40.0 | 40.0 | 40.0 |
| GWP | — | 2 | 2 | 2 | 2 | 2 |
| COP ratio | % (relative | 95.9 | 96.6 | 97.4 | 98.3 | 99.2 |
| | to 410A) | | | | | |
| Refrigerating | % (relative | 85.8 | 85.4 | 84.7 | 83.6 | 82.4 |
| capacity ratio | to 410A) | | | | | |
| Condensation | ° C. | 5.05 | 4.85 | 4.55 | 4.10 | 3.50 |
| glide | | | | | | |
| Discharge | % (relative | 93.5 | 92.1 | 90.3 | 88.1 | 85.6 |
| pressure | to 410A) | | | | | |
| RCL | g/m³ | 67.8 | 59.5 | 53.0 | 47.8 | 43.5 |

TABLE 14

| | | Example | Example | Example | Example | Example | Example | Example | Example |
|---|---|---|---|---|---|---|---|---|---|
| Item | Unit | 66 | 67 | 68 | 69 | 70 | 71 | 72 | 73 |
| HFO-1132(E) | mass % | 54.0 | 56.0 | 58.0 | 62.0 | 52.0 | 54.0 | 56.0 | 58.0 |
| HFO-1123 | mass % | 41.0 | 39.0 | 37.0 | 33.0 | 41.0 | 39.0 | 37.0 | 35.0 |
| R1234yf | mass % | 5.0 | 5.0 | 5.0 | 5.0 | 7.0 | 7.0 | 7.0 | 7.0 |
| GWP | — | 1 | 1 | 1 | 1 | 1 | 1 | 1 | 1 |
| COP ratio | % (relative | 95.1 | 95.3 | 95.6 | 96.0 | 95.1 | 95.4 | 95.6 | 95.8 |
| | to 410A) | | | | | | | | |
| Refrigerating | % (relative | 102.8 | 102.6 | 102.3 | 101.8 | 101.9 | 101.7 | 101.5 | 101.2 |
| capacity ratio | to 410A) | | | | | | | | |
| Condensation | ° C. | 0.78 | 0.79 | 0.80 | 0.81 | 0.93 | 0.94 | 0.95 | 0.95 |
| glide | | | | | | | | | |
| Discharge | % (relative | 110.5 | 109.9 | 109.3 | 108.1 | 109.7 | 109.1 | 108.5 | 107.9 |
| pressure | to 410A) | | | | | | | | |
| RCL | g/m³ | 43.2 | 42.4 | 41.7 | 40.3 | 43.9 | 43.1 | 42.4 | 41.6 |

TABLE 15

| | | Example | Example | Example | Example | Example | Example | Example | Example |
|---|---|---|---|---|---|---|---|---|---|
| Item | Unit | 74 | 75 | 76 | 77 | 78 | 79 | 80 | 81 |
| HFO-1132(E) | mass % | 60.0 | 62.0 | 61.0 | 58.0 | 60.0 | 62.0 | 52.0 | 54.0 |
| HFO-1123 | mass % | 33.0 | 31.0 | 29.0 | 30.0 | 28.0 | 26.0 | 34.0 | 32.0 |
| R1234yf | mass % | 7.0 | 7.0 | 10.0 | 12.0 | 12.0 | 12.0 | 14.0 | 14.0 |
| GWP | — | 1 | 1 | 1 | 1 | 1 | 1 | 1 | 1 |
| COP ratio | % (relative | 96.0 | 96.2 | 96.5 | 96.4 | 96.6 | 96.8 | 96.0 | 96.2 |
| | to 410A) | | | | | | | | |
| Refrigerating | % (relative | 100.9 | 100.7 | 99.1 | 98.4 | 98.1 | 97.8 | 98.0 | 97.7 |
| capacity ratio | to 410A) | | | | | | | | |
| Condensation | ° C. | 0.95 | 0.95 | 1.18 | 1.34 | 1.33 | 1.32 | 1.53 | 1.53 |
| glide | | | | | | | | | |
| Discharge | % (relative | 107.3 | 106.7 | 104.9 | 104.4 | 103.8 | 103.2 | 104.7 | 104.1 |
| pressure | to 410A) | | | | | | | | |
| RCL | g/m³ | 40.9 | 40.3 | 40.5 | 41.5 | 40.8 | 40.1 | 43.6 | 42.9 |

TABLE 16

| | | Example | Example | Example | Example | Example | Example | Example | Example |
|---|---|---|---|---|---|---|---|---|---|
| Item | Unit | 82 | 83 | 84 | 85 | 86 | 87 | 88 | 89 |
| HFO-1132(E) | mass % | 56.0 | 58.0 | 60.0 | 48.0 | 50.0 | 52.0 | 54.0 | 56.0 |
| HFO-1123 | mass % | 30.0 | 28.0 | 26.0 | 36.0 | 34.0 | 32.0 | 30.0 | 28.0 |
| R1234yf | mass % | 14.0 | 14.0 | 14.0 | 16.0 | 16.0 | 16.0 | 16.0 | 16.0 |
| GWP | — | 1 | 1 | 1 | 1 | 1 | 1 | 1 | 1 |
| COP ratio | % (relative | 96.4 | 96.6 | 96.9 | 95.8 | 96.0 | 96.2 | 96.4 | 96.7 |
| | to 410A) | | | | | | | | |
| Refrigerating | % (relative | 97.5 | 97.2 | 96.9 | 97.3 | 97.1 | 96.8 | 96.6 | 96.3 |
| capacity ratio | to 410A) | | | | | | | | |
| Condensation | ° C. | 1.51 | 1.50 | 1.48 | 1.72 | 1.72 | 1.71 | 1.69 | 1.67 |
| glide | | | | | | | | | |
| Discharge | % (relative | 103.5 | 102.9 | 102.3 | 104.3 | 103.8 | 103.2 | 102.7 | 102.1 |
| pressure | to 410A) | | | | | | | | |
| RCL | g/m³ | 42.1 | 41.4 | 40.7 | 45.2 | 44.4 | 43.6 | 42.8 | 42.1 |

TABLE 17

| | | Example | Example | Example | Example | Example | Example | Example | Example |
|---|---|---|---|---|---|---|---|---|---|
| Item | Unit | 90 | 91 | 92 | 93 | 94 | 95 | 96 | 97 |
| HFO-1132(E) | mass % | 58.0 | 60.0 | 42.0 | 44.0 | 46.0 | 48.0 | 50.0 | 52.0 |
| HFO-1123 | mass % | 26.0 | 24.0 | 40.0 | 38.0 | 36.0 | 34.0 | 32.0 | 30.0 |
| R1234yf | mass % | 16.0 | 16.0 | 18.0 | 18.0 | 18.0 | 18.0 | 18.0 | 18.0 |
| GWP | — | 1 | 1 | 2 | 2 | 2 | 2 | 2 | 2 |
| COP ratio | % (relative | 96.9 | 97.1 | 95.4 | 95.6 | 95.8 | 96.0 | 96.3 | 96.5 |
| | to 410A) | | | | | | | | |
| Refrigerating | % (relative | 96.1 | 95.8 | 96.8 | 96.6 | 96.4 | 96.2 | 95.9 | 95.7 |
| capacity ratio | to 410A) | | | | | | | | |
| Condensation | ° C. | 1.65 | 1.63 | 1.93 | 1.92 | 1.92 | 1.91 | 1.89 | 1.88 |
| glide | | | | | | | | | |
| Discharge | % (relative | 101.5 | 100.9 | 104.5 | 103.9 | 103.4 | 102.9 | 102.3 | 101.8 |
| pressure | to 410A) | | | | | | | | |
| RCL | g/m³ | 41.4 | 40.7 | 47.8 | 46.9 | 46.0 | 45.1 | 44.3 | 43.5 |

TABLE 18

| | | Example | Example | Example | Example | Example | Example | Example | Example |
|---|---|---|---|---|---|---|---|---|---|
| Item | Unit | 98 | 99 | 100 | 101 | 102 | 103 | 104 | 105 |
| HFO-1132(E) | mass % | 54.0 | 56.0 | 58.0 | 60.0 | 36.0 | 38.0 | 42.0 | 44.0 |
| HFO-1123 | mass % | 28.0 | 26.0 | 24.0 | 22.0 | 44.0 | 42.0 | 38.0 | 36.0 |
| R1234yf | mass % | 18.0 | 18.0 | 18.0 | 18.0 | 20.0 | 20.0 | 20.0 | 20.0 |
| GWP | — | 2 | 2 | 2 | 2 | 2 | 2 | 2 | 2 |
| COP ratio | % (relative | 96.7 | 96.9 | 97.1 | 97.3 | 95.1 | 95.3 | 95.7 | 95.9 |
| | to 410A) | | | | | | | | |
| Refrigerating | % (relative | 95.4 | 95.2 | 94.9 | 94.6 | 96.3 | 96.1 | 95.7 | 95.4 |
| capacity ratio | to 410A) | | | | | | | | |
| Condensation | ° C. | 1.86 | 1.83 | 1.80 | 1.77 | 2.14 | 2.14 | 2.13 | 2.12 |
| glide | | | | | | | | | |
| Discharge | % (relative | 101.2 | 100.6 | 100.0 | 99.5 | 104.5 | 104.0 | 103.0 | 102.5 |
| pressure | to 410A) | | | | | | | | |
| RCL | g/m³ | 42.7 | 42.0 | 41.3 | 40.6 | 50.7 | 49.7 | 47.7 | 46.8 |

TABLE 19

| | | Example | Example | Example | Example | Example | Example | Example | Example |
|---|---|---|---|---|---|---|---|---|---|
| Item | Unit | 106 | 107 | 108 | 109 | 110 | 111 | 112 | 113 |
| HFO-1132(E) | mass % | 46.0 | 48.0 | 52.0 | 54.0 | 56.0 | 58.0 | 34.0 | 36.0 |
| HFO-1123 | mass % | 34.0 | 32.0 | 28.0 | 26.0 | 24.0 | 22.0 | 44.0 | 42.0 |
| R1234yf | mass % | 20.0 | 20.0 | 20.0 | 20.0 | 20.0 | 20.0 | 22.0 | 22.0 |
| GWP | — | 2 | 2 | 2 | 2 | 2 | 2 | 2 | 2 |
| COP ratio | % (relative | 96.1 | 96.3 | 96.7 | 96.9 | 97.2 | 97.4 | 95.1 | 95.3 |
| | to 410A) | | | | | | | | |
| Refrigerating | % (relative | 95.2 | 95.0 | 94.5 | 94.2 | 94.0 | 93.7 | 95.3 | 95.1 |
| capacity ratio | to 410A) | | | | | | | | |
| Condensation | ° C. | 2.11 | 2.09 | 2.05 | 2.02 | 1.99 | 1.95 | 2.37 | 2.36 |
| glide | | | | | | | | | |
| Discharge | % (relative | 101.9 | 101.4 | 100.3 | 99.7 | 99.2 | 98.6 | 103.4 | 103.0 |
| pressure | to 410A) | | | | | | | | |
| RCL | g/m³ | 45.9 | 45.0 | 43.4 | 42.7 | 41.9 | 41.2 | 51.7 | 50.6 |

TABLE 20

| | | Example | Example | Example | Example | Example | Example | Example | Example |
|---|---|---|---|---|---|---|---|---|---|
| Item | Unit | 114 | 115 | 116 | 117 | 118 | 119 | 120 | 121 |
| HFO-1132(E) | mass % | 38.0 | 40.0 | 42.0 | 44.0 | 46.0 | 48.0 | 50.0 | 52.0 |
| HFO-1123 | mass % | 40.0 | 38.0 | 36.0 | 34.0 | 32.0 | 30.0 | 28.0 | 26.0 |
| R1234yf | mass % | 22.0 | 22.0 | 22.0 | 22.0 | 22.0 | 22.0 | 22.0 | 22.0 |
| GWP | — | 2 | 2 | 2 | 2 | 2 | 2 | 2 | 2 |
| COP ratio | % (relative | 95.5 | 95.7 | 95.9 | 96.1 | 96.4 | 96.6 | 96.8 | 97.0 |
| | to 410A) | | | | | | | | |
| Refrigerating | % (relative | 94.9 | 94.7 | 94.5 | 94.3 | 94.0 | 93.8 | 93.6 | 93.3 |
| capacity ratio | to 410A) | | | | | | | | |
| Condensation | ° C. | 2.36 | 2.35 | 2.33 | 2.32 | 2.30 | 2.27 | 2.25 | 2.21 |
| glide | | | | | | | | | |
| Discharge | % (relative | 102.5 | 102.0 | 101.5 | 101.0 | 100.4 | 99.9 | 99.4 | 98.8 |
| pressure | to 410A) | | | | | | | | |
| RCL | g/m³ | 49.6 | 48.6 | 47.6 | 46.7 | 45.8 | 45.0 | 44.1 | 43.4 |

TABLE 21

| | | Example | Example | Example | Example | Example | Example | Example | Example |
|---|---|---|---|---|---|---|---|---|---|
| Item | Unit | 122 | 123 | 124 | 125 | 126 | 127 | 128 | 129 |
| HFO-1132(E) | mass % | 54.0 | 56.0 | 58.0 | 60.0 | 32.0 | 34.0 | 36.0 | 38.0 |
| HFO-1123 | mass % | 24.0 | 22.0 | 20.0 | 18.0 | 44.0 | 42.0 | 40.0 | 38.0 |
| R1234yf | mass % | 22.0 | 22.0 | 22.0 | 22.0 | 24.0 | 24.0 | 24.0 | 24.0 |
| GWP | — | 2 | 2 | 2 | 2 | 2 | 2 | 2 | 2 |
| COP ratio | % (relative | 97.2 | 97.4 | 97.6 | 97.9 | 95.2 | 95.4 | 95.6 | 95.8 |
| | to 410A) | | | | | | | | |
| Refrigerating | % (relative | 93.0 | 92.8 | 92.5 | 92.2 | 94.3 | 94.1 | 93.9 | 93.7 |
| capacity ratio | to 410A) | | | | | | | | |
| Condensation | ° C. | 2.18 | 2.14 | 2.09 | 2.04 | 2.61 | 2.60 | 2.59 | 2.58 |
| glide | | | | | | | | | |
| Discharge | % (relative | 98.2 | 97.7 | 97.1 | 96.5 | 102.4 | 101.9 | 101.5 | 101.0 |
| pressure | to 410A) | | | | | | | | |
| RCL | g/m³ | 42.6 | 41.9 | 41.2 | 40.5 | 52.7 | 51.6 | 50.5 | 49.5 |

TABLE 22

| | | Example | Example | Example | Example | Example | Example | Example | Example |
|---|---|---|---|---|---|---|---|---|---|
| Item | Unit | 130 | 131 | 132 | 133 | 134 | 135 | 136 | 137 |
| HFO-1132(E) | mass % | 40.0 | 42.0 | 44.0 | 46.0 | 48.0 | 50.0 | 52.0 | 54.0 |
| HFO-1123 | mass % | 36.0 | 34.0 | 32.0 | 30.0 | 28.0 | 26.0 | 24.0 | 22.0 |
| R1234yf | mass % | 24.0 | 24.0 | 24.0 | 24.0 | 24.0 | 24.0 | 24.0 | 24.0 |
| GWP | — | 2 | 2 | 2 | 2 | 2 | 2 | 2 | 2 |
| COP ratio | % (relative | 96.0 | 96.2 | 96.4 | 96.6 | 96.8 | 97.0 | 97.2 | 97.5 |
| | to 410A) | | | | | | | | |
| Refrigerating | % (relative | 93.5 | 93.3 | 93.1 | 92.8 | 92.6 | 92.4 | 92.1 | 91.8 |
| capacity ratio | to 410A) | | | | | | | | |
| Condensation | ° C. | 2.56 | 2.54 | 2.51 | 2.49 | 2.45 | 2.42 | 2.38 | 2.33 |
| glide | | | | | | | | | |
| Discharge | % (relative | 100.5 | 100.0 | 99.5 | 98.9 | 98.4 | 97.9 | 97.3 | 96.8 |
| pressure | to 410A) | | | | | | | | |
| RCL | g/m³ | 48.5 | 47.5 | 46.6 | 45.7 | 44.9 | 44.1 | 43.3 | 42.5 |

TABLE 23

| | | Example | Example | Example | Example | Example | Example | Example | Example |
|---|---|---|---|---|---|---|---|---|---|
| Item | Unit | 138 | 139 | 140 | 141 | 142 | 143 | 144 | 145 |
| HFO-1132(E) | mass % | 56.0 | 58.0 | 60.0 | 30.0 | 32.0 | 34.0 | 36.0 | 38.0 |
| HFO-1123 | mass % | 20.0 | 18.0 | 16.0 | 44.0 | 42.0 | 40.0 | 38.0 | 36.0 |
| R1234yf | mass % | 24.0 | 24.0 | 24.0 | 26.0 | 26.0 | 26.0 | 26.0 | 26.0 |
| GWP | — | 2 | 2 | 2 | 2 | 2 | 2 | 2 | 2 |
| COP ratio | % (relative | 97.7 | 97.9 | 98.1 | 95.3 | 95.5 | 95.7 | 95.9 | 96.1 |
| | to 410A) | | | | | | | | |
| Refrigerating | % (relative | 91.6 | 91.3 | 91.0 | 93.2 | 93.1 | 92.9 | 92.7 | 92.5 |
| capacity ratio | to 410A) | | | | | | | | |
| Condensation | ° C. | 2.28 | 2.22 | 2.16 | 2.86 | 2.85 | 2.83 | 2.81 | 2.79 |
| glide | | | | | | | | | |
| Discharge | % (relative | 96.2 | 95.6 | 95.1 | 101.3 | 100.8 | 100.4 | 99.9 | 99.4 |
| pressure | to 410A) | | | | | | | | |
| RCL | g/m³ | 41.8 | 41.1 | 40.4 | 53.7 | 52.6 | 51.5 | 50.4 | 49.4 |

TABLE 24

| | | Example | Example | Example | Example | Example | Example | Example | Example |
|---|---|---|---|---|---|---|---|---|---|
| Item | Unit | 146 | 147 | 148 | 149 | 150 | 151 | 152 | 153 |
| HFO-1132(E) | mass % | 40.0 | 42.0 | 44.0 | 46.0 | 48.0 | 50.0 | 52.0 | 54.0 |
| HFO-1123 | mass % | 34.0 | 32.0 | 30.0 | 28.0 | 26.0 | 24.0 | 22.0 | 20.0 |
| R1234yf | mass % | 26.0 | 26.0 | 26.0 | 26.0 | 26.0 | 26.0 | 26.0 | 26.0 |
| GWP | — | 2 | 2 | 2 | 2 | 2 | 2 | 2 | 2 |
| COP ratio | % (relative | 96.3 | 96.5 | 96.7 | 96.9 | 97.1 | 97.3 | 97.5 | 97.7 |
| | to 410A) | | | | | | | | |
| Refrigerating | % (relative | 92.3 | 92.1 | 91.9 | 91.6 | 91.4 | 91.2 | 90.9 | 90.6 |
| capacity ratio | to 410A) | | | | | | | | |
| Condensation | ° C. | 2.77 | 2.74 | 2.71 | 2.67 | 2.63 | 2.59 | 2.53 | 2.48 |
| glide | | | | | | | | | |
| Discharge | % (relative | 99.0 | 98.5 | 97.9 | 97.4 | 96.9 | 96.4 | 95.8 | 95.3 |
| pressure | to 410A) | | | | | | | | |
| RCL | g/m³ | 48.4 | 47.4 | 46.5 | 45.7 | 44.8 | 44.0 | 43.2 | 42.5 |

TABLE 25

| | | Example | Example | Example | Example | Example | Example | Example | Example |
|---|---|---|---|---|---|---|---|---|---|
| Item | Unit | 154 | 155 | 156 | 157 | 158 | 159 | 160 | 161 |
| HFO-1132(E) | mass % | 56.0 | 58.0 | 60.0 | 30.0 | 32.0 | 34.0 | 36.0 | 38.0 |
| HFO-1123 | mass % | 18.0 | 16.0 | 14.0 | 42.0 | 40.0 | 38.0 | 36.0 | 34.0 |
| R1234yf | mass % | 26.0 | 26.0 | 26.0 | 28.0 | 28.0 | 28.0 | 28.0 | 28.0 |
| GWP | — | 2 | 2 | 2 | 2 | 2 | 2 | 2 | 2 |
| COP ratio | % (relative | 97.9 | 98.2 | 98.4 | 95.6 | 95.8 | 96.0 | 96.2 | 96.3 |
| | to 410A) | | | | | | | | |
| Refrigerating | % (relative | 90.3 | 90.1 | 89.8 | 92.1 | 91.9 | 91.7 | 91.5 | 91.3 |
| capacity ratio | to 410A) | | | | | | | | |
| Condensation | ° C. | 2.42 | 2.35 | 2.27 | 3.10 | 3.09 | 3.06 | 3.04 | 3.01 |
| glide | | | | | | | | | |
| Discharge | % (relative | 94.7 | 94.1 | 93.6 | 99.7 | 99.3 | 98.8 | 98.4 | 97.9 |
| pressure | to 410A) | | | | | | | | |
| RCL | g/m³ | 41.7 | 41.0 | 40.3 | 53.6 | 52.5 | 51.4 | 50.3 | 49.3 |

TABLE 26

| | | Example | Example | Example | Example | Example | Example | Example | Example |
|---|---|---|---|---|---|---|---|---|---|
| Item | Unit | 162 | 163 | 164 | 165 | 166 | 167 | 168 | 169 |
| HFO-1132(E) | mass % | 40.0 | 42.0 | 44.0 | 46.0 | 48.0 | 50.0 | 52.0 | 54.0 |
| HFO-1123 | mass % | 32.0 | 30.0 | 28.0 | 26.0 | 24.0 | 22.0 | 20.0 | 18.0 |
| R1234yf | mass % | 28.0 | 28.0 | 28.0 | 28.0 | 28.0 | 28.0 | 28.0 | 28.0 |
| GWP | — | 2 | 2 | 2 | 2 | 2 | 2 | 2 | 2 |
| COP ratio | % (relative | 96.5 | 96.7 | 96.9 | 97.2 | 97.4 | 97.6 | 97.8 | 98.0 |
| | to 410A) | | | | | | | | |
| Refrigerating | % (relative | 91.1 | 90.9 | 90.7 | 90.4 | 90.2 | 89.9 | 89.7 | 89.4 |
| capacity ratio | to 410A) | | | | | | | | |
| Condensation | ° C. | 2.98 | 2.94 | 2.90 | 2.85 | 2.80 | 2.75 | 2.68 | 2.62 |
| glide | | | | | | | | | |
| Discharge | % (relative | 97.4 | 96.9 | 96.4 | 95.9 | 95.4 | 94.9 | 94.3 | 93.8 |
| pressure | to 410A) | | | | | | | | |
| RCL | g/m³ | 48.3 | 47.4 | 46.4 | 45.6 | 44.7 | 43.9 | 43.1 | 42.4 |

TABLE 27

| | | Example | Example | Example | Example | Example | Example | Example | Example |
|---|---|---|---|---|---|---|---|---|---|
| Item | Unit | 170 | 171 | 172 | 173 | 174 | 175 | 176 | 177 |
| HFO-1132(E) | mass % | 56.0 | 58.0 | 60.0 | 32.0 | 34.0 | 36.0 | 38.0 | 42.0 |
| HFO-1123 | mass % | 16.0 | 14.0 | 12.0 | 38.0 | 36.0 | 34.0 | 32.0 | 28.0 |
| R1234yf | mass % | 28.0 | 28.0 | 28.0 | 30.0 | 30.0 | 30.0 | 30.0 | 30.0 |
| GWP | — | 2 | 2 | 2 | 2 | 2 | 2 | 2 | 2 |
| COP ratio | % (relative | 98.2 | 98.4 | 98.6 | 96.1 | 96.2 | 96.4 | 96.6 | 97.0 |
| | to 410A) | | | | | | | | |
| Refrigerating | % (relative | 89.1 | 88.8 | 88.5 | 90.7 | 90.5 | 90.3 | 90.1 | 89.7 |
| capacity ratio | to 410A) | | | | | | | | |
| Condensation | ° C. | 2.54 | 2.46 | 2.38 | 3.32 | 3.30 | 3.26 | 3.22 | 3.14 |
| glide | | | | | | | | | |
| Discharge | % (relative | 93.2 | 92.6 | 92.1 | 97.7 | 97.3 | 96.8 | 96.4 | 95.4 |
| pressure | to 410A) | | | | | | | | |
| RCL | g/m³ | 41.7 | 41.0 | 40.3 | 52.4 | 51.3 | 50.2 | 49.2 | 47.3 |

TABLE 28

| | | Example | Example | Example | Example | Example | Example | Example | Example |
|---|---|---|---|---|---|---|---|---|---|
| Item | Unit | 178 | 179 | 180 | 181 | 182 | 183 | 184 | 185 |
| HFO-1132(E) | mass % | 44.0 | 46.0 | 48.0 | 50.0 | 52.0 | 54.0 | 56.0 | 58.0 |
| HFO-1123 | mass % | 26.0 | 24.0 | 22.0 | 20.0 | 18.0 | 16.0 | 14.0 | 12.0 |
| R1234yf | mass % | 30.0 | 30.0 | 30.0 | 30.0 | 30.0 | 30.0 | 30.0 | 30.0 |
| GWP | — | 2 | 2 | 2 | 2 | 2 | 2 | 2 | 2 |
| COP ratio | % (relative | 97.2 | 97.4 | 97.6 | 97.8 | 98.0 | 98.3 | 98.5 | 98.7 |
| | to 410A) | | | | | | | | |
| Refrigerating | % (relative | 89.4 | 89.2 | 89.0 | 88.7 | 88.4 | 88.2 | 87.9 | 87.6 |
| capacity ratio | to 410A) | | | | | | | | |
| Condensation | ° C. | 3.08 | 3.03 | 2.97 | 2.90 | 2.83 | 2.75 | 2.66 | 2.57 |
| glide | | | | | | | | | |
| Discharge | % (relative | 94.9 | 94.4 | 93.9 | 93.3 | 92.8 | 92.3 | 91.7 | 91.1 |
| pressure | to 410A) | | | | | | | | |
| RCL | g/m³ | 46.4 | 45.5 | 44.7 | 43.9 | 43.1 | 42.3 | 41.6 | 40.9 |

TABLE 29

| | | Example | Example | Example | Example | Example | Example | Example | Example |
|---|---|---|---|---|---|---|---|---|---|
| Item | Unit | 186 | 187 | 188 | 189 | 190 | 191 | 192 | 193 |
| HFO-1132(E) | mass % | 30.0 | 32.0 | 34.0 | 36.0 | 38.0 | 40.0 | 42.0 | 44.0 |
| HFO-1123 | mass % | 38.0 | 36.0 | 34.0 | 32.0 | 30.0 | 28.0 | 26.0 | 24.0 |
| R1234yf | mass % | 32.0 | 32.0 | 32.0 | 32.0 | 32.0 | 32.0 | 32.0 | 32.0 |
| GWP | — | 2 | 2 | 2 | 2 | 2 | 2 | 2 | 2 |
| COP ratio | % (relative | 96.2 | 96.3 | 96.5 | 96.7 | 96.9 | 97.1 | 97.3 | 97.5 |
| | to 410A) | | | | | | | | |
| Refrigerating | % (relative | 89.6 | 89.5 | 89.3 | 89.1 | 88.9 | 88.7 | 88.4 | 88.2 |
| capacity ratio | to 410A) | | | | | | | | |
| Condensation | ° C. | 3.60 | 3.56 | 3.52 | 3.48 | 3.43 | 3.38 | 3.33 | 3.26 |
| glide | | | | | | | | | |
| Discharge | % (relative | 96.6 | 96.2 | 95.7 | 95.3 | 94.8 | 94.3 | 93.9 | 93.4 |
| pressure | to 410A) | | | | | | | | |
| RCL | g/m³ | 53.4 | 52.3 | 51.2 | 50.1 | 49.1 | 48.1 | 47.2 | 46.3 |

TABLE 30

| | | Example | Example | Example | Example | Example | Example | Example | Example |
|---|---|---|---|---|---|---|---|---|---|
| Item | Unit | 194 | 195 | 196 | 197 | 198 | 199 | 200 | 201 |
| HFO-1132(E) | mass % | 46.0 | 48.0 | 50.0 | 52.0 | 54.0 | 56.0 | 58.0 | 60.0 |
| HFO-1123 | mass % | 22.0 | 20.0 | 18.0 | 16.0 | 14.0 | 12.0 | 10.0 | 8.0 |
| R1234yf | mass % | 32.0 | 32.0 | 32.0 | 32.0 | 32.0 | 32.0 | 32.0 | 32.0 |
| GWP | — | 2 | 2 | 2 | 2 | 2 | 2 | 2 | 2 |
| COP ratio | % (relative | 97.7 | 97.9 | 98.1 | 98.3 | 98.5 | 98.7 | 98.9 | 99.2 |
| | to 410A) | | | | | | | | |
| Refrigerating | % (relative | 88.0 | 87.7 | 87.5 | 87.2 | 86.9 | 86.6 | 86.3 | 86.0 |
| capacity ratio | to 410A) | | | | | | | | |
| Condensation | ° C. | 3.20 | 3.12 | 3.04 | 2.96 | 2.87 | 2.77 | 2.66 | 2.55 |
| glide | | | | | | | | | |
| Discharge | % (relative | 92.8 | 92.3 | 91.8 | 91.3 | 90.7 | 90.2 | 89.6 | 89.1 |
| pressure | to 410A) | | | | | | | | |
| RCL | g/m³ | 45.4 | 44.6 | 43.8 | 43.0 | 42.3 | 41.5 | 40.8 | 40.2 |

TABLE 31

| | | Example | Example | Example | Example | Example | Example | Example | Example |
|---|---|---|---|---|---|---|---|---|---|
| Item | Unit | 202 | 203 | 204 | 205 | 206 | 207 | 208 | 209 |
| HFO-1132(E) | mass % | 30.0 | 32.0 | 34.0 | 36.0 | 38.0 | 40.0 | 42.0 | 44.0 |
| HFO-1123 | mass % | 36.0 | 34.0 | 32.0 | 30.0 | 28.0 | 26.0 | 24.0 | 22.0 |
| R1234yf | mass % | 34.0 | 34.0 | 34.0 | 34.0 | 34.0 | 34.0 | 34.0 | 34.0 |
| GWP | — | 2 | 2 | 2 | 2 | 2 | 2 | 2 | 2 |
| COP ratio | % (relative | 96.5 | 96.6 | 96.8 | 97.0 | 97.2 | 97.4 | 97.6 | 97.8 |
| | to 410A) | | | | | | | | |
| Refrigerating | % (relative | 88.4 | 88.2 | 88.0 | 87.8 | 87.6 | 87.4 | 87.2 | 87.0 |
| capacity ratio | to 410A) | | | | | | | | |
| Condensation | ° C. | 3.84 | 3.80 | 3.75 | 3.70 | 3.64 | 3.58 | 3.51 | 3.43 |
| glide | | | | | | | | | |
| Discharge | % (relative | 95.0 | 94.6 | 94.2 | 93.7 | 93.3 | 92.8 | 92.3 | 91.8 |
| pressure | to 410A) | | | | | | | | |
| RCL | g/m³ | 53.3 | 52.2 | 51.1 | 50.0 | 49.0 | 48.0 | 47.1 | 46.2 |

TABLE 32

| | | Example | Example | Example | Example | Example | Example | Example | Example |
|---|---|---|---|---|---|---|---|---|---|
| Item | Unit | 210 | 211 | 212 | 213 | 214 | 215 | 216 | 217 |
| HFO-1132(E) | mass % | 46.0 | 48.0 | 50.0 | 52.0 | 54.0 | 30.0 | 32.0 | 34.0 |
| HFO-1123 | mass % | 20.0 | 18.0 | 16.0 | 14.0 | 12.0 | 34.0 | 32.0 | 30.0 |
| R1234yf | mass % | 34.0 | 34.0 | 34.0 | 34.0 | 34.0 | 36.0 | 36.0 | 36.0 |
| GWP | — | 2 | 2 | 2 | 2 | 2 | 2 | 2 | 2 |
| COP ratio | % (relative | 98.0 | 98.2 | 98.4 | 98.6 | 98.8 | 96.8 | 96.9 | 97.1 |
| | to 410A) | | | | | | | | |
| Refrigerating | % (relative | 86.7 | 86.5 | 86.2 | 85.9 | 85.6 | 87.2 | 87.0 | 86.8 |
| capacity ratio | to 410A) | | | | | | | | |
| Condensation | ° C. | 3.36 | 3.27 | 3.18 | 3.08 | 2.97 | 4.08 | 4.03 | 3.97 |
| glide | | | | | | | | | |
| Discharge | % (relative | 91.3 | 90.8 | 90.3 | 89.7 | 89.2 | 93.4 | 93.0 | 92.6 |
| pressure | to 410A) | | | | | | | | |
| RCL | g/m³ | 45.3 | 44.5 | 43.7 | 42.9 | 42.2 | 53.2 | 52.1 | 51.0 |

TABLE 33

| | | Example | Example | Example | Example | Example | Example | Example | Example |
|---|---|---|---|---|---|---|---|---|---|
| Item | Unit | 218 | 219 | 220 | 221 | 222 | 223 | 224 | 225 |
| HFO-1132(E) | mass % | 36.0 | 38.0 | 40.0 | 42.0 | 44.0 | 46.0 | 30.0 | 32.0 |
| HFO-1123 | mass % | 28.0 | 26.0 | 24.0 | 22.0 | 20.0 | 18.0 | 32.0 | 30.0 |
| R1234yf | mass % | 36.0 | 36.0 | 36.0 | 36.0 | 36.0 | 36.0 | 38.0 | 38.0 |
| GWP | — | 2 | 2 | 2 | 2 | 2 | 2 | 2 | 2 |
| COP ratio | % (relative | 97.3 | 97.5 | 97.7 | 97.9 | 98.1 | 98.3 | 97.1 | 97.2 |
| | to 410A) | | | | | | | | |
| Refrigerating | % (relative | 86.6 | 86.4 | 86.2 | 85.9 | 85.7 | 85.5 | 85.9 | 85.7 |
| capacity ratio | to 410A) | | | | | | | | |
| Condensation | ° C. | 3.91 | 3.84 | 3.76 | 3.68 | 3.60 | 3.50 | 4.32 | 4.25 |
| glide | | | | | | | | | |
| Discharge | % (relative | 92.1 | 91.7 | 91.2 | 90.7 | 90.3 | 89.8 | 91.9 | 91.4 |
| pressure | to 410A) | | | | | | | | |
| RCL | g/m³ | 49.9 | 48.9 | 47.9 | 47.0 | 46.1 | 45.3 | 53.1 | 52.0 |

TABLE 34

| | | Example | Example |
|---|---|---|---|
| Item | Unit | 226 | 227 |
| HFO-1132(E) | mass % | 34.0 | 36.0 |
| HFO-1123 | mass % | 28.0 | 26.0 |
| R1234yf | mass % | 38.0 | 38.0 |
| GWP | — | 2 | 2 |
| COP ratio | % (relative | 97.4 | 97.6 |
| | to 410A) | | |
| Refrigerating | % (relative | 85.6 | 85.3 |
| capacity ratio | to 410A) | | |
| Condensation glide | ° C. | 4.18 | 4.11 |
| Discharge pressure | % (relative | 91.0 | 90.6 |
| | to 410A) | | |
| RCL | g/m³ | 50.9 | 49.8 |

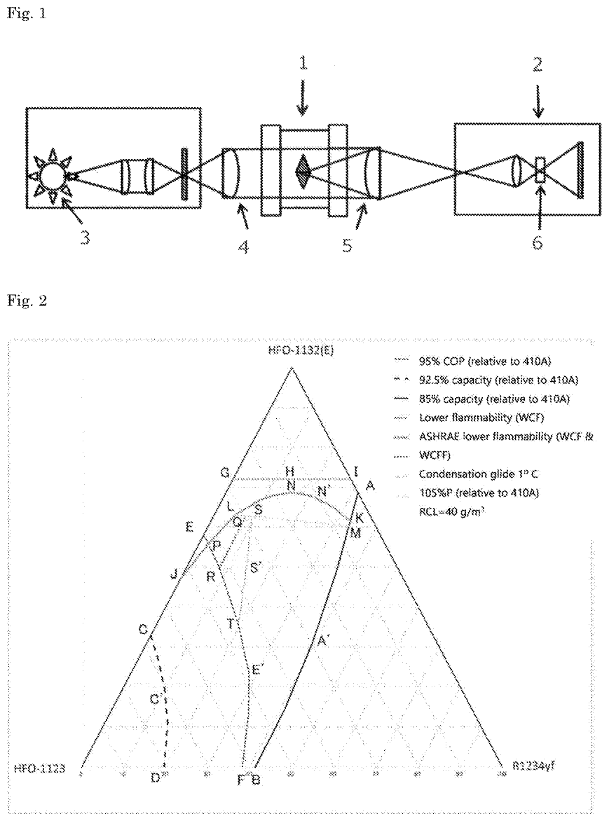

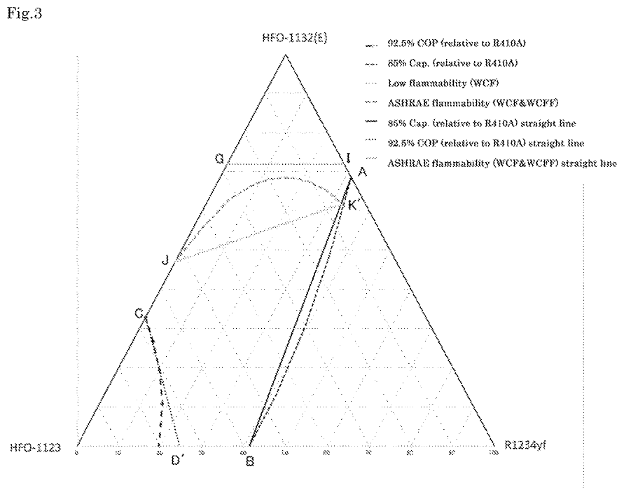

These results indicate that under the condition that the mass % of HFO-1132(E), HFO-1123, and R1234yf based on their sum is respectively represented by x, y, and z, when coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
   point A (68.6, 0.0, 31.4),
   point A′(30.6, 30.0, 39.4),
   point B (0.0, 58.7, 41.3),
   point D (0.0, 80.4, 19.6),
   point C′ (19.5, 70.5, 10.0),
   point C (32.9, 67.1, 0.0), and
   point O (100.0, 0.0, 0.0),
   or on the above line segments (excluding the points on the line segment CO);
   the line segment AA′ is represented by coordinates (x, 0.0016x²−0.9473x+57.497, −0.0016x²−0.0527x+42.503),
   the line segment A′B is represented by coordinates (x, 0.0029x²−1.0268x+58.7, −0.0029x²+0.0268x+41.3,
   the line segment DC′ is represented by coordinates (x, 0.0082x²−0.6671x+80.4, −0.0082x²−0.3329x+19.6),
   the line segment C′C is represented by coordinates (x, 0.0067x²−0.6034x+79.729, −0.0067x²−0.3966x+20.271), and
   the line segments BD, CO, and OA are straight lines,
   the refrigerant has a refrigerating capacity ratio of 85% or more relative to that of R410A, and a COP of 92.5% or more relative to that of R410A.
The point on the line segment AA′ was determined by obtaining an approximate curve connecting point A, Example 1, and point A′ by the least square method.
The point on the line segment A′B was determined by obtaining an approximate curve connecting point A′, Example 3, and point B by the least square method.
The point on the line segment DC′ was determined by obtaining an approximate curve connecting point D, Example 6, and point C′ by the least square method.
The point on the line segment C′C was determined by obtaining an approximate curve connecting point C′, Example 4, and point C by the least square method.
Likewise, the results indicate that when coordinates (x,y,z) are within the range of a figure surrounded by line segments AA′, A′B, BF, FT, TE, EO, and OA that connect the following 7 points:
   point A (68.6, 0.0, 31.4),
   point A′ (30.6, 30.0, 39.4),
   point B (0.0, 58.7, 41.3),
   point F (0.0, 61.8, 38.2),
   point T (35.8, 44.9, 19.3),
   point E (58.0, 42.0, 0.0) and
   point O (100.0, 0.0, 0.0),
   or on the above line segments (excluding the points on the line EO);
   the line segment AA′ is represented by coordinates (x, 0.0016x²−0.9473x+57.497, −0.0016x²−0.0527x+42.503),
   the line segment A′B is represented by coordinates (x, 0.0029x²−1.0268x+58.7, −0.0029x²+0.0268x+41.3),
   the line segment FT is represented by coordinates (x, 0.0078x²−0.7501x+61.8, −0.0078x²−0.2499x+38.2), and
   the line segment TE is represented by coordinates (x, 0.0067x²−0.7607x+63.525, −0.0067x²−0.2393x+36.475), and
   the line segments BF, FO, and OA are straight lines,
   the refrigerant has a refrigerating capacity ratio of 85% or more relative to that of R410A, and a COP of 95% or more relative to that of R410A.
The point on the line segment FT was determined by obtaining an approximate curve connecting three points, i.e., points T, E′, and F, by the least square method.
The point on the line segment TE was determined by obtaining an approximate curve connecting three points, i.e., points E, R, and T, by the least square method.
The results in Tables 1 to 34 clearly indicate that in a ternary composition diagram of the mixed refrigerant of HFO-1132(E), HFO-1123, and R1234yf in which the sum of these components is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below the line segment LM connecting point L (63.1, 31.9, 5.0) and point M (60.3, 6.2, 33.5), the refrigerant has an RCL of 40 g/m³ or more.
The results in Tables 1 to 34 clearly indicate that in a ternary composition diagram of the mixed refrigerant of HFO-1132(E), HFO-1123 and R1234yf in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on the line segment QR connecting point Q (62.8, 29.6, 7.6) and point R (49.8, 42.3, 7.9) or on the left side of the line segment, the refrigerant has a temperature glide of 1° C. or less.
The results in Tables 1 to 34 clearly indicate that in a ternary composition diagram of the mixed refrigerant of HFO-1132(E), HFO-1123, and R1234yf in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on the line segment ST connecting point S (62.6, 28.3, 9.1) and point T (35.8, 44.9, 19.3) or on the right side of the line segment, the refrigerant has a discharge pressure of 105% or less relative to that of 410A.
In these compositions, R1234yf contributes to reducing flammability, and suppressing deterioration of polymerization etc. Therefore, the composition preferably contains R1234yf.
Further, the burning velocity of these mixed refrigerants whose mixed formulations were adjusted to WCF concentrations was measured according to the ANSI/ASHRAE Standard 34-2013. Compositions having a burning velocity of 10 cm/s or less were determined to be classified as “Class 2L (lower flammability).”
A burning velocity test was performed using the apparatus shown in FIG. 1 in the following manner. In FIG. 1, reference numeral 901 refers to a sample cell, 902 refers to a high-speed camera, 903 refers to a xenon lamp, 904 refers to a collimating lens, 905 refers to a collimating lens, and 906 refers to a ring filter. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
Each WCFF concentration was obtained by using the WCF concentration as the initial concentration and performing a leak simulation using NIST Standard Reference Database REFLEAK Version 4.0.
Tables 35 and 36 show the results.

TABLE 35

| Item | | Unit | G | H | I |
|---|---|---|---|---|---|
| WCF | HFO-1132(E) | mass % | 72.0 | 72.0 | 72.0 |
| | HFO-1123 | mass % | 28.0 | 9.6 | 0.0 |
| | R1234yf | mass % | 0.0 | 18.4 | 28.0 |

| | | | | |
|---|---|---|---|---|
| Burning velocity (WCF) | cm/s | 10 | 10 | 10 |

TABLE 36

| Item | | Unit | J | P | L | N | N′ | K |
|---|---|---|---|---|---|---|---|---|
| WCF | HFO-1132(E) | mass % | 47.1 | 55.8 | 63.1 | 68.6 | 65.0 | 61.3 |
| | HFO-1123 | mass % | 52.9 | 42.0 | 31.9 | 16.3 | 7.7 | 5.4 |
| | R1234yf | mass % | 0.0 | 2.2 | 5.0 | 15.1 | 27.3 | 33.3 |
| Leak condition that results in WCFF | | | Storage/ | Storage/ | Storage/ | Storage/ | Storage/ | Storage/ |
| | | | Shipping −40° | Shipping −40° | Shipping −40° | Shipping −40° | Shipping −40° | Shipping, −40° |
| | | | C., 92% | C., 90% | C., 90% | C., 66% | C., 12% | C., 0% |
| | | | release, | release, | release, | release, | release, | release, |
| | | | liquid phase | liquid phase | gas phase | gas phase | gas phase | gas phase |
| | | | side | side | side | side | side | side |
| WCFF | HFO-1132(E) | mass % | 72.0 | 72.0 | 72.0 | 72.0 | 72.0 | 72.0 |
| | HFO-1123 | mass % | 28.0 | 17.8 | 17.4 | 13.6 | 12.3 | 9.8 |
| | R1234yf | mass % | 0.0 | 10.2 | 10.6 | 14.4 | 15.7 | 18.2 |

| | | | | | | | |
|---|---|---|---|---|---|---|---|
| Burning velocity (WCF) | cm/s | 8 or | 8 or | 8 or | 9 | 9 | 8 or |
| | | less | less | less | | | less |
| Burning velocity (WCFF) | cm/s | 10 | 10 | 10 | 10 | 10 | 10 |

The results in Table 35 clearly indicate that when a mixed refrigerant of HFO-1132(E), HFO-1123, and R1234yf contains HFO-1132(E) in a proportion of 72.0 mass % or less based on their sum, the refrigerant can be determined to have a WCF lower flammability.
The results in Tables 36 clearly indicate that in a ternary composition diagram of a mixed refrigerant of HFO-1132(E), HFO-1123, and R1234yf in which their sum is 100 mass %, and a line segment connecting a point (0.0, 100.0, 0.0) and a point (0.0, 0.0, 100.0) is the base,
   when coordinates (x,y,z) are on or below the line segments JP, PN, and NK connecting the following 6 points:
   point J (47.1, 52.9, 0.0),
   point P (55.8, 42.0, 2.2),
   point L (63.1, 31.9, 5.0)
   point N (68.6, 16.3, 15.1)
   point N′ (65.0, 7.7, 27.3) and
   point K (61.3, 5.4, 33.3),
   the refrigerant can be determined to have a WCF lower flammability, and a WCFF lower flammability.
   In the diagram, the line segment PN is represented by coordinates (x, −0.1135x²+12.112x−280.43, 0.1135x²−13.112x+380.43),
   and the line segment NK is represented by coordinates (x, 0.2421x²−29.955x+931.91, −0.2421x²+28.955x−831.91).
The point on the line segment PN was determined by obtaining an approximate curve connecting three points, i.e., points P, L, and N, by the least square method.
The point on the line segment NK was determined by obtaining an approximate curve connecting three points, i.e., points N, N′, and K, by the least square method.

### (5-2) Refrigerant B

The refrigerant B according to the present disclosure is
a mixed refrigerant comprising trans-1,2-difluoroethylene (HFO-1132(E)) and trifluoroethylene (HFO-1123) in a total amount of 99.5 mass % or more based on the entire refrigerant, and the refrigerant comprising 62.0 mass % to 72.0 mass % or 45.1 mass % to 47.1 mass % of HFO-1132(E) based on the entire refrigerant, or
a mixed refrigerant comprising HFO-1132(E) and HFO-1123 in a total amount of 99.5 mass % or more based on the entire refrigerant, and the refrigerant comprising 45.1 mass % to 47.1 mass % of HFO-1132(E) based on the entire refrigerant.
The refrigerant B according to the present disclosure has various properties that are desirable as an R410A-alternative refrigerant, i.e., (1) a coefficient of performance equivalent to that of R410A, (2) a refrigerating capacity equivalent to that of R410A, (3) a sufficiently low GWP, and (4) a lower flammability (Class 2L) according to the ASHRAE standard.
When the refrigerant B according to the present disclosure is a mixed refrigerant comprising 72.0 mass % or less of HFO-1132(E), it has WCF lower flammability. When the refrigerant B according to the present disclosure is a composition comprising 47.1% or less of HFO-1132(E), it has WCF lower flammability and WCFF lower flammability, and is determined to be “Class 2L,” which is a lower flammable refrigerant according to the ASHRAE standard, and which is further easier to handle.
When the refrigerant B according to the present disclosure comprises 62.0 mass % or more of HFO-1132(E), it becomes superior with a coefficient of performance of 95% or more relative to that of R410A, the polymerization reaction of HFO-1132(E) and/or HFO-1123 is further suppressed, and the stability is further improved. When the refrigerant B according to the present disclosure comprises 45.1 mass % or more of HFO-1132(E), it becomes superior with a coefficient of performance of 93% or more relative to that of R410A, the polymerization reaction of HFO-1132(E) and/or HFO-1123 is further suppressed, and the stability is further improved.
The refrigerant B according to the present disclosure may further comprise other additional refrigerants in addition to HFO-1132(E) and HFO-1123, as long as the above properties and effects are not impaired. In this respect, the refrigerant according to the present disclosure preferably comprises HFO-1132(E) and HFO-1123 in a total amount of 99.75 mass % or more, and more preferably 99.9 mass % or more, based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant B)

The present disclosure is described in more detail below with reference to Examples of refrigerant B. However, the refrigerant B is not limited to the Examples.
Mixed refrigerants were prepared by mixing HFO-1132(E) and HFO-1123 at mass % based on their sum shown in Tables 37 and 38.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in WO2015/141678). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
   Evaporating temperature: 5° C.
   Condensation temperature: 45° C.
   Superheating temperature: 5 K
   Subcooling temperature: 5 K
   Compressor efficiency: 70%
The composition of each mixture was defined as WCF. A leak simulation was performed using NIST Standard Reference Data Base Refleak Version 4.0 under the conditions of Equipment, Storage, Shipping, Leak, and Recharge according to the ASHRAE Standard 34-2013. The most flammable fraction was defined as WCFF.
Tables 1 and 2 show GWP, COP, and refrigerating capacity, which were calculated based on these results. The COP and refrigerating capacity are ratios relative to R410A.
The coefficient of performance (COP) was determined by the following formula.

COP=(refrigerating capacity or heating capacity)/power consumption
For the flammability, the burning velocity was measured according to the ANSI/ASHRAE Standard 34-2013. Both WCF and WCFF having a burning velocity of 10 cm/s or less were determined to be “Class 2L (lower flammability).”
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.

TABLE 37

| | | Comparative | Comparative | | | | | | | |
|---|---|---|---|---|---|---|---|---|---|---|
| | | Example 1 | Example 2 | Comparative | Example | Example | Example | Example | Example | Comparative |
| Item | Unit | R410A | HFO-1132E | Example 3 | 1 | 2 | 3 | 4 | 5 | Example 4 |
| HFO-1132E | mass % | — | 100 | 80 | 72 | 70 | 68 | 65 | 62 | 60 |
| (WCF) | | | | | | | | | | |
| HFO-1123 | mass % | | 0 | 20 | 28 | 30 | 32 | 35 | 38 | 40 |
| (WCF) | | | | | | | | | | |
| GWP | — | 2088 | 1 | 1 | 1 | 1 | 1 | 1 | 1 | 1 |
| COP ratio | % | 100 | 99.7 | 97.5 | 96.6 | 96.3 | 96.1 | 95.8 | 95.4 | 95.2 |
| | (relative | | | | | | | | | |
| | to R410A) | | | | | | | | | |
| Refrigerating | % | 100 | 98.3 | 101.9 | 103.1 | 103.4 | 103.8 | 104.1 | 104.5 | 104.8 |
| capacity | (relative | | | | | | | | | |
| ratio | to R410A) | | | | | | | | | |
| Discharge | Mpa | 2.73 | 2.71 | 2.89 | 2.96 | 2.98 | 3.00 | 3.02 | 3.04 | 3.06 |
| pressure | | | | | | | | | | |
| Burning | cm/sec | Non-flammable | 20 | 13 | 10 | 9 | 9 | 8 | 8 or | 8 or |
| velocity | | | | | | | | | less | less |
| (WCF) | | | | | | | | | | |

TABLE 38

| | | | | | | | | | | Comparative |
|---|---|---|---|---|---|---|---|---|---|---|
| | | Comparative | Comparative | Example | Example | Example | Comparative | Comparative | Comparative | Example 10 |
| Item | Unit | Example 5 | Example 6 | 7 | 8 | 9 | Example 7 | Example 8 | Example 9 | HFO-1123 |
| HFO-1132E | mass % | 50 | 48 | 47.1 | 46.1 | 45.1 | 43 | 40 | 25 | 0 |
| (WCF) | | | | | | | | | | |
| HFO-1123 | mass % | 50 | 52 | 52.9 | 53.9 | 54.9 | 57 | 60 | 75 | 100 |
| (WCF) | | | | | | | | | | |
| GWP | — | 1 | 1 | 1 | 1 | 1 | 1 | 1 | 1 | 1 |
| COP ratio | % | 94.1 | 93.9 | 93.8 | 93.7 | 93.6 | 93.4 | 93.1 | 91.9 | 90.6 |
| | (relative | | | | | | | | | |
| | to R410A) | | | | | | | | | |
| Refrigerating | % | 105.9 | 106.1 | 106.2 | 106.3 | 106.4 | 106.6 | 106.9 | 107.9 | 108.0 |
| capacity | (relative | | | | | | | | | |
| ratio | to R410A) | | | | | | | | | |
| Discharge | Mpa | 3.14 | 3.16 | 3.16 | 3.17 | 3.18 | 3.20 | 3.21 | 3.31 | 3.39 |
| pressure | | | | | | | | | | |
| Leakage test | | Storage/ | Storage/ | Storage/ | Storage/ | Storage/ | Storage/ | Storage/ | Storage/ | — |
| conditions (WCFF) | | Shipp- | Shipp- | Shipp- | Shipp- | Shipp- | Shipp- | Shipp- | Shipp- | |
| | | ing −40° | ing −40° | ing −40° | ing −40° | ing −40° | ing −40° | ing −40° | ing −40° | |
| | | C., 92% | C., 92% | C., 92% | C., 92% | C., 92% | C., 92% | C., 92% | C., 90% | |
| | | release, | release, | release, | release, | release, | release, | release, | release, | |
| | | liquid | liquid | liquid | liquid | liquid | liquid | liquid | liquid | |
| | | phase | phase | phase | phase | phase | phase | phase | phase | |
| | | side | side | side | side | side | side | side | side | |
| HFO-1132E | mass % | 74 | 73 | 72 | 71 | 70 | 67 | 63 | 38 | — |
| (WCFF) | | | | | | | | | | |
| HFO-1123 | mass % | 26 | 27 | 28 | 29 | 30 | 33 | 37 | 62 | |
| (WCFF) | | | | | | | | | | |
| Burning | cm/sec | 8 or | 8 or | 8 or | 8 or | 8 or | 8 or | 8 or | 8 or | 5 |
| velocity | | less | less | less | less | less | less | less | less | |
| (WCF) | | | | | | | | | | |
| Burning | cm/sec | 11 | 10.5 | 10.0 | 9.5 | 9.5 | 8.5 | 8 or | 8 or | |
| velocity | | | | | | | | less | less | |
| (WCFF) | | | | | | | | | | |

| | | | | | | | | | |
|---|---|---|---|---|---|---|---|---|---|
| ASHRAE flammability | 2 | 2 | 2L | 2L | 2L | 2L | 2L | 2L | 2L |
| classification | | | | | | | | | |

The compositions each comprising 62.0 mass % to 72.0 mass % of HFO-1132(E) based on the entire composition are stable while having a low GWP (GWP=1), and they ensure WCF lower flammability. Further, surprisingly, they can ensure performance equivalent to that of R410A. Moreover, compositions each comprising 45.1 mass % to 47.1 mass % of HFO-1132(E) based on the entire composition are stable while having a low GWP (GWP=1), and they ensure WCFF lower flammability. Further, surprisingly, they can ensure performance equivalent to that of R410A.

### (5-3) Refrigerant C

The refrigerant C according to the present disclosure is a composition comprising trans-1,2-difluoroethylene (HFO-1132(E)), trifluoroethylene (HFO-1123), 2,3,3,3-tetrafluoro-1-propene (R1234yf), and difluoromethane (R32), and satisfies the following requirements. The refrigerant C according to the present disclosure has various properties that are desirable as an alternative refrigerant for R410A; i.e. it has a coefficient of performance and a refrigerating capacity that are equivalent to those of R410A, and a sufficiently low GWP.

### Requirements

Preferable refrigerant C is as follows:
When the mass % of HFO-1132(E), HFO-1123, R1234yf, and R32 based on their sum is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
   point G (0.026a²−1.7478a+72.0, −0.026a²+0.7478a+28.0, 0.0),
   point I (0.026a²−1.7478a+72.0, 0.0, −0.026a²+0.7478a+28.0),
   point A (0.0134a²−1.9681a+68.6, 0.0, −0.0134a²+0.9681a+31.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines GI, AB, and D′C (excluding point G, point I, point A, point B,
   point D′, and point C);
if 11.1<a≤18.2, coordinates (x,y,z) in the ternary composition diagram are within the range of a figure surrounded by straight lines GI, IA, AB, BW, and WG that connect the following 5 points:
   point G (0.02a²−1.6013a+71.105, −0.02a²+0.6013a+28.895, 0.0),
   point I (0.02a²−1.6013a+71.105, 0.0, −0.02a²+0.6013a+28.895),
   point A (0.0112a²−1.9337a+68.484, 0.0, −0.0112a²+0.9337a+31.516),
   point B (0.0, 0.0075a²−1.5156a+58.199, −0.0075a²+0.5156a+41.801) and
   point W (0.0, 100.0−a, 0.0),
   or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
   point G (0.0135a²−1.4068a+69.727, −0.0135a²+0.4068a+30.273, 0.0),
   point I (0.0135a²−1.4068a+69.727, 0.0, −0.0135a²+0.4068a+30.273),
   point A (0.0107a²−1.9142a+68.305, 0.0, −0.0107a²+0.9142a+31.695),
   point B (0.0, 0.009a²−1.6045a+59.318, −0.009a²+0.6045a+40.682) and
   point W (0.0, 100.0−a, 0.0),
   or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
   point G (0.0111a²−1.3152a+68.986, −0.0111a²+0.3152a+31.014, 0.0),
   point I (0.0111a²−1.3152a+68.986, 0.0, −0.0111a²+0.3152a+31.014),
   point A (0.0103a²−1.9225a+68.793, 0.0, −0.0103a²+0.9225a+31.207),
   point B (0.0, 0.0046a²−1.41a+57.286, −0.0046a²+0.41a+42.714) and
   point W (0.0, 100.0−a, 0.0),
   or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
   point G (0.0061a²−0.9918a+63.902, −0.0061a²−0.0082a+36.098, 0.0),
   point I (0.0061a²−0.9918a+63.902, 0.0, −0.0061a²−0.0082a+36.098),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05) and
   point W (0.0, 100.0−a, 0.0),
   or on the straight lines GI and AB (excluding point G, point I, point A, point B, and point W). When the refrigerant according to the present disclosure satisfies the above requirements, it has a refrigerating capacity ratio of 85% or more relative to that of R410A, and a COP ratio of 92.5% or more relative to that of R410A, and further ensures a WCF lower flammability.
The refrigerant C according to the present disclosure is preferably a refrigerant wherein
when the mass % of HFO-1132(E), HFO-1123, and R1234yf based on their sum is respectively represented by x, y, and z,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
   point J (0.0049a²−0.9645a+47.1, −0.0049a²−0.0355a+52.9, 0.0),
   point K′ (0.0514a²−2.4353a+61.7, −0.0323a²+0.4122a+5.9, −0.0191a²+1.0231a+32.4),
   point B (0.0, 0.0144a²−1.6377a+58.7, −0.0144a²+0.6377a+41.3),
   point D′ (0.0, 0.0224a²+0.968a+75.4, −0.0224a²−1.968a+24.6), and
   point C (−0.2304a²−0.4062a+32.9, 0.2304a²−0.5938a+67.1, 0.0),
   or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
   point J (0.0243a²−1.4161a+49.725, −0.0243a²+0.4161a+50.275, 0.0),
   point K′ (0.0341a²−2.1977a+61.187, −0.0236a²+0.34a+5.636, −0.0105a²+0.8577a+33.177),
   point B (0.0, 0.0075a²−1.5156a+58.199, −0.0075a²+0.5156a+41.801) and
   point W (0.0, 100.0−a, 0.0),
   or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
   point J (0.0246a²−1.4476a+50.184, −0.0246a²+0.4476a+49.816, 0.0),
   point K′ (0.0196a²−1.7863a+58.515, −0.0079a²−0.1136a+8.702, −0.0117a²+0.8999a+32.783),
   point B (0.0, 0.009a²−1.6045a+59.318, −0.009a²+0.6045a+40.682) and
   point W (0.0, 100.0−a, 0.0),
   or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
   point J (0.0183a²−1.1399a+46.493, −0.0183a²+0.1399a+53.507, 0.0),
   point K′ (−0.0051a²+0.0929a+25.95, 0.0, 0.0051a²−1.0929a+74.05),
   point A (0.0103a²−1.9225a+68.793, 0.0, −0.0103a²+0.9225a+31.207),
   point B (0.0, 0.0046a²−1.41a+57.286, −0.0046a²+0.41a+42.714) and
   point W (0.0, 100.0−a, 0.0),
   or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
   point J (−0.0134a²+1.0956a+7.13, 0.0134a²−2.0956a+92.87, 0.0),
   point K′ (−1.892a+29.443, 0.0, 0.892a+70.557),
   point A (0.0085a²−1.8102a+67.1, 0.0, −0.0085a²+0.8102a+32.9),
   point B (0.0, 0.0012a²−1.1659a+52.95, −0.0012a²+0.1659a+47.05) and
   point W (0.0, 100.0−a, 0.0),
   or on the straight lines JK′, K′A, and AB (excluding point J, point B, and point W). When the refrigerant according to the present disclosure satisfies the above requirements, it has a refrigerating capacity ratio of 85% or more relative to that of R410A, and a COP ratio of 92.5% or more relative to that of R410A. Additionally, the refrigerant has a WCF lower flammability and a WCFF lower flammability, and is classified as “Class 2L,” which is a lower flammable refrigerant according to the ASHRAE standard.
When the refrigerant C according to the present disclosure further contains R32 in addition to HFO-1132 (E), HFO-1123, and R1234yf, the refrigerant may be a refrigerant wherein when the mass % of HFO-1132(E), HFO-1123, R1234yf, and R32 based on their sum is respectively represented by x, y, z, and a,
if 0<a≤10.0, coordinates (x,y,z) in a ternary composition diagram in which the sum of HFO-1132(E), HFO-1123, and R1234yf is (100−a) mass % are within the range of a figure surrounded by straight lines that connect the following 4 points:
   point a (0.02a²−2.46a+93.4, 0, −0.02a²+2.46a+6.6),
   point b′ (−0.008a²−1.38a+56, 0.018a²−0.53a+26.3, −0.01a²+1.91a+17.7),
   point c (−0.016a²+1.02a+77.6, 0.016a²−1.02a+22.4, 0), and
   point o (100.0−a, 0.0, 0.0)
   or on the straight lines oa, ab′, and b′c (excluding point o and point c);
if 10.0<a≤16.5, coordinates (x,y,z) in the ternary composition diagram are within the range of a figure surrounded by straight lines that connect the following 4 points:
   point a (0.0244a²−2.5695a+94.056, 0, −0.0244a²+2.5695a+5.944),
   point b′ (0.1161a²−1.9959a+59.749, 0.014a²−0.3399a+24.8, −0.1301a²+2.3358a+15.451),
   point c (−0.0161a²+1.02a+77.6, 0.0161a²−1.02a+22.4, 0), and
   point o (100.0−a, 0.0, 0.0),
   or on the straight lines oa, ab′, and b′c (excluding point o and point c); or
if 16.5<a≤21.8, coordinates (x,y,z) in the ternary composition diagram are within the range of a figure surrounded by straight lines that connect the following 4 points:
   point a (0.0161a²−2.3535a+92.742, 0, −0.0161a²+2.3535a+7.258),
   point b′ (−0.0435a²−0.0435a+50.406, 0.0304a²+1.8991a−0.0661, 0.0739a²−1.8556a+49.6601),
   point c (−0.0161a²+0.9959a+77.851, 0.0161a²−0.9959a+22.149, 0), and
   point o (100.0−a, 0.0, 0.0),
   or on the straight lines oa, ab′, and b′c (excluding point o and point c). Note that when point b in the ternary composition diagram is defined as a point where a refrigerating capacity ratio of 95% relative to that of R410A and a COP ratio of 95% relative to that of R410A are both achieved, point b′ is the intersection of straight line ab and an approximate line formed by connecting the points where the COP ratio relative to that of R410A is 95%. When the refrigerant according to the present disclosure meets the above requirements, the refrigerant has a refrigerating capacity ratio of 95% or more relative to that of R410A, and a COP ratio of 95% or more relative to that of R410A.
The refrigerant C according to the present disclosure may further comprise other additional refrigerants in addition to HFO-1132(E), HFO-1123, R1234yf, and R32 as long as the above properties and effects are not impaired. In this respect, the refrigerant according to the present disclosure preferably comprises HFO-1132(E), HFO-1123, R1234yf, and R32 in a total amount of 99.5 mass % or more, more preferably 99.75 mass % or more, and still more preferably 99.9 mass % or more, based on the entire refrigerant.
The refrigerant C according to the present disclosure may comprise HFO-1132(E), HFO-1123, R1234yf, and R32 in a total amount of 99.5 mass % or more, 99.75 mass % or more, or 99.9 mass % or more, based on the entire refrigerant.
Additional refrigerants are not particularly limited and can be widely selected. The mixed refrigerant may contain one additional refrigerant, or two or more additional refrigerants.

### (Examples of Refrigerant C)

The present disclosure is described in more detail below with reference to Examples of refrigerant C. However, the refrigerant C is not limited to the Examples.
Mixed refrigerants were prepared by mixing HFO-1132(E), HFO-1123, R1234yf, and R32 at mass % based on their sum shown in Tables 39 to 96.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in WO2015/141678). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
For each of these mixed refrigerants, the COP ratio and the refrigerating capacity ratio relative to those of R410 were obtained. Calculation was conducted under the following conditions.
Evaporating temperature: 5° C.
Condensation temperature: 45° C.
Superheating temperature: 5 K
Subcooling temperature: 5 K
Compressor efficiency: 70%
Tables 39 to 96 show the resulting values together with the GWP of each mixed refrigerant. The COP and refrigerating capacity are ratios relative to R410A.
The coefficient of performance (COP) was determined by the following formula.

COP=(refrigerating capacity or heating capacity)/power consumption

TABLE 39

| | | | Comp. | Comp. | Comp. | Comp. | Comp. | Comp. | Comp. | Ex. |
|---|---|---|---|---|---|---|---|---|---|---|
| | | Comp. | Ex. 2 | Ex. 3 | Ex. 4 | Ex. 5 | Ex. 6 | Ex. 7 | Ex. 8 | 1 |
| Item | Unit | Ex. 1 | A | B | C | D′ | G | I | J | K′ |
| HFO-1132(E) | Mass % | R410A | 68.6 | 0.0 | 32.9 | 0.0 | 72.0 | 72.0 | 47.1 | 61.7 |
| HFO-1123 | Mass % | | 0.0 | 58.7 | 67.1 | 75.4 | 28.0 | 0.0 | 52.9 | 5.9 |
| R1234yf | Mass % | | 31.4 | 41.3 | 0.0 | 24.6 | 0.0 | 28.0 | 0.0 | 32.4 |
| R32 | Mass % | | 0.0 | 0.0 | 0.0 | 0.0 | 0.0 | 0.0 | 0.0 | 0.0 |
| GWP | — | 2088 | 2 | 2 | 1 | 2 | 1 | 2 | 1 | 2 |
| | % (relative | | | | | | | | | |
| COP ratio | to R410A) | 100 | 100.0 | 95.5 | 92.5 | 93.1 | 96.6 | 99.9 | 93.8 | 99.4 |
| Refrigerating | % (relative | | | | | | | | | |
| capacity ratio | to R410A) | 100 | 85.0 | 85.0 | 107.4 | 95.0 | 103.1 | 86.6 | 106.2 | 85.5 |

TABLE 40

| | | Comp. | Comp. | Comp. | Comp. | Comp. | Comp. | Comp. | Ex. |
|---|---|---|---|---|---|---|---|---|---|
| | | Ex. 9 | Ex. 10 | Ex. 11 | Ex. 12 | Ex. 13 | Ex. 14 | Ex. 15 | 2 |
| Item | Unit | A | B | C | D′ | G | I | J | K′ |
| HFO-1132(E) | Mass % | 55.3 | 0.0 | 18.4 | 0.0 | 60.9 | 60.9 | 40.5 | 47.0 |
| HFO-1123 | Mass % | 0.0 | 47.8 | 74.5 | 83.4 | 32.0 | 0.0 | 52.4 | 7.2 |
| R1234yf | Mass % | 37.6 | 45.1 | 0.0 | 9.5 | 0.0 | 32.0 | 0.0 | 38.7 |
| R32 | Mass % | 7.1 | 7.1 | 7.1 | 7.1 | 7.1 | 7.1 | 7.1 | 7.1 |
| GWP | — | 50 | 50 | 49 | 49 | 49 | 50 | 49 | 50 |
| COP ratio | % (relative | 99.8 | 96.9 | 92.5 | 92.5 | 95.9 | 99.6 | 94.0 | 99.2 |
| | to R410A) | | | | | | | | |
| Refrigerating | % (relative | 85.0 | 85.0 | 110.5 | 106.0 | 106.5 | 87.7 | 108.9 | 85.5 |
| capacity ratio | to R410A) | | | | | | | | |

TABLE 41

| | | Comp. | Comp. | Comp. | Comp. | Comp. | Comp. | Ex. |
|---|---|---|---|---|---|---|---|---|
| | | Ex. 16 | Ex. 17 | Ex. 18 | Ex. 19 | Ex. 20 | Ex. 21 | 3 |
| Item | Unit | A | B | C = D′ | G | I | J | K′ |
| HFO-1132(E) | Mass % | 48.4 | 0.0 | 0.0 | 55.8 | 55.8 | 37.0 | 41.0 |
| HFO-1123 | Mass % | 0.0 | 42.3 | 88.9 | 33.1 | 0.0 | 51.9 | 6.5 |
| R1234yf | Mass % | 40.5 | 46.6 | 0.0 | 0.0 | 33.1 | 0.0 | 41.4 |
| R32 | Mass % | 11.1 | 11.1 | 11.1 | 11.1 | 11.1 | 11.1 | 11.1 |
| GWP | — | 77 | 77 | 76 | 76 | 77 | 76 | 77 |
| COP ratio | % (relative | 99.8 | 97.6 | 92.5 | 95.8 | 99.5 | 94.2 | 99.3 |
| | to R410A) | | | | | | | |
| Refrigerating | % (relative | 85.0 | 85.0 | 112.0 | 108.0 | 88.6 | 110.2 | 85.4 |
| capacity ratio | to R410A) | | | | | | | |

TABLE 42

| | | Comp. | Comp. | Comp. | Comp. | Comp. | Ex. |
|---|---|---|---|---|---|---|---|
| | | Ex. 22 | Ex. 23 | Ex. 24 | Ex. 25 | Ex. 26 | 4 |
| Item | Unit | A | B | G | I | J | K′ |
| HFO-1132(E) | Mass % | 42.8 | 0.0 | 52.1 | 52.1 | 34.3 | 36.5 |
| HFO-1123 | Mass % | 0.0 | 37.8 | 33.4 | 0.0 | 51.2 | 5.6 |
| R1234yf | Mass % | 42.7 | 47.7 | 0.0 | 33.4 | 0.0 | 43.4 |
| R32 | Mass % | 14.5 | 14.5 | 14.5 | 14.5 | 14.5 | 14.5 |
| GWP | — | 100 | 100 | 99 | 100 | 99 | 100 |
| COP ratio | % (relative | 99.9 | 98.1 | 95.8 | 99.5 | 94.4 | 99.5 |
| | to R410A) | | | | | | |
| Refrigerating | % (relative | 85.0 | 85.0 | 109.1 | 89.6 | 111.1 | 85.3 |
| capacity ratio | to R410A) | | | | | | |

TABLE 43

| | | Comp. | Comp. | Comp. | Comp. | Comp. | Ex. |
|---|---|---|---|---|---|---|---|
| | | Ex. 27 | Ex. 28 | Ex. 29 | Ex. 30 | Ex. 31 | 5 |
| Item | Unit | A | B | G | I | J | K′ |
| HFO-1132(E) | Mass % | 37.0 | 0.0 | 48.6 | 48.6 | 32.0 | 32.5 |
| HFO-1123 | Mass % | 0.0 | 33.1 | 33.2 | 0.0 | 49.8 | 4.0 |
| R1234yf | Mass % | 44.8 | 48.7 | 0.0 | 33.2 | 0.0 | 45.3 |
| R32 | Mass % | 18.2 | 18.2 | 18.2 | 18.2 | 18.2 | 18.2 |
| GWP | — | 125 | 125 | 124 | 125 | 124 | 125 |
| COP ratio | % (relative | 100.0 | 98.6 | 95.9 | 99.4 | 94.7 | 99.8 |
| | to R410A) | | | | | | |
| Refrigerating | % (relative | 85.0 | 85.0 | 110.1 | 90.8 | 111.9 | 85.2 |
| capacity ratio | to R410A) | | | | | | |

TABLE 44

| | | Comp. | Comp. | Comp. | Comp. | Comp. | Ex. |
|---|---|---|---|---|---|---|---|
| | | Ex. 32 | Ex. 33 | Ex. 34 | Ex. 35 | Ex. 36 | 6 |
| Item | Unit | A | B | G | I | J | K′ |
| HFO-1132(E) | Mass % | 31.5 | 0.0 | 45.4 | 45.4 | 30.3 | 28.8 |
| HFO-1123 | Mass % | 0.0 | 28.5 | 32.7 | 0.0 | 47.8 | 2.4 |
| R1234yf | Mass % | 46.6 | 49.6 | 0.0 | 32.7 | 0.0 | 46.9 |
| R32 | Mass % | 21.9 | 21.9 | 21.9 | 21.9 | 21.9 | 21.9 |
| GWP | — | 150 | 150 | 149 | 150 | 149 | 150 |
| COP ratio | % (relative | 100.2 | 99.1 | 96.0 | 99.4 | 95.1 | 100.0 |
| | to R410A) | | | | | | |
| Refrigerating | % (relative | 85.0 | 85.0 | 111.0 | 92.1 | 112.6 | 85.1 |
| capacity ratio | to R410A) | | | | | | |

TABLE 45

| | | Comp. | Comp. | Comp. | Comp. | Comp. | Comp. |
|---|---|---|---|---|---|---|---|
| | | Ex. 37 | Ex. 38 | Ex. 39 | Ex. 40 | Ex. 41 | Ex. 42 |
| Item | Unit | A | B | G | I | J | K′ |
| HFO-1132(E) | Mass % | 24.8 | 0.0 | 41.8 | 41.8 | 29.1 | 24.8 |
| HFO-1123 | Mass % | 0.0 | 22.9 | 31.5 | 0.0 | 44.2 | 0.0 |
| R1234yf | Mass % | 48.5 | 50.4 | 0.0 | 31.5 | 0.0 | 48.5 |
| R32 | Mass % | 26.7 | 26.7 | 26.7 | 26.7 | 26.7 | 26.7 |
| GWP | — | 182 | 182 | 181 | 182 | 181 | 182 |
| COP ratio | % (relative | 100.4 | 99.8 | 96.3 | 99.4 | 95.6 | 100.4 |
| | to R410A) | | | | | | |
| Refrigerating | % (relative | 85.0 | 85.0 | 111.9 | 93.8 | 113.2 | 85.0 |
| capacity ratio | to R410A) | | | | | | |

TABLE 46

| | | Comp. | Comp. | Comp. | Comp. | Comp. | Comp. |
|---|---|---|---|---|---|---|---|
| | | Ex. 43 | Ex. 44 | Ex. 45 | Ex. 46 | Ex. 47 | Ex. 48 |
| Item | Unit | A | B | G | I | J | K′ |
| HFO-1132(E) | Mass % | 21.3 | 0.0 | 40.0 | 40.0 | 28.8 | 24.3 |
| HFO-1123 | Mass % | 0.0 | 19.9 | 30.7 | 0.0 | 41.9 | 0.0 |
| R1234yf | Mass % | 49.4 | 50.8 | 0.0 | 30.7 | 0.0 | 46.4 |
| R32 | Mass % | 29.3 | 29.3 | 29.3 | 29.3 | 29.3 | 29.3 |
| GWP | — | 200 | 200 | 198 | 199 | 198 | 200 |
| COP ratio | % (relative | 100.6 | 100.1 | 96.6 | 99.5 | 96.1 | 100.4 |
| | to R410A) | | | | | | |
| Refrigerating | % (relative | 85.0 | 85.0 | 112.4 | 94.8 | 113.6 | 86.7 |
| capacity ratio | to R410A) | | | | | | |

TABLE 47

| | | Comp. | Comp. | Comp. | Comp. | Comp. | Comp. |
|---|---|---|---|---|---|---|---|
| | | Ex. 49 | Ex. 50 | Ex. 51 | Ex. 52 | Ex. 53 | Ex. 54 |
| Item | Unit | A | B | G | I | J | K′ |
| HFO-1132(E) | Mass % | 12.1 | 0.0 | 35.7 | 35.7 | 29.3 | 22.5 |
| HFO-1123 | Mass % | 0.0 | 11.7 | 27.6 | 0.0 | 34.0 | 0.0 |
| R1234yf | Mass % | 51.2 | 51.6 | 0.0 | 27.6 | 0.0 | 40.8 |
| R32 | Mass % | 36.7 | 36.7 | 36.7 | 36.7 | 36.7 | 36.7 |
| GWP | — | 250 | 250 | 248 | 249 | 248 | 250 |
| COP ratio | % (relative | 101.2 | 101.0 | 96.4 | 99.6 | 97.0 | 100.4 |
| | to R410A) | | | | | | |
| Refrigerating | % (relative | 85.0 | 85.0 | 113.2 | 97.6 | 113.9 | 90.9 |
| capacity ratio | to R410A) | | | | | | |

TABLE 48

| | | Comp. | Comp. | Comp. | Comp. | Comp. | Comp. |
|---|---|---|---|---|---|---|---|
| | | Ex. 55 | Ex. 56 | Ex. 57 | Ex. 58 | Ex. 59 | Ex. 60 |
| Item | Unit | A | B | G | I | J | K′ |
| HFO-1132(E) | Mass % | 3.8 | 0.0 | 32.0 | 32.0 | 29.4 | 21.1 |
| HFO-1123 | Mass % | 0.0 | 3.9 | 23.9 | 0.0 | 26.5 | 0.0 |
| R1234yf | Mass % | 52.1 | 52.0 | 0.0 | 23.9 | 0.0 | 34.8 |
| R32 | Mass % | 44.1 | 44.1 | 44.1 | 44.1 | 44.1 | 44.1 |
| GWP | — | 300 | 300 | 298 | 299 | 298 | 299 |
| COP ratio | % (relative | 101.8 | 101.8 | 97.9 | 99.8 | 97.8 | 100.5 |
| | to R410A) | | | | | | |
| Refrigerating | % (relative | 85.0 | 85.0 | 113.7 | 100.4 | 113.9 | 94.9 |
| capacity ratio | to R410A) | | | | | | |

TABLE 49

| | | Comp. | Comp. | Comp. | Comp. | Comp. |
|---|---|---|---|---|---|---|
| | | Ex. 61 | Ex. 62 | Ex. 63 | Ex. 64 | Ex. 65 |
| Item | Unit | A = B | G | I | J | K′ |
| HFO- | Mass % | 0.0 | 30.4 | 30.4 | 28.9 | 20.4 |
| 1132(E) | | | | | | |
| HFO-1123 | Mass % | 0.0 | 21.8 | 0.0 | 23.3 | 0.0 |
| R1234yf | Mass % | 52.2 | 0.0 | 21.8 | 0.0 | 31.8 |
| R32 | Mass % | 47.8 | 47.8 | 47.8 | 47.8 | 47.8 |
| GWP | — | 325 | 323 | 324 | 323 | 324 |
| COP ratio | % | 102.1 | 98.2 | 100.0 | 98.2 | 100.6 |
| | (relative | | | | | |
| | to R410A) | | | | | |
| Refrigerating | % | 85.0 | 113.8 | 101.8 | 113.9 | 96.8 |
| capacity | (relative | | | | | |
| ratio | to R410A) | | | | | |

TABLE 50

| | | Comp. | Ex. | Ex. | Ex. | Ex. | Ex. | Ex. | Ex. |
|---|---|---|---|---|---|---|---|---|---|
| Item | Unit | Ex. 66 | 7 | 8 | 9 | 10 | 11 | 12 | 13 |
| HFO-1132(E) | Mass % | 5.0 | 10.0 | 15.0 | 20.0 | 25.0 | 30.0 | 35.0 | 40.0 |
| HFO-1123 | Mass % | 82.9 | 77.9 | 72.9 | 67.9 | 62.9 | 57.9 | 52.9 | 47.9 |
| R1234yf | Mass % | 5.0 | 5.0 | 5.0 | 5.0 | 5.0 | 5.0 | 5.0 | 5.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 92.4 | 92.6 | 92.8 | 93.1 | 93.4 | 93.7 | 94.1 | 94.5 |
| | to R410A) | | | | | | | | |
| Refrigerating | % (relative | 108.4 | 108.3 | 108.2 | 107.9 | 107.6 | 107.2 | 106.8 | 106.3 |
| capacity ratio | to R410A) | | | | | | | | |

TABLE 51

| | | Ex. | Ex. | Ex. | Ex. | Comp. | Ex. | Ex. | Ex. |
|---|---|---|---|---|---|---|---|---|---|
| Item | Unit | 14 | 15 | 16 | 17 | Ex. 67 | 18 | 19 | 20 |
| HFO-1132(E) | Mass % | 45.0 | 50.0 | 55.0 | 60.0 | 65.0 | 10.0 | 15.0 | 20.0 |
| HFO-1123 | Mass % | 42.9 | 37.9 | 32.9 | 27.9 | 22.9 | 72.9 | 67.9 | 62.9 |
| R1234yf | Mass % | 5.0 | 5.0 | 5.0 | 5.0 | 5.0 | 10.0 | 10.0 | 10.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 95.0 | 95.4 | 95.9 | 96.4 | 96.9 | 93.0 | 93.3 | 93.6 |
| | to R410A) | | | | | | | | |
| Refrigerating | % (relative | 105.8 | 105.2 | 104.5 | 103.9 | 103.1 | 105.7 | 105.5 | 105.2 |
| capacity ratio | to R410A) | | | | | | | | |

TABLE 52

| | | Ex. | Ex. | Ex. | Ex. | Ex. | Ex. | Ex. | Ex. |
|---|---|---|---|---|---|---|---|---|---|
| Item | Unit | 21 | 22 | 23 | 24 | 25 | 26 | 27 | 28 |
| HFO-1132(E) | Mass % | 25.0 | 30.0 | 35.0 | 40.0 | 45.0 | 50.0 | 55.0 | 60.0 |
| HFO-1123 | Mass % | 57.9 | 52.9 | 47.9 | 42.9 | 37.9 | 32.9 | 27.9 | 22.9 |
| R1234yf | Mass % | 10.0 | 10.0 | 10.0 | 10.0 | 10.0 | 10.0 | 10.0 | 10.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 93.9 | 94.2 | 94.6 | 95.0 | 95.5 | 96.0 | 96.4 | 96.9 |
| | to R410A) | | | | | | | | |
| Refrigerating | % (relative | 104.9 | 104.5 | 104.1 | 103.6 | 103.0 | 102.4 | 101.7 | 101.0 |
| capacity ratio | to R410A) | | | | | | | | |

TABLE 53

| | | Comp. | Ex. | Ex. | Ex. | Ex. | Ex. | Ex. | Ex. |
|---|---|---|---|---|---|---|---|---|---|
| Item | Unit | Ex. 68 | 29 | 30 | 31 | 32 | 33 | 34 | 35 |
| HFO-1132(E) | Mass % | 65.0 | 10.0 | 15.0 | 20.0 | 25.0 | 30.0 | 35.0 | 40.0 |
| HFO-1123 | Mass % | 17.9 | 67.9 | 62.9 | 57.9 | 52.9 | 47.9 | 42.9 | 37.9 |
| R1234yf | Mass % | 10.0 | 15.0 | 15.0 | 15.0 | 15.0 | 15.0 | 15.0 | 15.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 97.4 | 93.5 | 93.8 | 94.1 | 94.4 | 94.8 | 95.2 | 95.6 |
| | to R410A) | | | | | | | | |
| Refrigerating | % (relative | 100.3 | 102.9 | 102.7 | 102.5 | 102.1 | 101.7 | 101.2 | 100.7 |
| capacity ratio | to R410A) | | | | | | | | |

TABLE 54

| | | Ex. | Ex. | Ex. | Ex. | Comp. | Ex. | Ex. | Ex. |
|---|---|---|---|---|---|---|---|---|---|
| Item | Unit | 36 | 37 | 38 | 39 | Ex. 69 | 40 | 41 | 42 |
| HFO-1132(E) | Mass % | 45.0 | 50.0 | 55.0 | 60.0 | 65.0 | 10.0 | 15.0 | 20.0 |
| HFO-1123 | Mass % | 32.9 | 27.9 | 22.9 | 17.9 | 12.9 | 62.9 | 57.9 | 52.9 |
| R1234yf | Mass % | 15.0 | 15.0 | 15.0 | 15.0 | 15.0 | 20.0 | 20.0 | 20.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 96.0 | 96.5 | 97.0 | 97.5 | 98.0 | 94.0 | 94.3 | 94.6 |
| | to R410A) | | | | | | | | |
| Refrigerating | % (relative | 100.1 | 99.5 | 98.9 | 98.1 | 97.4 | 100.1 | 99.9 | 99.6 |
| capacity ratio | to R410A) | | | | | | | | |

TABLE 55

| | | Ex. | Ex. | Ex. | Ex. | Ex. | Ex. | Ex. | Ex. |
|---|---|---|---|---|---|---|---|---|---|
| Item | Unit | 43 | 44 | 45 | 46 | 47 | 48 | 49 | 50 |
| HFO-1132(E) | Mass % | 25.0 | 30.0 | 35.0 | 40.0 | 45.0 | 50.0 | 55.0 | 60.0 |
| HFO-1123 | Mass % | 47.9 | 42.9 | 37.9 | 32.9 | 27.9 | 22.9 | 17.9 | 12.9 |
| R1234yf | Mass % | 20.0 | 20.0 | 20.0 | 20.0 | 20.0 | 20.0 | 20.0 | 20.0 |
| R32 | Mass % | 7.1 | 7.1 | 7.1 | 7.1 | 7.1 | 7.1 | 7.1 | 7.1 |
| GWP | — | 49 | 49 | 49 | 49 | 49 | 49 | 49 | 49 |
| COP ratio | % (relative | 95.0 | 95.3 | 95.7 | 96.2 | 96.6 | 97.1 | 97.6 | 98.1 |
| | to R410A) | | | | | | | | |
| Refrigerating | % (relative | 99.2 | 98.8 | 98.3 | 97.8 | 97.2 | 96.6 | 95.9 | 95.2 |
| capacity ratio | to R410A) | | | | | | | | |

TABLE 56

| | | Comp. | Ex. | Ex. | Ex. | Ex. | Ex. | Ex. | Ex. |
|---|---|---|---|---|---|---|---|---|---|
| Item | Unit | Ex. 70 | 51 | 52 | 53 | 54 | 55 | 56 | 57 |
| HFO-1132(E) | Mass % | 65.0 | 10.0 | 15.0 | 20.0 | 25.0 | 30.0 | 35.0 | 40.0 |
| HFO-1123 | Mass % | 7.9 | 57.9 | 52.9 | 47.9 | 42.9 | 37.9 | 32.9 | 27.9 |
| R1234yf | Mass % | 20.0 | 25.0 | 25.0 | 25.0 | 25.0 | 25.0 | 25.0 | 25.0 |
| R32 | Mass % | 7.1 | 7.1 | 7.1 | 7.1 | 7.1 | 7.1 | 7.1 | 7.1 |
| GWP | — | 49 | 50 | 50 | 50 | 50 | 50 | 50 | 50 |
| COP ratio | % (relative | 98.6 | 94.6 | 94.9 | 95.2 | 95.5 | 95.9 | 96.3 | 96.8 |
| | to R410A) | | | | | | | | |
| Refrigerating | % (relative | 94.4 | 97.1 | 96.9 | 96.7 | 96.3 | 95.9 | 95.4 | 94.8 |
| capacity ratio | to R410A) | | | | | | | | |

TABLE 57

| | | Ex. | Ex. | Ex. | Ex. | Comp. | Ex. | Ex. | Ex. |
|---|---|---|---|---|---|---|---|---|---|
| Item | Unit | 58 | 59 | 60 | 61 | Ex. 71 | 62 | 63 | 64 |
| HFO-1132(E) | Mass % | 45.0 | 50.0 | 55.0 | 60.0 | 65.0 | 10.0 | 15.0 | 20.0 |
| HFO-1123 | Mass % | 7.1 | 7.1 | 7.1 | 7.1 | 7.1 | 7.1 | 7.1 | 7.1 |
| R1234yf | Mass % | 25.0 | 25.0 | 25.0 | 25.0 | 25.0 | 30.0 | 30.0 | 30.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative | 97.2 | 97.7 | 98.2 | 98.7 | 99.2 | 95.2 | 95.5 | 95.8 |
| | to R410A) | | | | | | | | |
| Refrigerating | % (relative | 94.2 | 93.6 | 92.9 | 92.2 | 91.4 | 94.2 | 93.9 | 93.7 |
| capacity ratio | to R410A) | | | | | | | | |

TABLE 58

| | | Ex. | Ex. | Ex. | Ex. | Ex. | Ex. | Ex. | Ex. |
|---|---|---|---|---|---|---|---|---|---|
| Item | Unit | 65 | 66 | 67 | 68 | 69 | 70 | 71 | 72 |
| HFO-1132(E) | Mass % | 25.0 | 30.0 | 35.0 | 40.0 | 45.0 | 50.0 | 55.0 | 60.0 |
| HFO-1123 | Mass % | 37.9 | 32.9 | 27.9 | 22.9 | 17.9 | 12.9 | 7.9 | 2.9 |
| R1234yf | Mass % | 30.0 | 30.0 | 30.0 | 30.0 | 30.0 | 30.0 | 30.0 | 30.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative | 96.2 | 96.6 | 97.0 | 97.4 | 97.9 | 98.3 | 98.8 | 99.3 |
| | to R410A) | | | | | | | | |
| Refrigerating | % (relative | 93.3 | 92.9 | 92.4 | 91.8 | 91.2 | 90.5 | 89.8 | 89.1 |
| capacity ratio | to R410A) | | | | | | | | |

TABLE 59

| | | Ex. | Ex. | Ex. | Ex. | Ex. | Ex. | Ex. | Ex. |
|---|---|---|---|---|---|---|---|---|---|
| Item | Unit | 73 | 74 | 75 | 76 | 77 | 78 | 79 | 80 |
| HFO-1132(E) | Mass % | 10.0 | 15.0 | 20.0 | 25.0 | 30.0 | 35.0 | 40.0 | 45.0 |
| HFO-1123 | Mass % | 47.9 | 42.9 | 37.9 | 32.9 | 27.9 | 22.9 | 17.9 | 12.9 |
| R1234yf | Mass % | 35.0 | 35.0 | 35.0 | 35.0 | 35.0 | 35.0 | 35.0 | 35.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative | 95.9 | 96.2 | 96.5 | 96.9 | 97.2 | 97.7 | 98.1 | 98.5 |
| | to R410A) | | | | | | | | |
| Refrigerating | % (relative | 91.1 | 90.9 | 90.6 | 90.2 | 89.8 | 89.3 | 88.7 | 88.1 |
| capacity ratio | to R410A) | | | | | | | | |

TABLE 60

| | | Ex. | Ex. | Ex. | Ex. | Ex. | Ex. | Ex. | Ex. |
|---|---|---|---|---|---|---|---|---|---|
| Item | Unit | 81 | 82 | 83 | 84 | 85 | 86 | 87 | 88 |
| HFO-1132(E) | Mass % | 50.0 | 55.0 | 10.0 | 15.0 | 20.0 | 25.0 | 30.0 | 35.0 |
| HFO-1123 | Mass % | 7.9 | 2.9 | 42.9 | 37.9 | 32.9 | 27.9 | 22.9 | 17.9 |
| R1234yf | Mass % | 35.0 | 35.0 | 40.0 | 40.0 | 40.0 | 40.0 | 40.0 | 40.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative | 99.0 | 99.4 | 96.6 | 96.9 | 97.2 | 97.6 | 98.0 | 98.4 |
| | to R410A) | | | | | | | | |
| Refrigerating | % (relative | 87.4 | 86.7 | 88.0 | 87.8 | 87.5 | 87.1 | 86.6 | 86.1 |
| capacity ratio | to R410A) | | | | | | | | |

TABLE 61

| | | Comp. | Comp. | Comp. | Comp. | Comp. | Comp. | Comp. | Comp. |
|---|---|---|---|---|---|---|---|---|---|
| Item | Unit | Ex. 72 | Ex. 73 | Ex. 74 | Ex. 75 | Ex. 76 | Ex. 77 | Ex. 78 | Ex. 79 |
| HFO-1132(E) | Mass % | 40.0 | 45.0 | 50.0 | 10.0 | 15.0 | 20.0 | 25.0 | 30.0 |
| HFO-1123 | Mass % | 12.9 | 7.9 | 2.9 | 37.9 | 32.9 | 27.9 | 22.9 | 17.9 |
| R1234yf | Mass % | 40.0 | 40.0 | 40.0 | 45.0 | 45.0 | 45.0 | 45.0 | 45.0 |
| R32 | Mass % | 7.1 | 7.1 | 7.1 | 7.1 | 7.1 | 7.1 | 7.1 | 7.1 |
| GWP | — | 50 | 50 | 50 | 50 | 50 | 50 | 50 | 50 |
| COP ratio | % (relative | 98.8 | 99.2 | 99.6 | 97.4 | 97.7 | 98.0 | 98.3 | 98.7 |
| | to R410A) | | | | | | | | |
| Refrigerating | % (relative | 85.5 | 84.9 | 84.2 | 84.9 | 84.6 | 84.3 | 83.9 | 83.5 |
| capacity ratio | to R410A) | | | | | | | | |

TABLE 62

| | | Comp. | Comp. | Comp. |
|---|---|---|---|---|
| Item | Unit | Ex. 80 | Ex. 81 | Ex. 82 |
| HFO-1132(E) | Mass % | 35.0 | 40.0 | 45.0 |
| HFO-1123 | Mass % | 12.9 | 7.9 | 2.9 |
| R1234yf | Mass % | 45.0 | 45.0 | 45.0 |
| R32 | Mass % | 7.1 | 7.1 | 7.1 |
| GWP | — | 50 | 50 | 50 |
| COP ratio | % (relative | 99.1 | 99.5 | 99.9 |
| | to R410A) | | | |
| Refrigerating | % (relative | 82.9 | 82.3 | 81.7 |
| capacity ratio | to R410A) | | | |

TABLE 63

| | | Ex. | Ex. | Ex. | Ex. | Ex. | Ex. | Ex. | Ex. |
|---|---|---|---|---|---|---|---|---|---|
| Item | Unit | 89 | 90 | 91 | 92 | 93 | 94 | 95 | 96 |
| HFO-1132(E) | Mass % | 10.0 | 15.0 | 20.0 | 25.0 | 30.0 | 35.0 | 40.0 | 45.0 |
| HFO-1123 | Mass % | 70.5 | 65.5 | 60.5 | 55.5 | 50.5 | 45.5 | 40.5 | 35.5 |
| R1234yf | Mass % | 5.0 | 5.0 | 5.0 | 5.0 | 5.0 | 5.0 | 5.0 | 5.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 93.7 | 93.9 | 94.1 | 94.4 | 94.7 | 95.0 | 95.4 | 95.8 |
| | to R410A) | | | | | | | | |
| Refrigerating | % (relative | 110.2 | 110.0 | 109.7 | 109.3 | 108.9 | 108.4 | 107.9 | 107.3 |
| capacity ratio | to R410A) | | | | | | | | |

TABLE 64

| | | Ex. | Comp. | Ex. | Ex. | Ex. | Ex. | Ex. | Ex. |
|---|---|---|---|---|---|---|---|---|---|
| Item | Unit | 97 | Ex. 83 | 98 | 99 | 100 | 101 | 102 | 103 |
| HFO-1132(E) | Mass % | 50.0 | 55.0 | 10.0 | 15.0 | 20.0 | 25.0 | 30.0 | 35.0 |
| HFO-1123 | Mass % | 30.5 | 25.5 | 65.5 | 60.5 | 55.5 | 50.5 | 45.5 | 40.5 |
| R1234yf | Mass % | 5.0 | 5.0 | 10.0 | 10.0 | 10.0 | 10.0 | 10.0 | 10.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 96.2 | 96.6 | 94.2 | 94.4 | 94.6 | 94.9 | 95.2 | 95.5 |
| | to R410A) | | | | | | | | |
| Refrigerating | % (relative | 106.6 | 106.0 | 107.5 | 107.3 | 107.0 | 106.6 | 106.1 | 105.6 |
| capacity ratio | to R410A) | | | | | | | | |

TABLE 65

| | | Ex. | Ex. | Ex. | Comp. | Ex. | Ex. | Ex. | Ex. |
|---|---|---|---|---|---|---|---|---|---|
| Item | Unit | 104 | 105 | 106 | Ex. 84 | 107 | 108 | 109 | 110 |
| HFO-1132(E) | Mass % | 40.0 | 45.0 | 50.0 | 55.0 | 10.0 | 15.0 | 20.0 | 25.0 |
| HFO-1123 | Mass % | 35.5 | 30.5 | 25.5 | 20.5 | 60.5 | 55.5 | 50.5 | 45.5 |
| R1234yf | Mass % | 10.0 | 10.0 | 10.0 | 10.0 | 15.0 | 15.0 | 15.0 | 15.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 95.9 | 96.3 | 96.7 | 97.1 | 94.6 | 94.8 | 95.1 | 95.4 |
| | to R410A) | | | | | | | | |
| Refrigerating | % (relative | 105.1 | 104.5 | 103.8 | 103.1 | 104.7 | 104.5 | 104.1 | 103.7 |
| capacity ratio | to R410A) | | | | | | | | |

TABLE 66

| | | Ex. | Ex. | Ex. | Ex. | Ex. | Comp. | Ex. | Ex. |
|---|---|---|---|---|---|---|---|---|---|
| Item | Unit | 111 | 112 | 113 | 114 | 115 | Ex. 85 | 116 | 117 |
| HFO-1132(E) | Mass % | 30.0 | 35.0 | 40.0 | 45.0 | 50.0 | 55.0 | 10.0 | 15.0 |
| HFO-1123 | Mass % | 40.5 | 35.5 | 30.5 | 25.5 | 20.5 | 15.5 | 55.5 | 50.5 |
| R1234yf | Mass % | 15.0 | 15.0 | 15.0 | 15.0 | 15.0 | 15.0 | 20.0 | 20.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 95.7 | 96.0 | 96.4 | 96.8 | 97.2 | 97.6 | 95.1 | 95.3 |
| | to R410A) | | | | | | | | |
| Refrigerating | % (relative | 103.3 | 102.8 | 102.2 | 101.6 | 101.0 | 100.3 | 101.8 | 101.6 |
| capacity ratio | to R410A) | | | | | | | | |

TABLE 67

| | | Ex. | Ex. | Ex. | Ex. | Ex. | Ex. | Ex. | Comp. |
|---|---|---|---|---|---|---|---|---|---|
| Item | Unit | 118 | 119 | 120 | 121 | 122 | 123 | 124 | Ex. 86 |
| HFO-1132(E) | Mass % | 20.0 | 25.0 | 30.0 | 35.0 | 40.0 | 45.0 | 50.0 | 55.0 |
| HFO-1123 | Mass % | 45.5 | 40.5 | 35.5 | 30.5 | 25.5 | 20.5 | 15.5 | 10.5 |
| R1234yf | Mass % | 20.0 | 20.0 | 20.0 | 20.0 | 20.0 | 20.0 | 20.0 | 20.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 95.6 | 95.9 | 96.2 | 96.5 | 96.9 | 97.3 | 97.7 | 98.2 |
| | to R410A) | | | | | | | | |
| Refrigerating | % (relative | 101.2 | 100.8 | 100.4 | 99.9 | 99.3 | 98.7 | 98.0 | 97.3 |
| capacity ratio | to R410A) | | | | | | | | |

TABLE 68

| | | Ex. | Ex. | Ex. | Ex. | Ex. | Ex. | Ex. | Ex. |
|---|---|---|---|---|---|---|---|---|---|
| Item | Unit | 125 | 126 | 127 | 128 | 129 | 130 | 131 | 132 |
| HFO-1132(E) | Mass % | 10.0 | 15.0 | 20.0 | 25.0 | 30.0 | 35.0 | 40.0 | 45.0 |
| HFO-1123 | Mass % | 50.5 | 45.5 | 40.5 | 35.5 | 30.5 | 25.5 | 20.5 | 15.5 |
| R1234yf | Mass % | 25.0 | 25.0 | 25.0 | 25.0 | 25.0 | 25.0 | 25.0 | 25.0 |
| R32 | Mass % | 14.5 | 14.5 | 14.5 | 14.5 | 14.5 | 14.5 | 14.5 | 14.5 |
| GWP | — | 99 | 99 | 99 | 99 | 99 | 99 | 99 | 99 |
| COP ratio | % (relative | 95.6 | 95.9 | 96.1 | 96.4 | 96.7 | 97.1 | 97.5 | 97.9 |
| | to R410A) | | | | | | | | |
| Refrigerating | % (relative to | 98.9 | 98.6 | 98.3 | 97.9 | 97.4 | 96.9 | 96.3 | 95.7 |
| capacity ratio | R410A) | | | | | | | | |

TABLE 69

| | | Ex. | Comp. | Ex. | Ex. | Ex. | Ex. | Ex. | Ex. |
|---|---|---|---|---|---|---|---|---|---|
| Item | Unit | 133 | Ex. 87 | 134 | 135 | 136 | 137 | 138 | 139 |
| HFO-1132(E) | Mass % | 50.0 | 55.0 | 10.0 | 15.0 | 20.0 | 25.0 | 30.0 | 35.0 |
| HFO-1123 | Mass % | 10.5 | 5.5 | 45.5 | 40.5 | 35.5 | 30.5 | 25.5 | 20.5 |
| R1234yf | Mass % | 25.0 | 25.0 | 30.0 | 30.0 | 30.0 | 30.0 | 30.0 | 30.0 |
| R32 | Mass % | 14.5 | 14.5 | 14.5 | 14.5 | 14.5 | 14.5 | 14.5 | 14.5 |
| GWP | — | 99 | 99 | 100 | 100 | 100 | 100 | 100 | 100 |
| COP ratio | % (relative | 98.3 | 98.7 | 96.2 | 96.4 | 96.7 | 97.0 | 97.3 | 97.7 |
| | to R410A) | | | | | | | | |
| Refrigerating | % (relative | 95.0 | 94.3 | 95.8 | 95.6 | 95.2 | 94.8 | 94.4 | 93.8 |
| capacity ratio | to R410A) | | | | | | | | |

TABLE 70

| | | Ex. | Ex. | Ex. | Ex. | Ex. | Ex. | Ex. | Ex. |
|---|---|---|---|---|---|---|---|---|---|
| Item | Unit | 140 | 141 | 142 | 143 | 144 | 145 | 146 | 147 |
| HFO-1132(E) | Mass % | 40.0 | 45.0 | 50.0 | 10.0 | 15.0 | 20.0 | 25.0 | 30.0 |
| HFO-1123 | Mass % | 15.5 | 10.5 | 5.5 | 40.5 | 35.5 | 30.5 | 25.5 | 20.5 |
| R1234yf | Mass % | 30.0 | 30.0 | 30.0 | 35.0 | 35.0 | 35.0 | 35.0 | 35.0 |
| R32 | Mass % | 14.5 | 14.5 | 14.5 | 14.5 | 14.5 | 14.5 | 14.5 | 14.5 |
| GWP | — | 100 | 100 | 100 | 100 | 100 | 100 | 100 | 100 |
| COP ratio | % (relative | 98.1 | 98.5 | 98.9 | 96.8 | 97.0 | 97.3 | 97.6 | 97.9 |
| | to R410A) | | | | | | | | |
| Refrigerating | % (relative | 93.3 | 92.6 | 92.0 | 92.8 | 92.5 | 92.2 | 91.8 | 91.3 |
| capacity ratio | to R410A) | | | | | | | | |

TABLE 71

| | | Ex. | Ex. | Ex. | Ex. | Ex. | Ex. | Ex. | Ex. |
|---|---|---|---|---|---|---|---|---|---|
| Item | Unit | 148 | 149 | 150 | 151 | 152 | 153 | 154 | 155 |
| HFO-1132(E) | Mass % | 35.0 | 40.0 | 45.0 | 10.0 | 15.0 | 20.0 | 25.0 | 30.0 |
| HFO-1123 | Mass % | 15.5 | 10.5 | 5.5 | 35.5 | 30.5 | 25.5 | 20.5 | 15.5 |
| R1234yf | Mass % | 35.0 | 35.0 | 35.0 | 40.0 | 40.0 | 40.0 | 40.0 | 40.0 |
| R32 | Mass % | 14.5 | 14.5 | 14.5 | 14.5 | 14.5 | 14.5 | 14.5 | 14.5 |
| GWP | — | 100 | 100 | 100 | 100 | 100 | 100 | 100 | 100 |
| COP ratio | % (relative | 98.3 | 98.7 | 99.1 | 97.4 | 97.7 | 98.0 | 98.3 | 98.6 |
| | to R410A) | | | | | | | | |
| Refrigerating | % (relative | 90.8 | 90.2 | 89.6 | 89.6 | 89.4 | 89.0 | 88.6 | 88.2 |
| capacity ratio | to R410A) | | | | | | | | |

TABLE 72

| | | Ex. | Ex. | Ex. | Ex. | Ex. | Comp. | Comp. | Comp. |
|---|---|---|---|---|---|---|---|---|---|
| Item | Unit | 156 | 157 | 158 | 159 | 160 | Ex. 88 | Ex. 89 | Ex. 90 |
| HFO-1132(E) | Mass % | 35.0 | 40.0 | 10.0 | 15.0 | 20.0 | 25.0 | 30.0 | 35.0 |
| HFO-1123 | Mass % | 10.5 | 5.5 | 30.5 | 25.5 | 20.5 | 15.5 | 10.5 | 5.5 |
| R1234yf | Mass % | 40.0 | 40.0 | 45.0 | 45.0 | 45.0 | 45.0 | 45.0 | 45.0 |
| R32 | Mass % | 14.5 | 14.5 | 14.5 | 14.5 | 14.5 | 14.5 | 14.5 | 14.5 |
| GWP | — | 100 | 100 | 100 | 100 | 100 | 100 | 100 | 100 |
| COP ratio | % (relative | 98.9 | 99.3 | 98.1 | 98.4 | 98.7 | 98.9 | 99.3 | 99.6 |
| | to R410A) | | | | | | | | |
| Refrigerating | % (relative | 87.6 | 87.1 | 86.5 | 86.2 | 85.9 | 85.5 | 85.0 | 84.5 |
| capacity ratio | to R410A) | | | | | | | | |

TABLE 73

| | | Comp. | Comp. | Comp. | Comp. | Comp. |
|---|---|---|---|---|---|---|
| Item | Unit | Ex. 91 | Ex. 92 | Ex. 93 | Ex. 94 | Ex. 95 |
| HFO- | Mass % | 10.0 | 15.0 | 20.0 | 25.0 | 30.0 |
| 1132(E) | | | | | | |
| HFO-1123 | Mass % | 25.5 | 20.5 | 15.5 | 10.5 | 5.5 |
| R1234yf | Mass % | 50.0 | 50.0 | 50.0 | 50.0 | 50.0 |
| R32 | Mass % | 14.5 | 14.5 | 14.5 | 14.5 | 14.5 |
| GWP | — | 100 | 100 | 100 | 100 | 100 |
| COP ratio | % (relative | 98.9 | 99.1 | 99.4 | 99.7 | 100.0 |
| | to R410A) | | | | | |
| Refrigerating | % (relative | 83.3 | 83.0 | 82.7 | 82.2 | 81.8 |
| capacity ratio | to R410A) | | | | | |

TABLE 74

| | | Ex. | Ex. | Ex. | Ex. | Ex. | Ex. | Ex. | Ex. |
|---|---|---|---|---|---|---|---|---|---|
| Item | Unit | 161 | 162 | 163 | 164 | 165 | 166 | 167 | 168 |
| HFO-1132(E) | Mass % | 10.0 | 15.0 | 20.0 | 25.0 | 30.0 | 35.0 | 40.0 | 45.0 |
| HFO-1123 | Mass % | 63.1 | 58.1 | 53.1 | 48.1 | 43.1 | 38.1 | 33.1 | 28.1 |
| R1234yf | Mass % | 5.0 | 5.0 | 5.0 | 5.0 | 5.0 | 5.0 | 5.0 | 5.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 94.8 | 95.0 | 95.2 | 95.4 | 95.7 | 95.9 | 96.2 | 96.6 |
| | to R410A) | | | | | | | | |
| Refrigerating | % (relative | 111.5 | 111.2 | 110.9 | 110.5 | 110.0 | 109.5 | 108.9 | 108.3 |
| capacity ratio | to R410A) | | | | | | | | |

TABLE 75

| | | Comp. | Ex. | Ex. | Ex. | Ex. | Ex. | Ex. | Ex. |
|---|---|---|---|---|---|---|---|---|---|
| Item | Unit | Ex. 96 | 169 | 170 | 171 | 172 | 173 | 174 | 175 |
| HFO-1132(E) | Mass % | 50.0 | 10.0 | 15.0 | 20.0 | 25.0 | 30.0 | 35.0 | 40.0 |
| HFO-1123 | Mass % | 23.1 | 58.1 | 53.1 | 48.1 | 43.1 | 38.1 | 33.1 | 28.1 |
| R1234yf | Mass % | 5.0 | 10.0 | 10.0 | 10.0 | 10.0 | 10.0 | 10.0 | 10.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 96.9 | 95.3 | 95.4 | 95.6 | 95.8 | 96.1 | 96.4 | 96.7 |
| | to R410A) | | | | | | | | |
| Refrigerating | % (relative | 107.7 | 108.7 | 108.5 | 108.1 | 107.7 | 107.2 | 106.7 | 106.1 |
| capacity ratio | to R410A) | | | | | | | | |

TABLE 76

| | | Ex. | Comp. | Ex. | Ex. | Ex. | Ex. | Ex. | Ex. |
|---|---|---|---|---|---|---|---|---|---|
| Item | Unit | 176 | Ex. 97 | 177 | 178 | 179 | 180 | 181 | 182 |
| HFO-1132(E) | Mass % | 45.0 | 50.0 | 10.0 | 15.0 | 20.0 | 25.0 | 30.0 | 35.0 |
| HFO-1123 | Mass % | 23.1 | 18.1 | 53.1 | 48.1 | 43.1 | 38.1 | 33.1 | 28.1 |
| R1234yf | Mass % | 10.0 | 10.0 | 15.0 | 15.0 | 15.0 | 15.0 | 15.0 | 15.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 97.0 | 97.4 | 95.7 | 95.9 | 96.1 | 96.3 | 96.6 | 96.9 |
| | to R410A) | | | | | | | | |
| Refrigerating | % (relative | 105.5 | 104.9 | 105.9 | 105.6 | 105.3 | 104.8 | 104.4 | 103.8 |
| capacity ratio | to R410A) | | | | | | | | |

TABLE 77

| | | Ex. | Ex. | Comp. | Ex. | Ex. | Ex. | Ex. | Ex. |
|---|---|---|---|---|---|---|---|---|---|
| Item | Unit | 183 | 184 | Ex. 98 | 185 | 186 | 187 | 188 | 189 |
| HFO-1132(E) | Mass % | 40.0 | 45.0 | 50.0 | 10.0 | 15.0 | 20.0 | 25.0 | 30.0 |
| HFO-1123 | Mass % | 23.1 | 18.1 | 13.1 | 48.1 | 43.1 | 38.1 | 33.1 | 28.1 |
| R1234yf | Mass % | 15.0 | 15.0 | 15.0 | 20.0 | 20.0 | 20.0 | 20.0 | 20.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 97.2 | 97.5 | 97.9 | 96.1 | 96.3 | 96.5 | 96.8 | 97.1 |
| | to R410A) | | | | | | | | |
| Refrigerating | % (relative | 103.3 | 102.6 | 102.0 | 103.0 | 102.7 | 102.3 | 101.9 | 101.4 |
| capacity ratio | to R410A) | | | | | | | | |

TABLE 78

| | | Ex. | Ex. | Ex. | Comp. | Ex. | Ex. | Ex. | Ex. |
|---|---|---|---|---|---|---|---|---|---|
| Item | Unit | 190 | 191 | 192 | Ex. 99 | 193 | 194 | 195 | 196 |
| HFO-1132(E) | Mass % | 35.0 | 40.0 | 45.0 | 50.0 | 10.0 | 15.0 | 20.0 | 25.0 |
| HFO-1123 | Mass % | 23.1 | 18.1 | 13.1 | 8.1 | 43.1 | 38.1 | 33.1 | 28.1 |
| R1234yf | Mass % | 20.0 | 20.0 | 20.0 | 20.0 | 25.0 | 25.0 | 25.0 | 25.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 149 | 149 | 149 |
| COP ratio | % (relative | 97.4 | 97.7 | 98.0 | 98.4 | 96.6 | 96.8 | 97.0 | 97.3 |
| | to R410A) | | | | | | | | |
| Refrigerating | % (relative | 100.9 | 100.3 | 99.7 | 99.1 | 100.0 | 99.7 | 99.4 | 98.9 |
| capacity ratio | to R410A) | | | | | | | | |

TABLE 79

| | | Ex. | Ex. | Ex. | Ex. | Comp. | Ex. | Ex. | Ex. |
|---|---|---|---|---|---|---|---|---|---|
| Item | Unit | 197 | 198 | 199 | 200 | Ex. 100 | 201 | 202 | 203 |
| HFO-1132(E) | Mass % | 30.0 | 35.0 | 40.0 | 45.0 | 50.0 | 10.0 | 15.0 | 20.0 |
| HFO-1123 | Mass % | 23.1 | 18.1 | 13.1 | 8.1 | 3.1 | 38.1 | 33.1 | 28.1 |
| R1234yf | Mass % | 25.0 | 25.0 | 25.0 | 25.0 | 25.0 | 30.0 | 30.0 | 30.0 |
| R32 | Mass % | 21.9 | 21.9 | 21.9 | 21.9 | 21.9 | 21.9 | 21.9 | 21.9 |
| GWP | — | 149 | 149 | 149 | 149 | 149 | 150 | 150 | 150 |
| COP ratio | % (relative | 97.6 | 97.9 | 98.2 | 98.5 | 98.9 | 97.1 | 97.3 | 97.6 |
| | to R410A) | | | | | | | | |
| Refrigerating | % (relative | 98.5 | 97.9 | 97.4 | 96.8 | 96.1 | 97.0 | 96.7 | 96.3 |
| capacity ratio | to R410A) | | | | | | | | |

TABLE 80

| | | Ex. | Ex. | Ex. | Ex. | Ex. | Ex. | Ex. | Ex. |
|---|---|---|---|---|---|---|---|---|---|
| Item | Unit | 204 | 205 | 206 | 207 | 208 | 209 | 210 | 211 |
| HFO-1132(E) | Mass % | 25.0 | 30.0 | 35.0 | 40.0 | 45.0 | 10.0 | 15.0 | 20.0 |
| HFO-1123 | Mass % | 23.1 | 18.1 | 13.1 | 8.1 | 3.1 | 33.1 | 28.1 | 23.1 |
| R1234yf | Mass % | 30.0 | 30.0 | 30.0 | 30.0 | 30.0 | 35.0 | 35.0 | 35.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative | 97.8 | 98.1 | 98.4 | 98.7 | 99.1 | 97.7 | 97.9 | 98.1 |
| | to R410A) | | | | | | | | |
| Refrigerating | % (relative | 95.9 | 95.4 | 94.9 | 94.4 | 93.8 | 93.9 | 93.6 | 93.3 |
| capacity ratio | to R410A) | | | | | | | | |

TABLE 81

| | | Ex. | Ex. | Ex. | Ex. | Ex. | Ex. | Ex. | Ex. |
|---|---|---|---|---|---|---|---|---|---|
| Item | Unit | 212 | 213 | 214 | 215 | 216 | 217 | 218 | 219 |
| HFO-1132(E) | Mass % | 25.0 | 30.0 | 35.0 | 40.0 | 10.0 | 15.0 | 20.0 | 25.0 |
| HFO-1123 | Mass % | 18.1 | 13.1 | 8.1 | 3.1 | 28.1 | 23.1 | 18.1 | 13.1 |
| R1234yf | Mass % | 35.0 | 35.0 | 35.0 | 35.0 | 40.0 | 40.0 | 40.0 | 40.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative | 98.4 | 98.7 | 99.0 | 99.3 | 98.3 | 98.5 | 98.7 | 99.0 |
| | to R410A) | | | | | | | | |
| Refrigerating | % (relative | 92.9 | 92.4 | 91.9 | 91.3 | 90.8 | 90.5 | 90.2 | 89.7 |
| capacity ratio | to R410A) | | | | | | | | |

TABLE 82

| | | Ex. | Ex. | Ex. | Ex. | Ex. | Ex. | Ex. | Comp. |
|---|---|---|---|---|---|---|---|---|---|
| Item | Unit | 220 | 221 | 222 | 223 | 224 | 225 | 226 | Ex. 101 |
| HFO-1132(E) | Mass % | 30.0 | 35.0 | 10.0 | 15.0 | 20.0 | 25.0 | 30.0 | 10.0 |
| HFO-1123 | Mass % | 8.1 | 3.1 | 23.1 | 18.1 | 13.1 | 8.1 | 3.1 | 18.1 |
| R1234yf | Mass % | 40.0 | 40.0 | 45.0 | 45.0 | 45.0 | 45.0 | 45.0 | 50.0 |
| R32 | Mass % | 21.9 | 21.9 | 21.9 | 21.9 | 21.9 | 21.9 | 21.9 | 21.9 |
| GWP | — | 150 | 150 | 150 | 150 | 150 | 150 | 150 | 150 |
| COP ratio | % (relative | 99.3 | 99.6 | 98.9 | 99.1 | 99.3 | 99.6 | 99.9 | 99.6 |
| | to R410A) | | | | | | | | |
| Refrigerating | % (relative | 89.3 | 88.8 | 87.6 | 87.3 | 87.0 | 86.6 | 86.2 | 84.4 |
| capacity ratio | to R410A) | | | | | | | | |

TABLE 83

| | | Comp. | Comp. | Comp. |
|---|---|---|---|---|
| Item | Unit | Ex. 102 | Ex. 103 | Ex. 104 |
| HFO-1132(E) | Mass % | 15.0 | 20.0 | 25.0 |
| HFO-1123 | Mass % | 13.1 | 8.1 | 3.1 |
| R1234yf | Mass % | 50.0 | 50.0 | 50.0 |
| R32 | Mass % | 21.9 | 21.9 | 21.9 |
| GWP | — | 150 | 150 | 150 |
| COP ratio | % (relative | 99.8 | 100.0 | 100.2 |
| | to R410A) | | | |
| Refrigerating | % (relative | 84.1 | 83.8 | 83.4 |
| capacity ratio | to R410A) | | | |

TABLE 84

| | | Ex. | Ex. | Ex. | Ex. | Ex. | Ex. | Ex. | Comp. |
|---|---|---|---|---|---|---|---|---|---|
| Item | Unit | 227 | 228 | 229 | 230 | 231 | 232 | 233 | Ex. 105 |
| HFO-1132(E) | Mass % | 10.0 | 15.0 | 20.0 | 25.0 | 30.0 | 35.0 | 40.0 | 45.0 |
| HFO-1123 | Mass % | 55.7 | 50.7 | 45.7 | 40.7 | 35.7 | 30.7 | 25.7 | 20.7 |
| R1234yf | Mass % | 5.0 | 5.0 | 5.0 | 5.0 | 5.0 | 5.0 | 5.0 | 5.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 95.9 | 96.0 | 96.2 | 96.3 | 96.6 | 96.8 | 97.1 | 97.3 |
| | to R410A) | | | | | | | | |
| Refrigerating | % (relative | 112.2 | 111.9 | 111.6 | 111.2 | 110.7 | 110.2 | 109.6 | 109.0 |
| capacity ratio | to R410A) | | | | | | | | |

TABLE 85

| | | Ex. | Ex. | Ex. | Ex. | Ex. | Ex. | Ex. | Comp. |
|---|---|---|---|---|---|---|---|---|---|
| Item | Unit | 234 | 235 | 236 | 237 | 238 | 239 | 240 | Ex. 106 |
| HFO-1132(E) | Mass % | 10.0 | 15.0 | 20.0 | 25.0 | 30.0 | 35.0 | 40.0 | 45.0 |
| HFO-1123 | Mass % | 50.7 | 45.7 | 40.7 | 35.7 | 30.7 | 25.7 | 20.7 | 15.7 |
| R1234yf | Mass % | 10.0 | 10.0 | 10.0 | 10.0 | 10.0 | 10.0 | 10.0 | 10.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 96.3 | 96.4 | 96.6 | 96.8 | 97.0 | 97.2 | 97.5 | 97.8 |
| | to R410A) | | | | | | | | |
| Refrigerating | % (relative | 109.4 | 109.2 | 108.8 | 108.4 | 107.9 | 107.4 | 106.8 | 106.2 |
| capacity ratio | to R410A) | | | | | | | | |

TABLE 86

| | | Ex. | Ex. | Ex. | Ex. | Ex. | Ex. | Ex. | Comp. |
|---|---|---|---|---|---|---|---|---|---|
| Item | Unit | 241 | 242 | 243 | 244 | 245 | 246 | 247 | Ex. 107 |
| HFO-1132(E) | Mass % | 10.0 | 15.0 | 20.0 | 25.0 | 30.0 | 35.0 | 40.0 | 45.0 |
| HFO-1123 | Mass % | 45.7 | 40.7 | 35.7 | 30.7 | 25.7 | 20.7 | 15.7 | 10.7 |
| R1234yf | Mass % | 15.0 | 15.0 | 15.0 | 15.0 | 15.0 | 15.0 | 15.0 | 15.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 96.7 | 96.8 | 97.0 | 97.2 | 97.4 | 97.7 | 97.9 | 98.2 |
| | to R410A) | | | | | | | | |
| Refrigerating | % (relative | 106.6 | 106.3 | 106.0 | 105.5 | 105.1 | 104.5 | 104.0 | 103.4 |
| capacity ratio | to R410A) | | | | | | | | |

TABLE 87

| | | Ex. | Ex. | Ex. | Ex. | Ex. | Ex. | Ex. | Comp. |
|---|---|---|---|---|---|---|---|---|---|
| Item | Unit | 248 | 249 | 250 | 251 | 252 | 253 | 254 | Ex. 108 |
| HFO-1132(E) | Mass % | 10.0 | 15.0 | 20.0 | 25.0 | 30.0 | 35.0 | 40.0 | 45.0 |
| HFO-1123 | Mass % | 40.7 | 35.7 | 30.7 | 25.7 | 20.7 | 15.7 | 10.7 | 5.7 |
| R1234yf | Mass % | 20.0 | 20.0 | 20.0 | 20.0 | 20.0 | 20.0 | 20.0 | 20.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 97.1 | 97.3 | 97.5 | 97.7 | 97.9 | 98.1 | 98.4 | 98.7 |
| | to R410A) | | | | | | | | |
| Refrigerating | % (relative | 103.7 | 103.4 | 103.0 | 102.6 | 102.2 | 101.6 | 101.1 | 100.5 |
| capacity ratio | to R410A) | | | | | | | | |

TABLE 88

| | | Ex. | Ex. | Ex. | Ex. | Ex. | Ex. | Ex. | Ex. |
|---|---|---|---|---|---|---|---|---|---|
| Item | Unit | 255 | 256 | 257 | 258 | 259 | 260 | 261 | 262 |
| HFO-1132(E) | Mass % | 10.0 | 15.0 | 20.0 | 25.0 | 30.0 | 35.0 | 40.0 | 10.0 |
| HFO-1123 | Mass % | 35.7 | 30.7 | 25.7 | 20.7 | 15.7 | 10.7 | 5.7 | 30.7 |
| R1234yf | Mass % | 25.0 | 25.0 | 25.0 | 25.0 | 25.0 | 25.0 | 25.0 | 30.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 199 | 199 | 199 |
| COP ratio | % (relative | 97.6 | 97.7 | 97.9 | 98.1 | 98.4 | 98.6 | 98.9 | 98.1 |
| | to R410A) | | | | | | | | |
| Refrigerating | % (relative | 100.7 | 100.4 | 100.1 | 99.7 | 99.2 | 98.7 | 98.2 | 97.7 |
| capacity ratio | to R410A) | | | | | | | | |

TABLE 89

| | | Ex. | Ex. | Ex. | Ex. | Ex. | Ex. | Ex. | Ex. |
|---|---|---|---|---|---|---|---|---|---|
| Item | Unit | 263 | 264 | 265 | 266 | 267 | 268 | 269 | 270 |
| HFO-1132(E) | Mass % | 15.0 | 20.0 | 25.0 | 30.0 | 35.0 | 10.0 | 15.0 | 20.0 |
| HFO-1123 | Mass % | 25.7 | 20.7 | 15.7 | 10.7 | 5.7 | 25.7 | 20.7 | 15.7 |
| R1234yf | Mass % | 30.0 | 30.0 | 30.0 | 30.0 | 30.0 | 35.0 | 35.0 | 35.0 |
| R32 | Mass % | 29.3 | 29.3 | 29.3 | 29.3 | 29.3 | 29.3 | 29.3 | 29.3 |
| GWP | — | 199 | 199 | 199 | 199 | 199 | 200 | 200 | 200 |
| COP ratio | % (relative | 98.2 | 98.4 | 98.6 | 98.9 | 99.1 | 98.6 | 98.7 | 98.9 |
| | to R410A) | | | | | | | | |
| Refrigerating | % (relative | 97.4 | 97.1 | 96.7 | 96.2 | 95.7 | 94.7 | 94.4 | 94.0 |
| capacity ratio | to R410A) | | | | | | | | |

TABLE 90

| | | Ex. | Ex. | Ex. | Ex. | Ex. | Ex. | Ex. | Ex. |
|---|---|---|---|---|---|---|---|---|---|
| Item | Unit | 271 | 272 | 273 | 274 | 275 | 276 | 277 | 278 |
| HFO-1132(E) | Mass % | 25.0 | 30.0 | 10.0 | 15.0 | 20.0 | 25.0 | 10.0 | 15.0 |
| HFO-1123 | Mass % | 10.7 | 5.7 | 20.7 | 15.7 | 10.7 | 5.7 | 15.7 | 10.7 |
| R1234yf | Mass % | 35.0 | 35.0 | 40.0 | 40.0 | 40.0 | 40.0 | 45.0 | 45.0 |
| R32 | Mass % | 29.3 | 29.3 | 29.3 | 29.3 | 29.3 | 29.3 | 29.3 | 29.3 |
| GWP | — | 200 | 200 | 200 | 200 | 200 | 200 | 200 | 200 |
| COP ratio | % (relative | 99.2 | 99.4 | 99.1 | 99.3 | 99.5 | 99.7 | 99.7 | 99.8 |
| | to R410A) | | | | | | | | |
| Refrigerating | % (relative | 93.6 | 93.2 | 91.5 | 91.3 | 90.9 | 90.6 | 88.4 | 88.1 |
| capacity ratio | to R410A) | | | | | | | | |

TABLE 91

| | | Ex. | Ex. | Comp. | Comp. |
|---|---|---|---|---|---|
| Item | Unit | 279 | 280 | Ex. 109 | Ex. 110 |
| HFO-1132(E) | Mass % | 20.0 | 10.0 | 15.0 | 10.0 |
| HFO-1123 | Mass % | 5.7 | 10.7 | 5.7 | 5.7 |
| R1234yf | Mass % | 45.0 | 50.0 | 50.0 | 55.0 |
| R32 | Mass % | 29.3 | 29.3 | 29.3 | 29.3 |
| GWP | — | 200 | 200 | 200 | 200 |
| COP ratio | % (relative | 100.1 | 100.3 | 100.4 | 100.9 |
| | to R410A) | | | | |
| Refrigerating | % (relative | 87.8 | 85.2 | 85.0 | 82.0 |
| capacity ratio | to R410A) | | | | |

TABLE 92

| | | Ex. | Ex. | Ex. | Ex. | Ex. | Comp. | Ex. | Ex. |
|---|---|---|---|---|---|---|---|---|---|
| Item | Unit | 281 | 282 | 283 | 284 | 285 | Ex. 111 | 286 | 287 |
| HFO-1132(E) | Mass % | 10.0 | 15.0 | 20.0 | 25.0 | 30.0 | 35.0 | 10.0 | 15.0 |
| HFO-1123 | Mass % | 40.9 | 35.9 | 30.9 | 25.9 | 20.9 | 15.9 | 35.9 | 30.9 |
| R1234yf | Mass % | 5.0 | 5.0 | 5.0 | 5.0 | 5.0 | 5.0 | 10.0 | 10.0 |
| R32 | Mass % | 44.1 | 44.1 | 44.1 | 44.1 | 44.1 | 44.1 | 44.1 | 44.1 |
| GWP | — | 298 | 298 | 298 | 298 | 298 | 298 | 299 | 299 |
| COP ratio | % (relative | 97.8 | 97.9 | 97.9 | 98.1 | 98.2 | 98.4 | 98.2 | 98.2 |
| | to R410A) | | | | | | | | |
| Refrigerating | % (relative | 112.5 | 112.3 | 111.9 | 111.6 | 111.2 | 110.7 | 109.8 | 109.5 |
| capacity ratio | to R410A) | | | | | | | | |

TABLE 93

| | | Ex. | Ex. | Ex. | Comp. | Ex. | Ex. | Ex. | Ex. |
|---|---|---|---|---|---|---|---|---|---|
| Item | Unit | 288 | 289 | 290 | Ex. 112 | 291 | 292 | 293 | 294 |
| HFO-1132(E) | Mass % | 20.0 | 25.0 | 30.0 | 35.0 | 10.0 | 15.0 | 20.0 | 25.0 |
| HFO-1123 | Mass % | 25.9 | 20.9 | 15.9 | 10.9 | 30.9 | 25.9 | 20.9 | 15.9 |
| R1234yf | Mass % | 10.0 | 10.0 | 10.0 | 10.0 | 15.0 | 15.0 | 15.0 | 15.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative | 98.3 | 98.5 | 98.6 | 98.8 | 98.6 | 98.6 | 98.7 | 98.9 |
| | to R410A) | | | | | | | | |
| Refrigerating | % (relative | 109.2 | 108.8 | 108.4 | 108.0 | 107.0 | 106.7 | 106.4 | 106.0 |
| capacity ratio | to R410A) | | | | | | | | |

TABLE 94

| | | Ex. | Comp. | Ex. | Ex. | Ex. | Ex. | Ex. | Ex. |
|---|---|---|---|---|---|---|---|---|---|
| Item | Unit | 295 | Ex. 113 | 296 | 297 | 298 | 299 | 300 | 301 |
| HFO-1132(E) | Mass % | 30.0 | 35.0 | 10.0 | 15.0 | 20.0 | 25.0 | 30.0 | 10.0 |
| HFO-1123 | Mass % | 10.9 | 5.9 | 25.9 | 20.9 | 15.9 | 10.9 | 5.9 | 20.9 |
| R1234yf | Mass % | 15.0 | 15.0 | 20.0 | 20.0 | 20.0 | 20.0 | 20.0 | 25.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative | 99.0 | 99.2 | 99.0 | 99.0 | 99.2 | 99.3 | 99.4 | 99.4 |
| | to R410A) | | | | | | | | |
| Refrigerating | % (relative | 105.6 | 105.2 | 104.1 | 103.9 | 103.6 | 103.2 | 102.8 | 101.2 |
| capacity ratio | to R410A) | | | | | | | | |

TABLE 95

| | | Ex. | Ex. | Ex. | Ex. | Ex. | Ex. | Ex. | Ex. |
|---|---|---|---|---|---|---|---|---|---|
| Item | Unit | 302 | 303 | 304 | 305 | 306 | 307 | 308 | 309 |
| HFO-1132(E) | Mass % | 15.0 | 20.0 | 25.0 | 10.0 | 15.0 | 20.0 | 10.0 | 15.0 |
| HFO-1123 | Mass % | 15.9 | 10.9 | 5.9 | 15.9 | 10.9 | 5.9 | 10.9 | 5.9 |
| R1234yf | Mass % | 25.0 | 25.0 | 25.0 | 30.0 | 30.0 | 30.0 | 35.0 | 35.0 |
| R32 | Mass % | 44.1 | 44.1 | 44.1 | 44.1 | 44.1 | 44.1 | 44.1 | 44.1 |
| GWP | — | 299 | 299 | 299 | 299 | 299 | 299 | 299 | 299 |
| COP ratio | % (relative | 99.5 | 99.6 | 99.7 | 99.8 | 99.9 | 100.0 | 100.3 | 100.4 |
| | to R410A) | | | | | | | | |
| Refrigerating | % (relative | 101.0 | 100.7 | 100.3 | 98.3 | 98.0 | 97.8 | 95.3 | 95.1 |
| capacity ratio | to R410A) | | | | | | | | |

TABLE 96

| | | Ex. |
|---|---|---|
| Item | Unit | 400 |
| HFO-1132(E) | Mass % | 10.0 |
| HFO-1123 | Mass % | 5.9 |
| R1234yf | Mass % | 40.0 |
| R32 | Mass % | 44.1 |
| GWP | — | 299 |
| COP ratio | % (relative | 100.7 |
| | to R410A) | |
| Refrigerating | % (relative | 92.3 |
| capacity ratio | to R410A) | |

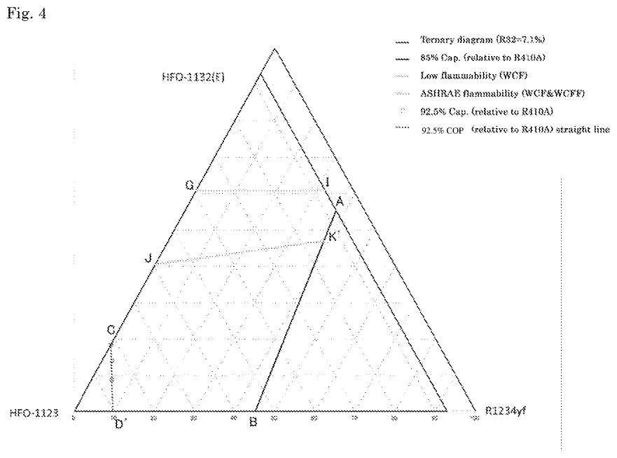

The above results indicate that the refrigerating capacity ratio relative to R410A is 85% or more in the following cases:
When the mass % of HFO-1132(E), HFO-1123, R1234yf, and R32 based on their sum is respectively represented by x, y, z, and a, in a ternary composition diagram in which the sum of HFO-1132(E), HFO-1123, and R1234yf is (100−a) mass %, a straight line connecting a point (0.0, 100.0−a, 0.0) and a point (0.0, 0.0, 100.0−a) is the base, and the point (0.0, 100.0−a, 0.0) is on the left side, if 0<a≤11.1, coordinates (x,y,z) in the ternary composition diagram are on, or on the left side of, a straight line AB that connects point A (0.0134a²−1.9681a+68.6, 0.0, −0.0134a²+0.9681a+31.4) and point B (0.0, 0.0144a²−1.6377a+58.7, −0.0144a²+0.6377a+41.3);
if 11.1<a≤18.2, coordinates (x,y,z) in the ternary composition diagram are on, or on the left side of, a straight line AB that connects point A (0.0112a²−1.9337a+68.484, 0.0, −0.0112a²+0.9337a+31.516) and point B (0.0, 0.0075a²−1.5156a+58.199, −0.0075a²+0.5156a+41.801);
if 18.2a<a≤26.7, coordinates (x,y,z) in the ternary composition diagram are on, or on the left side of, a straight line AB that connects point A (0.0107a²−1.9142a+68.305, 0.0, −0.0107a²+0.9142a+31.695) and point B (0.0, 0.009a²−1.6045a+59.318, −0.009a²+0.6045a+40.682);
if 26.7<a≤36.7, coordinates (x,y,z) in the ternary composition diagram are on, or on the left side of, a straight line AB that connects point A (0.0103a²−1.9225a+68.793, 0.0, −0.0103a²+0.9225a+31.207) and point B (0.0, 0.0046a²−1.41a+57.286, −0.0046a²+0.41a+42.714); and
if 36.7<a≤46.7, coordinates (x,y,z) in the ternary composition diagram are on, or on the left side of, a straight line AB that connects point A (0.0085a²−1.8102a+67.1, 0.0, −0.0085a²+0.8102a+32.9) and point B (0.0, 0.0012a²−1.1659a+52.95, −0.0012a²+0.1659a+47.05).
Actual points having a refrigerating capacity ratio of 85% or more form a curved line that connects point A and point B in FIG. 3, and that extends toward the 1234yf side. Accordingly, when coordinates are on, or on the left side of, the straight line AB, the refrigerating capacity ratio relative to R410A is 85% or more.
Similarly, it was also found that in the ternary composition diagram, if 0<a≤11.1, when coordinates (x,y,z) are on, or on the left side of, a straight line D′C that connects point D′ (0.0, 0.0224a²+0.968a+75.4, −0.0224a²−1.968a+24.6) and point C (−0.2304a²−0.4062a+32.9, 0.2304a²−0.5938a+67.1, 0.0); or if 11.1<a≤46.7, when coordinates are in the entire region, the COP ratio relative to that of R410A is 92.5% or more.
In FIG. 3, the COP ratio of 92.5% or more forms a curved line CD. In FIG. 3, an approximate line formed by connecting three points: point C (32.9, 67.1, 0.0) and points (26.6, 68.4, 5) (19.5, 70.5, 10) where the COP ratio is 92.5% when the concentration of R1234yf is 5 mass % and 10 mass was obtained, and a straight line that connects point C and point D′ (0, 75.4, 24.6), which is the intersection of the approximate line and a point where the concentration of HFO-1132(E) is 0.0 mass % was defined as a line segment D′C. In FIG. 4, point D′(0, 83.4, 9.5) was similarly obtained from an approximate curve formed by connecting point C (18.4, 74.5, 0) and points (13.9, 76.5, 2.5) (8.7, 79.2, 5) where the COP ratio is 92.5%, and a straight line that connects point C and point D′ was defined as the straight line D′C.
The composition of each mixture was defined as WCF. A leak simulation was performed using NIST Standard Reference Database REFLEAK Version 4.0 under the conditions of Equipment, Storage, Shipping, Leak, and Recharge according to the ASHRAE Standard 34-2013. The most flammable fraction was defined as WCFF.
For the flammability, the burning velocity was measured according to the ANSI/ASHRAE Standard 34-2013. Both WCF and WCFF having a burning velocity of 10 cm/s or less were determined to be classified as “Class 2L (lower flammability).”
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
The results are shown in Tables 97 to 104.

TABLE 97

| | | | Comp. | Comp. | Comp. | Comp. | Comp. | Comp. |
|---|---|---|---|---|---|---|---|---|
| Item | | | Ex. 6 | Ex. 13 | Ex. 19 | Ex. 24 | Ex. 29 | Ex. 34 |
| WCF | HFO-1132(E) | Mass % | 72.0 | 60.9 | 55.8 | 52.1 | 48.6 | 45.4 |
| | HFO-1123 | Mass % | 28.0 | 32.0 | 33.1 | 33.4 | 33.2 | 32.7 |
| | R1234yf | Mass % | 0.0 | 0.0 | 0.0 | 0 | 0 | 0 |
| | R32 | Mass % | 0.0 | 7.1 | 11.1 | 14.5 | 18.2 | 21.9 |

| | | | | | | | |
|---|---|---|---|---|---|---|---|
| Burning velocity (WCF) | cm/s | 10 | 10 | 10 | 10 | 10 | 10 |

TABLE 98

| | | | Comp. | Comp. | Comp. | Comp. | Comp. |
|---|---|---|---|---|---|---|---|
| Item | | | Ex. 39 | Ex. 45 | Ex. 51 | Ex. 57 | Ex. 62 |
| WCF | HFO-1132(E) | Mass % | 41.8 | 40 | 35.7 | 32 | 30.4 |
| | HFO-1123 | Mass % | 31.5 | 30.7 | 23.6 | 23.9 | 21.8 |
| | R1234yf | Mass % | 0 | 0 | 0 | 0 | 0 |
| | R32 | Mass % | 26.7 | 29.3 | 36.7 | 44.1 | 47.8 |

| | | | | | | |
|---|---|---|---|---|---|---|
| Burning velocity (WCF) | cm/s | 10 | 10 | 10 | 10 | 10 |

TABLE 99

| | | | Comp. | Comp. | Comp. | Comp. | Comp. | Comp. |
|---|---|---|---|---|---|---|---|---|
| Item | | | Ex. 7 | Ex. 14 | Ex. 20 | Ex. 25 | Ex. 30 | Ex. 35 |
| WCF | HFO-1132(E) | Mass % | 72.0 | 60.9 | 55.8 | 52.1 | 48.6 | 45.4 |
| | HFO-1123 | Mass % | 0.0 | 0.0 | 0.0 | 0 | 0 | 0 |
| | R1234yf | Mass % | 28.0 | 32.0 | 33.1 | 33.4 | 33.2 | 32.7 |
| | R32 | Mass % | 0.0 | 7.1 | 11.1 | 14.5 | 18.2 | 21.9 |

| | | | | | | | |
|---|---|---|---|---|---|---|---|
| Burning velocity (WCF) | cm/s | 10 | 10 | 10 | 10 | 10 | 10 |

TABLE 100

| | | | Comp. | Comp. | Comp. | Comp. | Comp. |
|---|---|---|---|---|---|---|---|
| Item | | | Ex. 40 | Ex. 46 | Ex. 52 | Ex. 58 | Ex. 63 |
| WCF | HFO-1132(E) | Mass % | 41.8 | 40 | 35.7 | 32 | 30.4 |
| | HFO-1123 | Mass % | 0 | 0 | 0 | 0 | 0 |
| | R1234yf | Mass % | 31.5 | 30.7 | 23.6 | 23.9 | 21.8 |
| | R32 | Mass % | 26.7 | 29.3 | 36.7 | 44.1 | 47.8 |

| | | | | | | |
|---|---|---|---|---|---|---|
| Burning velocity (WCF) | cm/s | 10 | 10 | 10 | 10 | 10 |

TABLE 101

| | | | Comp. | Comp. | Comp. | Comp. | Comp. | Comp. |
|---|---|---|---|---|---|---|---|---|
| Item | | | Ex. 8 | Ex. 15 | Ex. 21 | Ex. 26 | Ex. 31 | Ex. 36 |
| WCF | HFO-1132(E) | Mass % | 47.1 | 40.5 | 37.0 | 34.3 | 32.0 | 30.3 |
| | HFO-1123 | Mass % | 52.9 | 52.4 | 51.9 | 51.2 | 49.8 | 47.8 |
| | R1234yf | Mass % | 0.0 | 0.0 | 0.0 | 0.0 | 0.0 | 0.0 |
| | R32 | Mass % | 0.0 | 7.1 | 11.1 | 14.5 | 18.2 | 21.9 |
| Leak condition that results in WCFF | | | Storage/ | Storage/ | Storage/ | Storage/ | Storage/ | Storage/ |
| | | | Shipping −40° | Shipping −40° | Shipping −40° | Shipping −40° | Shipping −40° | Shipping −40° |
| | | | C., 92% | C., 92% | C., 92% | C., 92% | C., 92% | C., 92% |
| | | | release, | release, | release, | release, | release, | release, |
| | | | liquid | liquid | liquid | liquid | liquid | liquid |
| | | | phase side | phase side | phase side | phase side | phase side | phase side |
| WCFF | HFO-1132(E) | Mass % | 72.0 | 62.4 | 56.2 | 50.6 | 45.1 | 40.0 |
| | HFO-1123 | Mass % | 28.0 | 31.6 | 33.0 | 33.4 | 32.5 | 30.5 |
| | R1234yf | Mass % | 0.0 | 0.0 | 0.0 | 20.4 | 0.0 | 0.0 |
| | R32 | Mass % | 0.0 | 50.9 | 10.8 | 16.0 | 22.4 | 29.5 |

| | | | | | | | |
|---|---|---|---|---|---|---|---|
| Burning velocity (WCF) | cm/s | 8 or | 8 or | 8 or | 8 or | 8 or | 8 or |
| | | less | less | less | less | less | less |
| Burning velocity (WCFF) | cm/s | 10 | 10 | 10 | 10 | 10 | 10 |

TABLE 102

| | | | Comp. | Comp. | Comp. | Comp. | Comp. |
|---|---|---|---|---|---|---|---|
| Item | | | Ex. 41 | Ex. 47 | Ex. 53 | Ex. 59 | Ex. 64 |
| WCF | HFO-1132(E) | Mass % | 29.1 | 28.8 | 29.3 | 29.4 | 28.9 |
| | HFO-1123 | Mass % | 44.2 | 41.9 | 34.0 | 26.5 | 23.3 |
| | R1234yf | Mass % | 0.0 | 0.0 | 0.0 | 0.0 | 0.0 |
| | R32 | Mass % | 26.7 | 29.3 | 36.7 | 44.1 | 47.8 |
| Leak condition that results in WCFF | | | Storage/ | Storage/ | Storage/ | Storage/ | Storage/ |
| | | | Shipping −40° | Shipping −40° | Shipping −40° | Shipping −40° | Shipping −40° |
| | | | C., 92% | C., 92% | C., 92% | C., 90% | C., 86% |
| | | | release, | release, | release, | release, | release, |
| | | | liquid | liquid | liquid | gas | gas |
| | | | phase side | phase side | phase side | phase side | phase side |
| WCFF | HFO-1132(E) | Mass % | 34.6 | 32.2 | 27.7 | 28.3 | 27.5 |
| | HFO-1123 | Mass % | 26.5 | 23.9 | 17.5 | 18.2 | 16.7 |
| | R1234yf | Mass % | 0.0 | 0.0 | 0.0 | 0.0 | 0.0 |
| | R32 | Mass % | 38.9 | 43.9 | 54.8 | 53.5 | 55.8 |

| | | | | | | |
|---|---|---|---|---|---|---|
| Burning velocity (WCF) | cm/s | 8 or less | 8 or less | 8.3 | 9.3 | 9.6 |
| Burning velocity (WCFF) | cm/s | 10 | 10 | 10 | 10 | 10 |

TABLE 103

| | | | Comp. | Comp. | Comp. | Comp. | Comp. | Comp. |
|---|---|---|---|---|---|---|---|---|
| Item | | | Ex. 9 | Ex. 16 | Ex. 22 | Ex. 27 | Ex. 32 | Ex. 37 |
| WCF | HFO-1132(E) | Mass % | 61.7 | 47.0 | 41.0 | 36.5 | 32.5 | 28.8 |
| | HFO-1123 | Mass % | 5.9 | 7.2 | 6.5 | 5.6 | 4.0 | 2.4 |
| | R1234yf | Mass % | 32.4 | 38.7 | 41.4 | 43.4 | 45.3 | 46.9 |
| | R32 | Mass % | 0.0 | 7.1 | 11.1 | 14.5 | 18.2 | 21.9 |
| Leak condition that results in WCFF | | | Storage/ | Storage/ | Storage/ | Storage/ | Storage/ | Storage/ |
| | | | Shipping −40° | Shipping −40° | Shipping −40° | Shipping −40° | Shipping −40° | Shipping −40° |
| | | | C., 0% | C., 0% | C., 0% | C., 92% | C., 0% | C., 0% |
| | | | release, | release, | release, | release, | release, | release, |
| | | | gas | gas | gas | liquid | gas | gas |
| | | | phase side | phase side | phase side | phase side | phase side | phase side |
| WCFF | HFO-1132(E) | Mass % | 72.0 | 56.2 | 50.4 | 46.0 | 42.4 | 39.1 |
| | HFO-1123 | Mass % | 10.5 | 12.6 | 11.4 | 10.1 | 7.4 | 4.4 |
| | R1234yf | Mass % | 17.5 | 20.4 | 21.8 | 22.9 | 24.3 | 25.7 |
| | R32 | Mass % | 0.0 | 10.8 | 16.3 | 21.0 | 25.9 | 30.8 |

| | | | | | | | |
|---|---|---|---|---|---|---|---|
| Burning velocity (WCF) | cm/s | 8 or less | 8 or less | 8 or less | 8 or less | 8 or less | 8 or less |
| Burning velocity (WCFF) | cm/s | 10 | 10 | 10 | 10 | 10 | 10 |

TABLE 104

| | | | Comp. | Comp. | Comp. | Comp. | Comp. |
|---|---|---|---|---|---|---|---|
| Item | | | Ex. 42 | Ex. 48 | Ex. 54 | Ex. 60 | Ex. 65 |
| WCF | HFO-1132(E) | Mass % | 24.8 | 24.3 | 22.5 | 21.1 | 20.4 |
| | HFO-1123 | Mass % | 0.0 | 0.0 | 0.0 | 0.0 | 0.0 |
| | R1234yf | Mass % | 48.5 | 46.4 | 40.8 | 34.8 | 31.8 |
| | R32 | Mass % | 26.7 | 29.3 | 36.7 | 44.1 | 47.8 |
| Leak condition that results in WCFF | | | Storage/ | Storage/ | Storage/ | Storage/ | Storage/ |
| | | | Shipping −40° | Shipping −40° | Shipping −40° | Shipping −40° | Shipping −40° |
| | | | C., 0% | C., 0% | C., 0% | C., 0% | C., 0% |
| | | | release, | release, | release, | release, | release, |
| | | | gas | gas | gas | gas | gas |
| | | | phase side | phase side | phase side | phase side | phase side |
| WCFF | HFO-1132(E) | Mass % | 35.3 | 34.3 | 31.3 | 29.1 | 28.1 |
| | HFO-1123 | Mass % | 0.0 | 0.0 | 0.0 | 0.0 | 0.0 |
| | R1234yf | Mass % | 27.4 | 26.2 | 23.1 | 19.8 | 18.2 |
| | R32 | Mass % | 37.3 | 39.6 | 45.6 | 51.1 | 53.7 |

| | | | | | | |
|---|---|---|---|---|---|---|
| Burning velocity (WCF) | cm/s | 8 or less | 8 or less | 8 or less | 8 or less | 8 or less |
| Burning velocity (WCFF) | cm/s | 10 | 10 | 10 | 10 | 10 |

The results in Tables 97 to 100 indicate that the refrigerant has a WCF lower flammability in the following cases:
When the mass % of HFO-1132(E), HFO-1123, R1234yf, and R32 based on their sum in the mixed refrigerant of HFO-1132(E), HFO-1123, R1234yf, and R32 is respectively represented by x, y, z, and a, coordinates (x,y,z) in a ternary composition diagram in which the sum of HFO-1132(E), HFO-1123, and R1234yf is (100−a) mass % and a straight line connecting a point (0.0, 100.0−a, 0.0) and a point (0.0, 0.0, 100.0−a) is the base, if 0<a≤11.1, coordinates (x,y,z) in the ternary composition diagram are on or below a straight line GI that connects point G (0.026a²−1.7478a+72.0, −0.026a²+0.7478a+28.0, 0.0) and point I (0.026a²−1.7478a+72.0, 0.0, −0.026a²+0.7478a+28.0);
   if 11.1<a≤18.2, coordinates (x,y,z) in the ternary composition diagram are on or below a straight line GI that connects point G (0.02a²−1.6013a+71.105, −0.02a²+0.6013a+28.895, 0.0) and point I (0.02a²−1.6013a+71.105, 0.0, −0.02a²+0.6013a+28.895); if 18.2<a≤26.7, coordinates (x,y,z) in the ternary composition diagram are on or below a straight line GI that connects point G (0.0135a²−1.4068a+69.727, −0.0135a²+0.4068a+30.273, 0.0) and point I (0.0135a²−1.4068a+69.727, 0.0, −0.0135a²+0.4068a+30.273); if 26.7<a≤36.7, coordinates (x,y,z) in the ternary composition diagram are on or below a straight line GI that connects point G (0.0111a²−1.3152a+68.986, −0.0111a²+0.3152a+31.014, 0.0) and point I (0.0111a²−1.3152a+68.986, 0.0, −0.0111a²+0.3152a+31.014); and if 36.7<a≤46.7, coordinates (x,y,z) in the ternary composition diagram are on or below a straight line GI that connects point G (0.0061a²−0.9918a+63.902, −0.0061a²−0.0082a+36.098, 0.0) and point I (0.0061a²−0.9918a+63.902, 0.0, −0.0061a²−0.0082a+36.098).
Three points corresponding to point G (Table 105) and point I (Table 106) were individually obtained in each of the following five ranges by calculation, and their approximate expressions were obtained.

TABLE 105

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 72.0 | 60.9 | 55.8 | 55.8 | 52.1 | 48.6 | 48.6 | 45.4 | 41.8 |
| HFO-1123 | 28.0 | 32.0 | 33.1 | 33.1 | 33.4 | 33.2 | 33.2 | 32.7 | 31.5 |
| R1234yf | 0 | 0 | 0 | 0 | 0 | 0 | 0 | 0 | 0 |

| | | | |
|---|---|---|---|
| R32 | a | a | a |
| HFO-1132(E) | 0.026a² − 1.7478a + 72.0 | 0.02a² − 1.6013a + 71.105 | 0.0135a² − 1.4068a + 69.727 |
| Approximate | | | |
| expression | | | |
| HFO-1123 | −0.026a² + 0..7478a + 28.0 | −0.02a² + 0..6013a + 28.895 | −0.0135a² + 0.4068a + 30.273 |
| Approximate | | | |
| expression | | | |
| R1234yf | 0 | 0 | 0 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 41.8 | 40.0 | 35.7 | 35.7 | 32.0 | 30.4 |
| HFO-1123 | 31.5 | 30.7 | 27.6 | 27.6 | 23.9 | 21.8 |
| R1234yf | 0 | 0 | 0 | 0 | 0 | 0 |

| | | |
|---|---|---|
| R32 | a | a |
| HFO-1132(E) | 0.0111a2 − 1.3152a + 68.986 | 0.0061a² − 0.9918a + 63.902 |
| Approximate | | |
| expression | | |
| HFO-1123 | −0.0111a2 + 0.3152a + 31.014 | −0.0061a² − 0.0082a + 36.098 |
| Approximate | | |
| expression | | |
| R1234yf | 0 | 0 |
| Approximate | | |
| expression | | |

TABLE 106

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 72.0 | 60.9 | 55.8 | 55.8 | 52.1 | 48.6 | 48.6 | 45.4 | 41.8 |
| HFO-1123 | 0 | 0 | 0 | 0 | 0 | 0 | 0 | 0 | 0 |
| R1234yf | 28.0 | 32.0 | 33.1 | 33.1 | 33.4 | 33.2 | 33.2 | 32.7 | 31.5 |

| | | | |
|---|---|---|---|
| R32 | a | a | a |
| HFO-1132(E) | 0.026a² − 1.7478a + 72.0 | 0.02a² − 1.6013a + 71.105 | 0.0135a² − 1.4068a + 69.727 |
| Approximate | | | |
| expression | | | |
| HFO-1123 | 0 | 0 | 0 |
| Approximate | | | |
| expression | | | |
| R1234yf | −0.026a² + 0.7478a + 28.0 | −0.02a² + 0.6013a + 28.895 | −0.0135a² + 0.4068a + 30.273 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 41.8 | 40.0 | 35.7 | 35.7 | 32.0 | 30.4 |
| HFO-1123 | 0 | 0 | 0 | 0 | 0 | 0 |
| R1234yf | 31.5 | 30.7 | 23.6 | 23.6 | 23.5 | 21.8 |

| | | |
|---|---|---|
| R32 | x | x |
| HFO-1132(E) | 0.0111a² − 1.3152a + 68.986 | 0.0061a² − 0.9918a + 63.902 |
| Approximate | | |
| expression | | |
| HFO-1123 | 0 | 0 |
| Approximate | | |
| expression | | |
| R1234yf | −0.0111a² + 0.3152a + 31.014 | −0.0061a² − 0.0082a + 36.098 |
| Approximate | | |
| expression | | |

The results in Tables 101 to 104 indicate that the refrigerant is determined to have a WCFF lower flammability, and the flammability classification according to the ASHRAE Standard is “2L (flammability)” in the following cases:
When the mass % of HFO-1132(E), HFO-1123, R1234yf, and R32 based on their sum in the mixed refrigerant of HFO-1132(E), HFO-1123, R1234yf, and R32 is respectively represented by x, y, z, and a, in a ternary composition diagram in which the sum of HFO-1132(E), HFO-1123, and R1234yf is (100−a) mass % and a straight line connecting a point (0.0, 100.0−a, 0.0) and a point (0.0, 0.0, 100.0−a) is the base, if 0<a≤11.1, coordinates (x,y,z) in the ternary composition diagram are on or below a straight line JK′ that connects point J (0.0049a²−0.9645a+47.1, −0.0049a²−0.0355a+52.9, 0.0) and point K′(0.0514a²−2.4353a+61.7, −0.0323a²+0.4122a+5.9, −0.0191a²+1.0231a+32.4); if 11.1<a≤18.2, coordinates are on a straight line JK′ that connects point J (0.0243a²−1.4161a+49.725, −0.0243a²+0.4161a+50.275, 0.0) and point K′(0.0341a²−2.1977a+61.187, −0.0236a²+0.34a+5.636, −0.0105a²+0.8577a+33.177); if 18.2<a≤26.7, coordinates are on or below a straight line JK′ that connects point J (0.0246a²−1.4476a+50.184, −0.0246a²+0.4476a+49.816, 0.0) and point K′ (0.0196a²−1.7863a+58.515, −0.0079a²−0.1136a+8.702, −0.0117a²+0.8999a+32.783); if 26.7<a≤36.7, coordinates are on or below a straight line JK′ that connects point J (0.0183a²−1.1399a+46.493, −0.0183a²+0.1399a+53.507, 0.0) and point K′ (−0.0051a²+0.0929a+25.95, 0.0, 0.0051a²−1.0929a+74.05); and if 36.7<a≤46.7, coordinates are on or below a straight line JK′ that connects point J (−0.0134a²+1.0956a+7.13, 0.0134a²−2.0956a+92.87, 0.0) and point K′(−1.892a+29.443, 0.0, 0.892a+70.557).
Actual points having a WCFF lower flammability form a curved line that connects point J and point K′ (on the straight line AB) in FIG. 3 and extends toward the HFO-1132(E) side. Accordingly, when coordinates are on or below the straight line JK′, WCFF lower flammability is achieved.
Three points corresponding to point J (Table 107) and point K′ (Table 108) were individually obtained in each of the following five ranges by calculation, and their approximate expressions were obtained.

TABLE 107

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 47.1 | 40.5 | 37 | 37.0 | 34.3 | 32.0 | 32.0 | 30.3 | 29.1 |
| HFO-1123 | 52.9 | 52.4 | 51.9 | 51.9 | 51.2 | 49.8 | 49.8 | 47.8 | 44.2 |
| R1234yf | 0 | 0 | 0 | 0 | 0 | 0 | 0 | 0 | 0 |

| | | | |
|---|---|---|---|
| R32 | a | a | a |
| HFO-1132(E) | 0.0049a² − 0.9645a + 47.1 | 0.0243a² − 1.4161a + 49.725 | 0.0246a² − 1.4476a + 50.184 |
| Approximate | | | |
| expression | | | |
| HFO-1123 | −0.0049a² − 0.0355a + 52.9 | −0.0243a² + 0.4161a + 50.275 | −0.0246a² + 0.4476a + 49.816 |
| Approximate | | | |
| expression | | | |
| R1234yf | 0 | 0 | 0 |
| Approximate | | | |
| expression | | | |

| Item | 36.7 ≥ R32 ≥ 26.7 | | | 47.8 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 29.1 | 28.8 | 29.3 | 29.3 | 29.4 | 28.9 |
| HFO-1123 | 44.2 | 41.9 | 34.0 | 34.0 | 26.5 | 23.3 |
| R1234yf | 0 | 0 | 0 | 0 | 0 | 0 |

| | | |
|---|---|---|
| R32 | a | a |
| HFO-1132(E) | 0.0183a² − 1.1399a + 46.493 | −0.0134a² + 1.0956a + 7.13 |
| Approximate | | |
| expression | | |
| HFO-1123 | −0.0183a² + 0.1399a + 53.507 | 0.0134a² − 2.0956a + 92.87 |
| Approximate | | |
| expression | | |
| R1234yf | 0 | 0 |
| Approximate | | |
| expression | | |

TABLE 108

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 61.7 | 47.0 | 41.0 | 41.0 | 36.5 | 32.5 | 32.5 | 28.8 | 24.8 |
| HFO-1123 | 5.9 | 7.2 | 6.5 | 6.5 | 5.6 | 4.0 | 4.0 | 2.4 | 0 |
| R1234yf | 32.4 | 38.7 | 41.4 | 41.4 | 43.4 | 45.3 | 45.3 | 46.9 | 48.5 |

| | | | |
|---|---|---|---|
| R32 | x | x | x |
| HFO-1132(E) | 0.0514a² − 2.4353a + 61.7 | 0.0341a² − 2.1977a + 61.187 | 0.0196a² − 1.7863a + 58.515 |
| Approximate | | | |
| expression | | | |
| HFO-1123 | −0.0323a² + 0.4122a + 5.9 | −0.0236a² + 0.34a + 5.636 | −0.0079a² − 0.1136a + 8.702 |
| Approximate | | | |
| expression | | | |
| R1234yf | −0.0191a² + 1.0231a + 32.4 | −0.0105a² + 0.8577a + 33.177 | −0.0117a² + 0.8999a + 32.783 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 24.8 | 24.3 | 22.5 | 22.5 | 21.1 | 20.4 |
| HFO-1123 | 0 | 0 | 0 | 0 | 0 | 0 |
| R1234yf | 48.5 | 46.4 | 40.8 | 40.8 | 34.8 | 31.8 |

| | | |
|---|---|---|
| R32 | x | x |
| HFO-1132(E) | −0.0051a² + 0.0929a + 25.95 | −1.892a + 29.443 |
| Approximate | | |
| expression | | |
| HFO-1123 | 0 | 0 |
| Approximate | | |
| expression | | |
| R1234yf | 0.0051a² − 1.0929a + 74.05 | 0.892a + 70.557 |
| Approximate | | |
| expression | | |

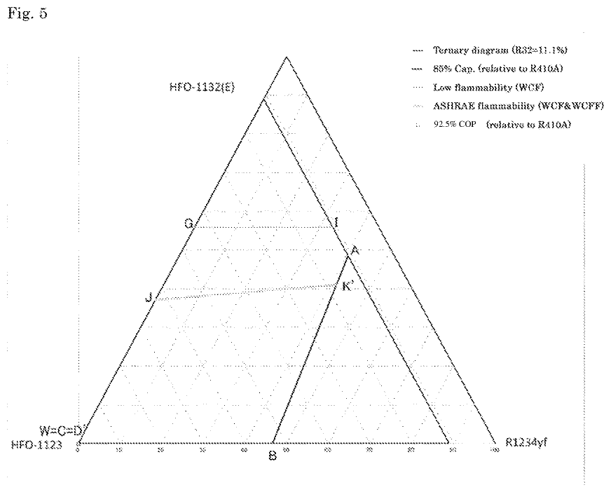

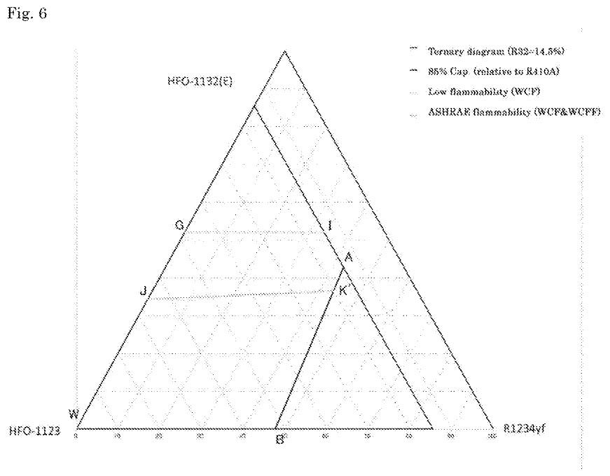

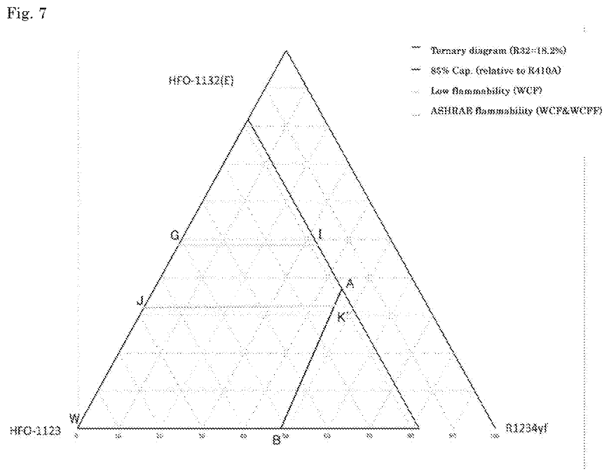

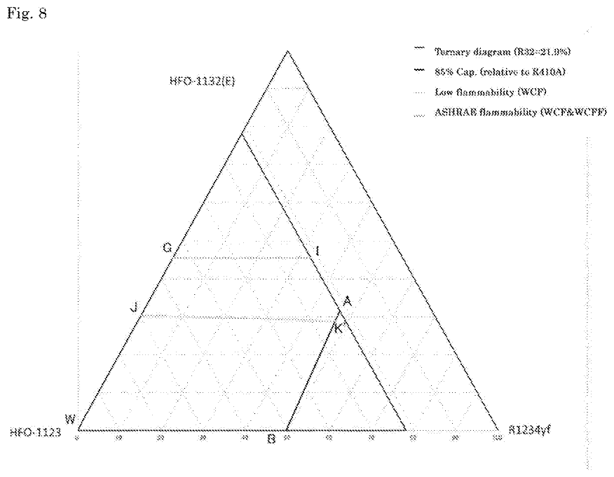

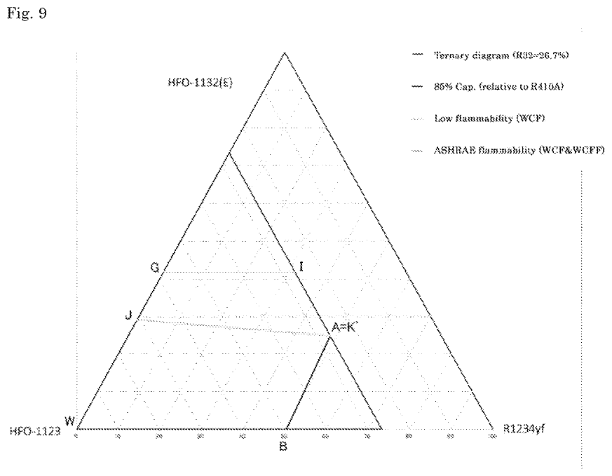

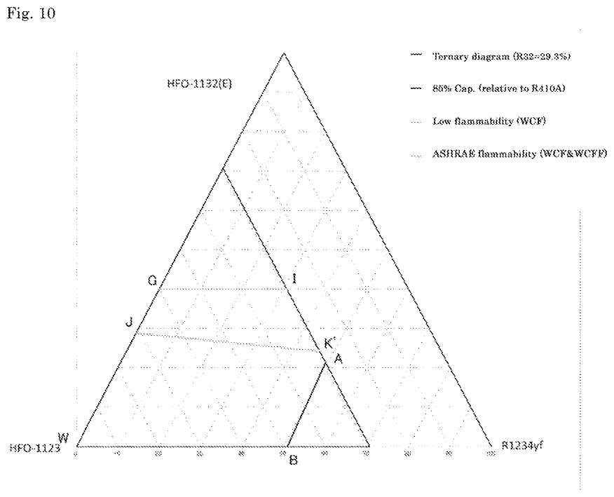

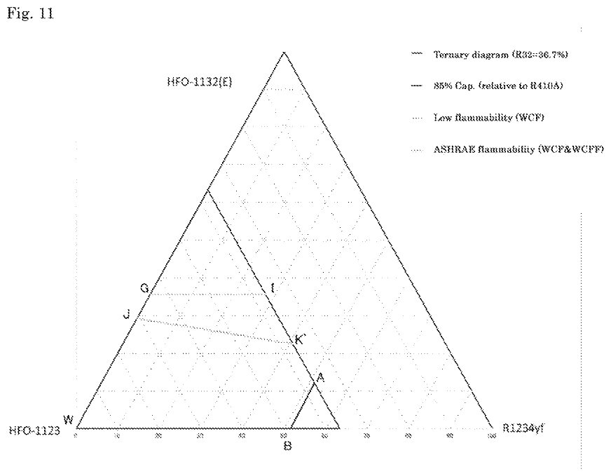

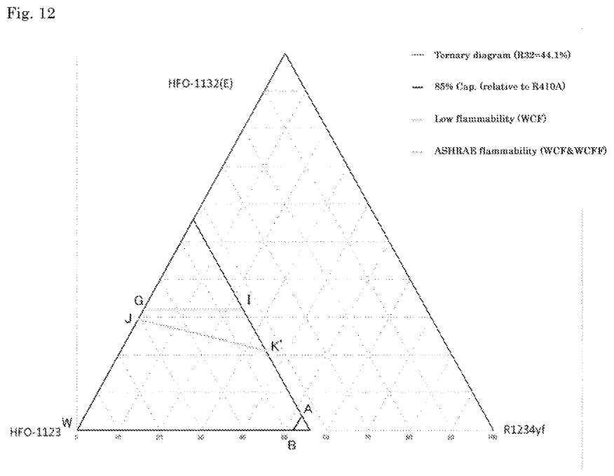

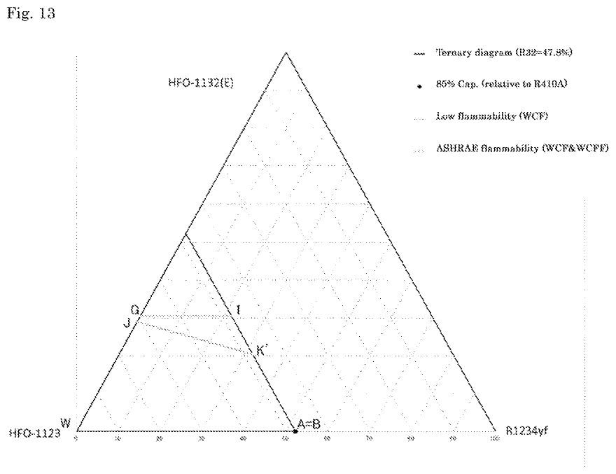

FIGS. 3 to 13 show compositions whose R32 content a (mass %) is 0 mass %, 7.1 mass %, 11.1 mass %, 14.5 mass %, 18.2 mass %, 21.9 mass %, 26.7 mass %, 29.3 mass %, 36.7 mass %, 44.1 mass %, and 47.8 mass %, respectively.
Points A, B, C, and D′ were obtained in the following manner according to approximate calculation.
Point A is a point where the content of HFO-1123 is 0 mass %, and a refrigerating capacity ratio of 85% relative to that of R410A is achieved. Three points corresponding to point A were obtained in each of the following five ranges by calculation, and their approximate expressions were obtained (Table 109).

TABLE 109

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 68.6 | 55.3 | 48.4 | 48.4 | 42.8 | 37 | 37 | 31.5 | 24.8 |
| HFO-1123 | 0 | 0 | 0 | 0 | 0 | 0 | 0 | 0 | 0 |
| R1234yf | 31.4 | 37.6 | 40.5 | 40.5 | 42.7 | 44.8 | 44.8 | 46.6 | 48.5 |

| | | | |
|---|---|---|---|
| R32 | a | a | a |
| HFO-1132(E) | 0.0134a² − 1.9681a + 68.6 | 0.0112a² − 1.9337a + 68.484 | 0.0107a² − 1.9142a + 68.305 |
| Approximate | | | |
| expression | | | |
| HFO-1123 | 0 | 0 | 0 |
| Approximate | | | |
| expression | | | |
| R1234yf | −0.0134a² + 0.9681a + 31.4 | −0.0112a² + 0.9337a + 31.516 | −0.0107a² + 0.9142a + 31.695 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 24.8 | 21.3 | 12.1 | 12.1 | 3.8 | 0 |
| HFO-1123 | 0 | 0 | 0 | 0 | 0 | 0 |
| R1234yf | 48.5 | 49.4 | 51.2 | 51.2 | 52.1 | 52.2 |

| | | |
|---|---|---|
| R32 | a | a |
| HFO-1132(E) | 0.0103a² − 1.9225a + 68.793 | 0.0085a² − 1.8102a + 67.1 |
| Approximate | | |
| expression | | |
| HFO-1123 | 0 | 0 |
| Approximate | | |
| expression | | |
| R1234yf | −0.0103a² + 0.9225a + 31..207 | −0.0085a² + 0.8102a + 32.9 |
| Approximate | | |
| expression | | |

Point B is a point where the content of HFO-1132(E) is 0 mass %, and a refrigerating capacity ratio of 85% relative to that of R410A is achieved.
Three points corresponding to point B were obtained in each of the following five ranges by calculation, and their approximate expressions were obtained (Table 110).

TABLE 110

| Item | 11.1 ≥ R32 > 0 | | | 18.2 ≥ R32 ≥ 11.1 | | | 26.7 ≥ R32 ≥ 18.2 | | |
|---|---|---|---|---|---|---|---|---|---|
| R32 | 0 | 7.1 | 11.1 | 11.1 | 14.5 | 18.2 | 18.2 | 21.9 | 26.7 |
| HFO-1132(E) | 0 | 0 | 0 | 0 | 0 | 0 | 0 | 0 | 0 |
| HFO-1123 | 58.7 | 47.8 | 42.3 | 42.3 | 37.8 | 33.1 | 33.1 | 28.5 | 22.9 |
| R1234yf | 41.3 | 45.1 | 46.6 | 46.6 | 47.7 | 48.7 | 48.7 | 49.6 | 50.4 |

| | | | |
|---|---|---|---|
| R32 | a | a | a |
| HFO-1132(E) | 0 | 0 | 0 |
| Approximate | | | |
| expression | | | |
| HFO-1123 | 0.0144a² − 1.6377a + 58.7 | 0.0075a² − 1.5156a + 58.199 | 0.009a² − 1.6045a + 59.318 |
| Approximate | | | |
| expression | | | |
| R1234yf | −0.0144a² + 0.6377a + 41.3 | −0.0075a² + 0.5156a + 41.801 | −0.009a² + 0.6045a + 40.682 |
| Approximate | | | |
| expression | | | |

| Item | 36.7 ≥ R32 ≥ 26.7 | | | 46.7 ≥ R32 ≥ 36.7 | | |
|---|---|---|---|---|---|---|
| R32 | 26.7 | 29.3 | 36.7 | 36.7 | 44.1 | 47.8 |
| HFO-1132(E) | 0 | 0 | 0 | 0 | 0 | 0 |
| HFO-1123 | 22.9 | 19.9 | 11.7 | 11.8 | 3.9 | 0 |
| R1234yf | 50.4 | 50.8 | 51.6 | 51.5 | 52.0 | 52.2 |

| | | |
|---|---|---|
| R32 | a | a |
| HFO-1132(E) | 0 | 0 |
| Approximate | | |
| expression | | |
| HFO-1123 | 0.0046a² − 1.41a + 57.286 | 0.0012a² − 1.1659a + 52.95 |
| Approximate | | |
| expression | | |
| R1234yf | −0.0046a² + 0.41a + 42.714 | −0.0012a² + 0.1659a + 47.05 |
| Approximate | | |
| expression | | |

Point D′ is a point where the content of HFO-1132(E) is 0 mass %, and a COP ratio of 95.5% relative to that of R410A is achieved.
Three points corresponding to point D′ were obtained in each of the following by calculation, and their approximate expressions were obtained (Table 111).

TABLE 111

| Item | 11.1 ≥ R32 > 0 | | |
|---|---|---|---|
| R32 | 0 | 7.1 | 11.1 |
| HFO-1132(E) | 0 | 0 | 0 |
| HFO-1123 | 75.4 | 83.4 | 88.9 |
| R1234yf | 24.6 | 9.5 | 0 |

| | |
|---|---|
| R32 | a |
| HFO-1132(E) | 0 |
| Approximate | |
| expression | |
| HFO-1123 | 0.0224a² + 0.968a + 75.4 |
| Approximate | |
| expression | |
| R1234yf | −0.0224a² − 1.968a + 24.6 |
| Approximate | |
| expression | |

Point C is a point where the content of R1234yf is 0 mass %, and a COP ratio of 95.5% relative to that of R410A is achieved.
Three points corresponding to point C were obtained in each of the following by calculation, and their approximate expressions were obtained (Table 112).

TABLE 112

| Item | 11.1 ≥ R32 > 0 | | |
|---|---|---|---|
| R32 | 0 | 7.1 | 11.1 |
| HFO-1132(E) | 32.9 | 18.4 | 0 |
| HFO-1123 | 67.1 | 74.5 | 88.9 |
| R1234yf | 0 | 0 | 0 |

| | |
|---|---|
| R32 | a |
| HFO-1132(E) | −0.2304a² − 0.4062a + 32.9 |
| Approximate | |
| expression | |
| HFO-1123 | 0.2304a² − 0.5938a + 67.1 |
| Approximate | |
| expression | |
| R1234yf | 0 |
| Approximate | |
| expression | |

### (5-4) Refrigerant D

The refrigerant D according to the present disclosure is a mixed refrigerant comprising trans-1,2-difluoroethylene (HFO-1132(E)), difluoromethane (R32), and 2,3,3,3-tetrafluoro-1-propene (R1234yf).
The refrigerant D according to the present disclosure has various properties that are desirable as an R410A-alternative refrigerant; i.e., a refrigerating capacity equivalent to that of R410A, a sufficiently low GWP, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI);
the line segment IJ is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines. When the requirements above are satisfied, the refrigerant according to the present disclosure has a refrigerating capacity ratio of 80% or more relative to R410A, a GWP of 125 or less, and a WCF lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines. When the requirements above are satisfied, the refrigerant according to the present disclosure has a refrigerating capacity ratio of 70% or more relative to R410A, a GWP of 125 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line. When the requirements above are satisfied, the refrigerant according to the present disclosure has a refrigerating capacity ratio of 80% or more relative to R410A, a GWP of 250 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line. When the requirements above are satisfied, the refrigerant according to the present disclosure has a refrigerating capacity ratio of 92.5% or more relative to R410A, a GWP of 350 or less, and a WCF lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
   point P (20.5, 51.7, 27.8),
   point S (21.9, 39.7, 38.4), and
   point T (8.6, 51.6, 39.8),
   or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line. When the requirements above are satisfied, the refrigerant according to the present disclosure has a refrigerating capacity ratio of 92.5% or more relative to R410A, a GWP of 350 or less, and an ASHRAE lower flammability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ac, cf, fd, and da that connect the following 4 points:
   point a (71.1, 0.0, 28.9),
   point c (36.5, 18.2, 45.3),
   point f (47.6, 18.3, 34.1), and
   point d (72.0, 0.0, 28.0),
   or on these line segments;
the line segment ac is represented by coordinates (0.0181y²−2.2288y+71.096, y, −0.0181y²+1.2288y+28.904);
the line segment fd is represented by coordinates (0.02y²−1.7y+72, y, −0.02y²+0.7y+28); and
the line segments cf and da are straight lines. When the requirements above are satisfied, the refrigerant according to the present disclosure has a refrigerating capacity ratio of 85% or more relative to R410A, a GWP of 125 or less, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments ab, be, ed, and da that connect the following 4 points:
   point a (71.1, 0.0, 28.9),
   point b (42.6, 14.5, 42.9),
   point e (51.4, 14.6, 34.0), and
   point d (72.0, 0.0, 28.0),
   or on these line segments;
the line segment ab is represented by coordinates (0.0181y²−2.2288y+71.096, y, −0.0181y²+1.2288y+28.904);
the line segment ed is represented by coordinates (0.02y²−1.7y+72, y, −0.02y²+0.7y+28); and
the line segments be and da are straight lines. When the requirements above are satisfied, the refrigerant according to the present disclosure has a refrigerating capacity ratio of 85% or more relative to R410A, a GWP of 100 or less, and a lower flammability (Class 2L) according to the ASHRAE standard.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments gi, ij, and jg that connect the following 3 points:
   point g (77.5, 6.9, 15.6),
   point i (55.1, 18.3, 26.6), and
   point j (77.5. 18.4, 4.1),
   or on these line segments;
the line segment gi is represented by coordinates (0.02y²−2.4583y+93.396, y, −0.02y²+1.4583y+6.604); and
the line segments ij and jg are straight lines. When the requirements above are satisfied, the refrigerant according to the present disclosure has a refrigerating capacity ratio of 95% or more relative to R410A and a GWP of 100 or less, undergoes fewer or no changes such as polymerization or decomposition, and also has excellent stability.
The refrigerant D according to the present disclosure is preferably a refrigerant wherein
when the mass % of HFO-1132(E), R32, and R1234yf based on their sum is respectively represented by x, y, and z, coordinates (x,y,z) in a ternary composition diagram in which the sum of HFO-1132(E), R32, and R1234yf is 100 mass % are within the range of a figure surrounded by line segments gh, hk, and kg that connect the following 3 points:
   point g (77.5, 6.9, 15.6),
   point h (61.8, 14.6, 23.6), and
   point k (77.5, 14.6, 7.9),
   or on these line segments;
the line segment gh is represented by coordinates (0.02y²−2.4583y+93.396, y, −0.02y²+1.4583y+6.604); and
the line segments hk and kg are straight lines. When the requirements above are satisfied, the refrigerant according to the present disclosure has a refrigerating capacity ratio of 95% or more relative to R410A and a GWP of 100 or less, undergoes fewer or no changes such as polymerization or decomposition, and also has excellent stability.
The refrigerant D according to the present disclosure may further comprise other additional refrigerants in addition to HFO-1132(E), R32, and R1234yf, as long as the above properties and effects are not impaired. In this respect, the refrigerant according to the present disclosure preferably comprises HFO-1132(E), R32, and R1234yf in a total amount of 99.5 mass % or more, more preferably 99.75 mass % or more, and still more preferably 99.9 mass % or more based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant D)

The present disclosure is described in more detail below with reference to Examples of refrigerant D. However, the refrigerant D is not limited to the Examples.
The composition of each mixed refrigerant of HFO-1132(E), R32, and R1234yf was defined as WCF. A leak simulation was performed using the NIST Standard Reference Database REFLEAK Version 4.0 under the conditions of Equipment, Storage, Shipping, Leak, and Recharge according to the ASHRAE Standard 34-2013. The most flammable fraction was defined as WCFF.
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC. Tables 113 to 115 show the results.

TABLE 113

| | | | Comparative | | Example | | Example | | Example |
|---|---|---|---|---|---|---|---|---|---|
| | | | Example 13 | Example | 12 | Example | 14 | Example | 16 |
| Item | | Unit | I | 11 | J | 13 | K | 15 | L |
| WCF | HFO-1132(E) | Mass % | 72 | 57.2 | 48.5 | 41.2 | 35.6 | 32 | 28.9 |
| | R32 | Mass % | 0 | 10 | 18.3 | 27.6 | 36.8 | 44.2 | 51.7 |
| | R1234yf | Mass % | 28 | 32.8 | 33.2 | 31.2 | 27.6 | 23.8 | 19.4 |

| | | | | | | | | |
|---|---|---|---|---|---|---|---|---|
| Burning Velocity (WCF) | cm/s | 10 | 10 | 10 | 10 | 10 | 10 | 10 |

TABLE 114

| | | | Comparative | | Example | | Example | |
|---|---|---|---|---|---|---|---|---|
| | | | Example 14 | Example | 19 | Example | 21 | Example |
| Item | | Unit | M | 18 | W | 20 | N | 22 |
| WCF | HFO-1132(E) | Mass % | 52.6 | 39.2 | 32.4 | 29.3 | 27.7 | 24.6 |
| | R32 | Mass % | 0.0 | 5.0 | 10.0 | 14.5 | 18.2 | 27.6 |
| | R1234yf | Mass % | 47.4 | 55.8 | 57.6 | 56.2 | 54.1 | 47.8 |
| Leak condition that results in WCFF | | | Storage, | Storage, | Storage, | Storage, | Storage, | Storage, |
| | | | Shipping, −40° | Shipping, −40° | Shipping, −40° | Shipping, −40° | Shipping, −40° | Shipping, −40° |
| | | | C., 0% | C., 0% | C., 0% | C., 0% | C., 0% | C., 0% |
| | | | release, on | release, on | release, on | release, on | release, on | release, on |
| | | | the gas | the gas | the gas | the gas | the gas | the gas |
| | | | phase side | phase side | phase side | phase side | phase side | phase side |
| WCF | HFO-1132(E) | Mass % | 72.0 | 57.8 | 48.7 | 43.6 | 40.6 | 34.9 |
| | R32 | Mass % | 0.0 | 9.5 | 17.9 | 24.2 | 28.7 | 38.1 |
| | R1234yf | Mass % | 28.0 | 32.7 | 33.4 | 32.2 | 30.7 | 27.0 |

| | | | | | | | |
|---|---|---|---|---|---|---|---|
| Burning Velocity (WCF) | cm/s | 8 or less | 8 or less | 8 or less | 8 or less | 8 or less | 8 or less |
| Burning Velocity (WCFF) | cm/s | 10 | 10 | 10 | 10 | 10 | 10 |

TABLE 115

| | | | Example | | Example |
|---|---|---|---|---|---|
| | | | 23 | Example | 25 |
| Item | | Unit | O | 24 | P |
| WCF | HFO-1132(E) | Mass % | 22.6 | 21.2 | 20.5 |
| | HFO-1123 | Mass % | 36.8 | 44.2 | 51.7 |
| | R1234yf | Mass % | 40.6 | 34.6 | 27.8 |
| Leak condition that results in WCFF | | | Storage, | Storage, | Storage, |
| | | | Shipping, | Shipping, | Shipping, |
| | | | −40° C., 0% | −40° C., 0% | −40° C., 0% |
| | | | release, on | release, on | release, on |
| | | | the gas | the gas | the gas |
| | | | phase side | phase side | phase side |
| WCFF | HFO-1132(E) | Mass % | 31.4 | 29.2 | 27.1 |
| | HFO-1123 | Mass % | 45.7 | 51.1 | 56.4 |
| | R1234yf | Mass % | 23.0 | 19.7 | 16.5 |

| | | | | |
|---|---|---|---|---|
| Burning Velocity (WCF) | cm/s | 8 or less | 8 or less | 8 or less |
| Burning Velocity (WCFF) | cm/s | 10 | 10 | 10 |

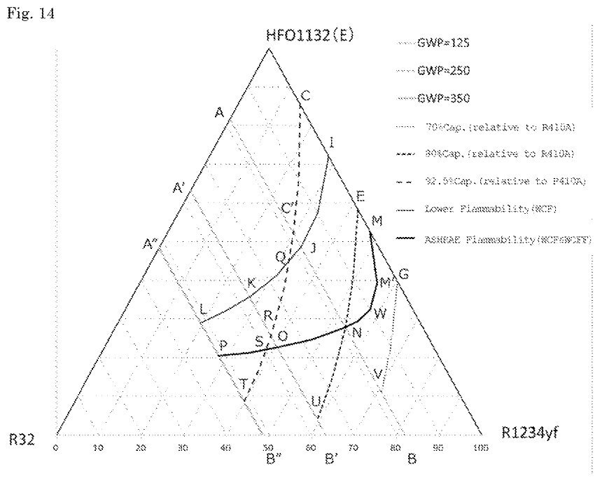

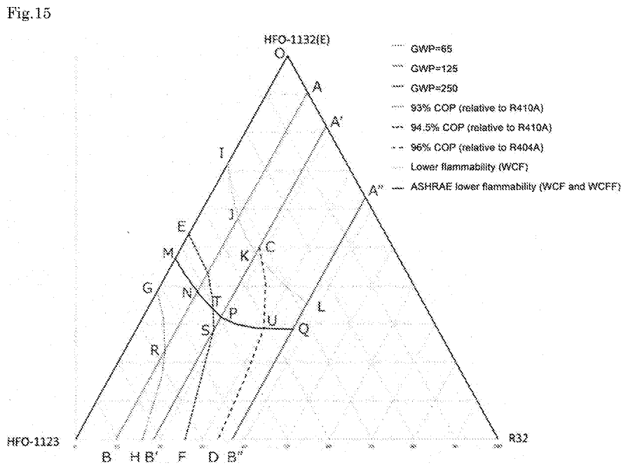

The results indicate that under the condition that the mass % of HFO-1132(E), R32, and R1234yf based on their sum is respectively represented by x, y, and z, when coordinates (x,y,z) in the ternary composition diagram shown in FIG. 14 in which the sum of HFO-1132(E), R32, and R1234yf is 100 mass % are on the line segment that connects point I, point J, point K, and point L, or below these line segments, the refrigerant has a WCF lower flammability.
The results also indicate that when coordinates (x,y,z) in the ternary composition diagram shown in FIG. 14 are on the line segments that connect point M, point M′, point W, point J, point N, and point P, or below these line segments, the refrigerant has an ASHRAE lower flammability.
Mixed refrigerants were prepared by mixing HFO-1132(E), R32, and R1234yf in amounts (mass %) shown in Tables 116 to 144 based on the sum of HFO-1132(E), R32, and R1234yf. The coefficient of performance (COP) ratio and the refrigerating capacity ratio relative to R410 of the mixed refrigerants shown in Tables 116 to 144 were determined. The conditions for calculation were as described below.
Evaporating temperature: 5° C.
Condensation temperature: 45° C.
Degree of superheating: 5 K
Degree of subcooling: 5 K
Compressor efficiency: 70%
Tables 116 to 144 show these values together with the GWP of each mixed refrigerant.

TABLE 116

| | | | Comparative | Comparative | Comparative | Comparative | Comparative | Comparative |
|---|---|---|---|---|---|---|---|---|
| | | Comparative | Example 2 | Example 3 | Example 4 | Example 5 | Example 6 | Example 7 |
| Item | Unit | Example 1 | A | B | A′ | B′ | A″ | B″ |
| HFO-1132(E) | Mass % | R410A | 81.6 | 0.0 | 63.1 | 0.0 | 48.2 | 0.0 |
| R32 | Mass % | | 18.4 | 18.1 | 36.9 | 36.7 | 51.8 | 51.5 |
| R1234yf | Mass % | | 0.0 | 81.9 | 0.0 | 63.3 | 0.0 | 48.5 |
| GWP | — | 2088 | 125 | 125 | 250 | 250 | 350 | 350 |
| COP Ratio | % (relative | 100 | 98.7 | 103.6 | 98.7 | 102.3 | 99.2 | 102.2 |
| | to R410A) | | | | | | | |
| Refrigerating | % (relative | 100 | 105.3 | 62.5 | 109.9 | 77.5 | 112.1 | 87.3 |
| Capacity Ratio | to R410A) | | | | | | | |

TABLE 117

| | | Comparative | | Comparative | | Example | | Example |
|---|---|---|---|---|---|---|---|---|
| | | Example 8 | Comparative | Example 10 | Example | 2 | Example | 4 |
| Item | Unit | C | Example 9 | C′ | 1 | R | 3 | T |
| HFO-1132(E) | Mass % | 85.5 | 66.1 | 52.1 | 37.8 | 25.5 | 16.6 | 8.6 |
| R32 | Mass % | 0.0 | 10.0 | 18.2 | 27.6 | 36.8 | 44.2 | 51.6 |
| R1234yf | Mass % | 14.5 | 23.9 | 29.7 | 34.6 | 37.7 | 39.2 | 39.8 |
| GWP | — | 1 | 69 | 125 | 188 | 250 | 300 | 350 |
| COP Ratio | % (relative | 99.8 | 99.3 | 99.3 | 99.6 | 100.2 | 100.8 | 101.4 |
| | to R410A) | | | | | | | |
| Refrigerating | % (relative | 92.5 | 92.5 | 92.5 | 92.5 | 92.5 | 92.5 | 92.5 |
| Capacity Ratio | to R410A) | | | | | | | |

TABLE 118

| | | Comparative | | Example | | Example | Comparative | | Example |
|---|---|---|---|---|---|---|---|---|---|
| | | Example 11 | Example | 6 | Example | 8 | Example 12 | Example | 10 |
| Item | Unit | E | 5 | N | 7 | U | G | 9 | V |
| HFO-1132(E) | Mass % | 58.3 | 40.5 | 27.7 | 14.9 | 3.9 | 39.6 | 22.8 | 11.0 |
| R32 | Mass % | 0.0 | 10.0 | 18.2 | 27.6 | 36.7 | 0.0 | 10.0 | 18.1 |
| R1234yf | Mass % | 41.7 | 49.5 | 54.1 | 57.5 | 59.4 | 60.4 | 67.2 | 70.9 |
| GWP | — | 2 | 70 | 125 | 189 | 250 | 3 | 70 | 125 |
| COP Ratio | % (relative | 100.3 | 100.3 | 100.7 | 101.2 | 101.9 | 101.4 | 101.8 | 102.3 |
| | to R410A) | | | | | | | | |
| Refrigerating | % (relative | 80.0 | 80.0 | 80.0 | 80.0 | 80.0 | 70.0 | 70.0 | 70.0 |
| Capacity Ratio | to R410A) | | | | | | | | |

TABLE 119

| | | Comparative | | Example | | Example | | Example | Example |
|---|---|---|---|---|---|---|---|---|---|
| | | Example 13 | Example | 12 | Example | 14 | Example | 16 | 17 |
| Item | Unit | I | 11 | J | 13 | K | 15 | L | Q |
| HFO-1132(E) | Mass % | 72.0 | 57.2 | 48.5 | 41.2 | 35.6 | 32.0 | 28.9 | 44.6 |
| R32 | Mass % | 0.0 | 10.0 | 18.3 | 27.6 | 36.8 | 44.2 | 51.7 | 23.0 |
| R1234yf | Mass % | 28.0 | 32.8 | 33.2 | 31.2 | 27.6 | 23.8 | 19.4 | 32.4 |
| GWP | — | 2 | 69 | 125 | 188 | 250 | 300 | 350 | 157 |
| COP Ratio | % (relative | 99.9 | 99.5 | 99.4 | 99.5 | 99.6 | 99.8 | 100.1 | 99.4 |
| | to R410A) | | | | | | | | |
| Refrigerating | % (relative | 86.6 | 88.4 | 90.9 | 94.2 | 97.7 | 100.5 | 103.3 | 92.5 |
| Capacity Ratio | to R410A) | | | | | | | | |

TABLE 120

| | | Comparative | | Example | | Example | |
|---|---|---|---|---|---|---|---|
| | | Example 14 | Example | 19 | Example | 21 | Example |
| Item | Unit | M | 18 | W | 20 | N | 22 |
| HFO-1132(E) | Mass % | 52.6 | 39.2 | 32.4 | 29.3 | 27.7 | 24.5 |
| R32 | Mass % | 0.0 | 5.0 | 10.0 | 14.5 | 18.2 | 27.6 |
| R1234yf | Mass % | 47.4 | 55.8 | 57.6 | 56.2 | 54.1 | 47.9 |
| GWP | — | 2 | 36 | 70 | 100 | 125 | 188 |
| COP Ratio | % (relative | 100.5 | 100.9 | 100.9 | 100.8 | 100.7 | 100.4 |
| | to R410A) | | | | | | |
| Refrigerating | % (relative | 77.1 | 74.8 | 75.6 | 77.8 | 80.0 | 85.5 |
| Capacity Ratio | to R410A) | | | | | | |

TABLE 121

| | | Example | | Example | Example |
|---|---|---|---|---|---|
| | | 23 | Example | 25 | 26 |
| Item | Unit | O | 24 | P | S |
| HFO-1132(E) | Mass % | 22.6 | 21.2 | 20.5 | 21.9 |
| R32 | Mass % | 36.8 | 44.2 | 51.7 | 39.7 |
| R1234yf | Mass % | 40.6 | 34.6 | 27.8 | 38.4 |
| GWP | — | 250 | 300 | 350 | 270 |
| COP Ratio | % (relative | 100.4 | 100.5 | 100.6 | 100.4 |
| | to R410A) | | | | |
| Refrigerating | % (relative | 91.0 | 95.0 | 99.1 | 92.5 |
| Capacity Ratio | to R410A) | | | | |

TABLE 122

| | | Comparative | Comparative | Comparative | Comparative | Example | Example | Comparative | Comparative |
|---|---|---|---|---|---|---|---|---|---|
| Item | Unit | Example 15 | Example 16 | Example 17 | Example 18 | 27 | 28 | Example 19 | Example 20 |
| HFO-1132(E) | Mass % | 10.0 | 20.0 | 30.0 | 40.0 | 50.0 | 60.0 | 70.0 | 80.0 |
| R32 | Mass % | 5.0 | 5.0 | 5.0 | 5.0 | 5.0 | 5.0 | 5.0 | 5.0 |
| R1234yf | Mass % | 85.0 | 75.0 | 65.0 | 55.0 | 45.0 | 35.0 | 25.0 | 15.0 |
| GWP | — | 37 | 37 | 37 | 36 | 36 | 36 | 35 | 35 |
| COP Ratio | % (relative | 103.4 | 102.6 | 101.6 | 100.8 | 100.2 | 99.8 | 99.6 | 99.4 |
| | to R410A) | | | | | | | | |
| Refrigerating | % (relative | 56.4 | 63.3 | 69.5 | 75.2 | 80.5 | 85.4 | 90.1 | 94.4 |
| Capacity Ratio | to R410A) | | | | | | | | |

TABLE 123

| | | Comparative | Comparative | Example | Comparative | Example | Comparative | Comparative | Comparative |
|---|---|---|---|---|---|---|---|---|---|
| Item | Unit | Example 21 | Example 22 | 29 | Example 23 | 30 | Example 24 | Example 25 | Example 26 |
| HFO-1132(E) | Mass % | 10.0 | 20.0 | 30.0 | 40.0 | 50.0 | 60.0 | 70.0 | 80.0 |
| R32 | Mass % | 10.0 | 10.0 | 10.0 | 10.0 | 10.0 | 10.0 | 10.0 | 10.0 |
| R1234yf | Mass % | 80.0 | 70.0 | 60.0 | 50.0 | 40.0 | 30.0 | 20.0 | 10.0 |
| GWP | — | 71 | 71 | 70 | 70 | 70 | 69 | 69 | 69 |
| COP Ratio | % (relative | 103.1 | 102.1 | 101.1 | 100.4 | 99.8 | 99.5 | 99.2 | 99.1 |
| | to R410A) | | | | | | | | |
| Refrigerating | % (relative | 61.8 | 68.3 | 74.3 | 79.7 | 84.9 | 89.7 | 94.2 | 98.4 |
| Capacity Ratio | to R410A) | | | | | | | | |

TABLE 124

| | | Comparative | Example | Comparative | Example | Example | Comparative | Comparative | Comparative |
|---|---|---|---|---|---|---|---|---|---|
| Item | Unit | Example 27 | 31 | Example 28 | 32 | 33 | Example 29 | Example 30 | Example 31 |
| HFO-1132(E) | Mass % | 10.0 | 20.0 | 30.0 | 40.0 | 50.0 | 60.0 | 70.0 | 80.0 |
| R32 | Mass % | 15.0 | 15.0 | 15.0 | 15.0 | 15.0 | 15.0 | 15.0 | 15.0 |
| R1234yf | Mass % | 75.0 | 65.0 | 55.0 | 45.0 | 35.0 | 25.0 | 15.0 | 5.0 |
| GWP | — | 104 | 104 | 104 | 103 | 103 | 103 | 103 | 102 |
| COP Ratio | % (relative | 102.7 | 101.6 | 100.7 | 100.0 | 99.5 | 99.2 | 99.0 | 98.9 |
| | to R410A) | | | | | | | | |
| Refrigerating | % (relative | 66.6 | 72.9 | 78.6 | 84.0 | 89.0 | 93.7 | 98.1 | 102.2 |
| Capacity Ratio | to R410A) | | | | | | | | |

TABLE 125

| | | Comparative | Comparative | Comparative | Comparative | Comparative | Comparative | Comparative | Comparative |
|---|---|---|---|---|---|---|---|---|---|
| Item | Unit | Example 32 | Example 33 | Example 34 | Example 35 | Example 36 | Example 37 | Example 38 | Example 39 |
| HFO-1132(E) | Mass % | 10.0 | 20.0 | 30.0 | 40.0 | 50.0 | 60.0 | 70.0 | 10.0 |
| R32 | Mass % | 20.0 | 20.0 | 20.0 | 20.0 | 20.0 | 20.0 | 20.0 | 25.0 |
| R1234yf | Mass % | 70.0 | 60.0 | 50.0 | 40.0 | 30.0 | 20.0 | 10.0 | 65.0 |
| GWP | — | 138 | 138 | 137 | 137 | 137 | 136 | 136 | 171 |
| COP Ratio | % (relative | 102.3 | 101.2 | 100.4 | 99.7 | 99.3 | 99.0 | 98.8 | 101.9 |
| | to R410A) | | | | | | | | |
| Refrigerating | % (relative | 71.0 | 77.1 | 82.7 | 88.0 | 92.9 | 97.5 | 101.7 | 75.0 |
| Capacity Ratio | to R410A) | | | | | | | | |

TABLE 126

| | | Example | Comparative | Comparative | Comparative | Comparative | Comparative | Comparative | Example |
|---|---|---|---|---|---|---|---|---|---|
| Item | Unit | 34 | Example 40 | Example 41 | Example 42 | Example 43 | Example 44 | Example 45 | 35 |
| HFO-1132(E) | Mass % | 20.0 | 30.0 | 40.0 | 50.0 | 60.0 | 70.0 | 10.0 | 20.0 |
| R32 | Mass % | 25.0 | 25.0 | 25.0 | 25.0 | 25.0 | 25.0 | 30.0 | 30.0 |
| R1234yf | Mass % | 55.0 | 45.0 | 35.0 | 25.0 | 15.0 | 5.0 | 60.0 | 50.0 |
| GWP | — | 171 | 171 | 171 | 170 | 170 | 170 | 205 | 205 |
| COP Ratio | % (relative | 100.9 | 100.1 | 99.6 | 99.2 | 98.9 | 98.7 | 101.6 | 100.7 |
| | to R410A) | | | | | | | | |
| Refrigerating | % (relative | 81.0 | 86.6 | 91.7 | 96.5 | 101.0 | 105.2 | 78.9 | 84.8 |
| Capacity Ratio | to R410A) | | | | | | | | |

TABLE 127

| | | Comparative | Comparative | Comparative | Comparative | Example | Example | Example | Comparative |
|---|---|---|---|---|---|---|---|---|---|
| Item | Unit | Example 46 | Example 47 | Example 48 | Example 49 | 36 | 37 | 38 | Example 50 |
| HFO-1132(E) | Mass % | 30.0 | 40.0 | 50.0 | 60.0 | 10.0 | 20.0 | 30.0 | 40.0 |
| R32 | Mass % | 30.0 | 30.0 | 30.0 | 30.0 | 35.0 | 35.0 | 35.0 | 35.0 |
| R1234yf | Mass % | 40.0 | 30.0 | 20.0 | 10.0 | 55.0 | 45.0 | 35.0 | 25.0 |
| GWP | — | 204 | 204 | 204 | 204 | 239 | 238 | 238 | 238 |
| COP Ratio | % (relative | 100.0 | 99.5 | 99.1 | 98.8 | 101.4 | 100.6 | 99.9 | 99.4 |
| | to R410A) | | | | | | | | |
| Refrigerating | % (relative | 90.2 | 95.3 | 100.0 | 104.4 | 82.5 | 88.3 | 93.7 | 98.6 |
| Capacity Ratio | to R410A) | | | | | | | | |

TABLE 128

| | | Comparative | Comparative | Comparative | Comparative | Example | Comparative | Comparative | Comparative |
|---|---|---|---|---|---|---|---|---|---|
| Item | Unit | Example 51 | Example 52 | Example 53 | Example 54 | 39 | Example 55 | Example 56 | Example 57 |
| HFO-1132(E) | Mass % | 50.0 | 60.0 | 10.0 | 20.0 | 30.0 | 40.0 | 50.0 | 10.0 |
| R32 | Mass % | 35.0 | 35.0 | 40.0 | 40.0 | 40.0 | 40.0 | 40.0 | 45.0 |
| R1234yf | Mass % | 15.0 | 5.0 | 50.0 | 40.0 | 30.0 | 20.0 | 10.0 | 45.0 |
| GWP | — | 237 | 237 | 272 | 272 | 272 | 271 | 271 | 306 |
| COP Ratio | % (relative | 99.0 | 98.8 | 101.3 | 100.6 | 99.9 | 99.4 | 99.0 | 101.3 |
| | to R410A) | | | | | | | | |
| Refrigerating | % (relative | 103.2 | 107.5 | 86.0 | 91.7 | 96.9 | 101.8 | 106.3 | 89.3 |
| Capacity Ratio | to R410A) | | | | | | | | |

TABLE 129

| | | Example | Example | Comparative | Comparative | Comparative | Example | Comparative | Comparative |
|---|---|---|---|---|---|---|---|---|---|
| Item | Unit | 40 | 41 | Example 58 | Example 59 | Example 60 | 42 | Example 61 | Example 62 |
| HFO-1132(E) | Mass % | 20.0 | 30.0 | 40.0 | 50.0 | 10.0 | 20.0 | 30.0 | 40.0 |
| R32 | Mass % | 45.0 | 45.0 | 45.0 | 45.0 | 50.0 | 50.0 | 50.0 | 50.0 |
| R1234yf | Mass % | 35.0 | 25.0 | 15.0 | 5.0 | 40.0 | 30.0 | 20.0 | 10.0 |
| GWP | — | 305 | 305 | 305 | 304 | 339 | 339 | 339 | 338 |
| COP Ratio | % (relative | 100.6 | 100.0 | 99.5 | 99.1 | 101.3 | 100.6 | 100.0 | 99.5 |
| | to R410A) | | | | | | | | |
| Refrigerating | % (relative | 94.9 | 100.0 | 104.7 | 109.2 | 92.4 | 97.8 | 102.9 | 107.5 |
| Capacity Ratio | to R410A) | | | | | | | | |

TABLE 130

| | | Comparative | Comparative | Comparative | Comparative | Example | Example | Example | Example |
|---|---|---|---|---|---|---|---|---|---|
| Item | Unit | Example 63 | Example 64 | Example 65 | Example 66 | 43 | 44 | 45 | 46 |
| HFO-1132(E) | Mass % | 10.0 | 20.0 | 30.0 | 40.0 | 56.0 | 59.0 | 62.0 | 65.0 |
| R32 | Mass % | 55.0 | 55.0 | 55.0 | 55.0 | 3.0 | 3.0 | 3.0 | 3.0 |
| R1234yf | Mass % | 35.0 | 25.0 | 15.0 | 5.0 | 41.0 | 38.0 | 35.0 | 32.0 |
| GWP | — | 373 | 372 | 372 | 372 | 22 | 22 | 22 | 22 |
| COP Ratio | % (relative | 101.4 | 100.7 | 100.1 | 99.6 | 100.1 | 100.0 | 99.9 | 99.8 |
| | to R410A) | | | | | | | | |
| Refrigerating | % (relative | 95.3 | 100.6 | 105.6 | 110.2 | 81.7 | 83.2 | 84.6 | 86.0 |
| Capacity Ratio | to R410A) | | | | | | | | |

TABLE 131

| | | Example | Example | Example | Example | Example | Example | Example | Example |
|---|---|---|---|---|---|---|---|---|---|
| Item | Unit | 47 | 48 | 49 | 50 | 51 | 52 | 53 | 54 |
| HFO-1132(E) | Mass % | 49.0 | 52.0 | 55.0 | 58.0 | 61.0 | 43.0 | 46.0 | 49.0 |
| R32 | Mass % | 6.0 | 6.0 | 6.0 | 6.0 | 6.0 | 9.0 | 9.0 | 9.0 |
| R1234yf | Mass % | 45.0 | 42.0 | 39.0 | 36.0 | 33.0 | 48.0 | 45.0 | 42.0 |
| GWP | — | 43 | 43 | 43 | 43 | 42 | 63 | 63 | 63 |
| COP Ratio | % (relative | 100.2 | 100.0 | 99.9 | 99.8 | 99.7 | 100.3 | 100.1 | 99.9 |
| | to R410A) | | | | | | | | |
| Refrigerating | % (relative | 80.9 | 82.4 | 83.9 | 85.4 | 86.8 | 80.4 | 82.0 | 83.5 |
| Capacity Ratio | to R410A) | | | | | | | | |

TABLE 132

| | | Example | Example | Example | Example | Example | Example | Example | Example |
|---|---|---|---|---|---|---|---|---|---|
| Item | Unit | 55 | 56 | 57 | 58 | 59 | 60 | 61 | 62 |
| HFO-1132(E) | Mass % | 52.0 | 55.0 | 58.0 | 38.0 | 41.0 | 44.0 | 47.0 | 50.0 |
| R32 | Mass % | 9.0 | 9.0 | 9.0 | 12.0 | 12.0 | 12.0 | 12.0 | 12.0 |
| R1234yf | Mass % | 39.0 | 36.0 | 33.0 | 50.0 | 47.0 | 44.0 | 41.0 | 38.0 |
| GWP | — | 63 | 63 | 63 | 83 | 83 | 83 | 83 | 83 |
| COP Ratio | % (relative | 99.8 | 99.7 | 99.6 | 100.3 | 100.1 | 100.0 | 99.8 | 99.7 |
| | to R410A) | | | | | | | | |
| Refrigerating | % (relative | 85.0 | 86.5 | 87.9 | 80.4 | 82.0 | 83.5 | 85.1 | 86.6 |
| Capacity Ratio | to R410A) | | | | | | | | |

TABLE 133

| | | Example | Example | Example | Example | Example | Example | Example | Example |
|---|---|---|---|---|---|---|---|---|---|
| Item | Unit | 63 | 64 | 65 | 66 | 67 | 68 | 69 | 70 |
| HFO-1132(E) | Mass % | 53.0 | 33.0 | 36.0 | 39.0 | 42.0 | 45.0 | 48.0 | 51.0 |
| R32 | Mass % | 12.0 | 15.0 | 15.0 | 15.0 | 15.0 | 15.0 | 15.0 | 15.0 |
| R1234yf | Mass % | 35.0 | 52.0 | 49.0 | 46.0 | 43.0 | 40.0 | 37.0 | 34.0 |
| GWP | — | 83 | 104 | 104 | 103 | 103 | 103 | 103 | 103 |
| COP Ratio | % (relative | 99.6 | 100.5 | 100.3 | 100.1 | 99.9 | 99.7 | 99.6 | 99.5 |
| | to R410A) | | | | | | | | |
| Refrigerating | % (relative | 88.0 | 80.3 | 81.9 | 83.5 | 85.0 | 86.5 | 88.0 | 89.5 |
| Capacity Ratio | to R410A) | | | | | | | | |

TABLE 134

| | | Example | Example | Example | Example | Example | Example | Example | Example |
|---|---|---|---|---|---|---|---|---|---|
| Item | Unit | 71 | 72 | 73 | 74 | 75 | 76 | 77 | 78 |
| HFO-1132(E) | Mass % | 29.0 | 32.0 | 35.0 | 38.0 | 41.0 | 44.0 | 47.0 | 36.0 |
| R32 | Mass % | 18.0 | 18.0 | 18.0 | 18.0 | 18.0 | 18.0 | 18.0 | 3.0 |
| R1234yf | Mass % | 53.0 | 50.0 | 47.0 | 44.0 | 41.0 | 38.0 | 35.0 | 61.0 |
| GWP | — | 124 | 124 | 124 | 124 | 124 | 123 | 123 | 23 |
| COP Ratio | % (relative | 100.6 | 100.3 | 100.1 | 99.9 | 99.8 | 99.6 | 99.5 | 101.3 |
| | to R410A) | | | | | | | | |
| Refrigerating | % (relative | 80.6 | 82.2 | 83.8 | 85.4 | 86.9 | 88.4 | 89.9 | 71.0 |
| Capacity Ratio | to R410A) | | | | | | | | |

TABLE 135

| | | Example | Example | Example | Example | Example | Example | Example | Example |
|---|---|---|---|---|---|---|---|---|---|
| Item | Unit | 79 | 80 | 81 | 82 | 83 | 84 | 85 | 86 |
| HFO-1132(E) | Mass % | 39.0 | 42.0 | 30.0 | 33.0 | 36.0 | 26.0 | 29.0 | 32.0 |
| R32 | Mass % | 3.0 | 3.0 | 6.0 | 6.0 | 6.0 | 9.0 | 9.0 | 9.0 |
| R1234yf | Mass % | 58.0 | 55.0 | 64.0 | 61.0 | 58.0 | 65.0 | 62.0 | 59.0 |
| GWP | — | 23 | 23 | 43 | 43 | 43 | 64 | 64 | 63 |
| COP Ratio | % (relative | 101.1 | 100.9 | 101.5 | 101.3 | 101.0 | 101.6 | 101.3 | 101.1 |
| | to R410A) | | | | | | | | |
| Refrigerating | % (relative | 72.7 | 74.4 | 70.5 | 72.2 | 73.9 | 71.0 | 72.8 | 74.5 |
| Capacity Ratio | to R410A) | | | | | | | | |

TABLE 136

| | | Example | Example | Example | Example | Example | Example | Example | Example |
|---|---|---|---|---|---|---|---|---|---|
| Item | Unit | 87 | 88 | 89 | 90 | 91 | 92 | 93 | 94 |
| HFO-1132(E) | Mass % | 21.0 | 24.0 | 27.0 | 30.0 | 16.0 | 19.0 | 22.0 | 25.0 |
| R32 | Mass % | 12.0 | 12.0 | 12.0 | 12.0 | 15.0 | 15.0 | 15.0 | 15.0 |
| R1234yf | Mass % | 67.0 | 64.0 | 61.0 | 58.0 | 69.0 | 66.0 | 63.0 | 60.0 |
| GWP | — | 84 | 84 | 84 | 84 | 104 | 104 | 104 | 104 |
| COP Ratio | % (relative | 101.8 | 101.5 | 101.2 | 101.0 | 102.1 | 101.8 | 101.4 | 101.2 |
| | to R410A) | | | | | | | | |
| Refrigerating | % (relative | 70.8 | 72.6 | 74.3 | 76.0 | 70.4 | 72.3 | 74.0 | 75.8 |
| Capacity Ratio | to R410A) | | | | | | | | |

TABLE 137

| | | Example | Example | Example | Example | Example | Example | Example | Example |
|---|---|---|---|---|---|---|---|---|---|
| Item | Unit | 95 | 96 | 97 | 98 | 99 | 100 | 101 | 102 |
| HFO-1132(E) | Mass % | 28.0 | 12.0 | 15.0 | 18.0 | 21.0 | 24.0 | 27.0 | 25.0 |
| R32 | Mass % | 15.0 | 18.0 | 18.0 | 18.0 | 18.0 | 18.0 | 18.0 | 21.0 |
| R1234yf | Mass % | 57.0 | 70.0 | 67.0 | 64.0 | 61.0 | 58.0 | 55.0 | 54.0 |
| GWP | — | 104 | 124 | 124 | 124 | 124 | 124 | 124 | 144 |
| COP Ratio | % (relative | 100.9 | 102.2 | 101.9 | 101.6 | 101.3 | 101.0 | 100.7 | 100.7 |
| | to R410A) | | | | | | | | |
| Refrigerating | % (relative | 77.5 | 70.5 | 72.4 | 74.2 | 76.0 | 77.7 | 79.4 | 80.7 |
| Capacity Ratio | to R410A) | | | | | | | | |

TABLE 138

| | | Example | Example | Example | Example | Example | Example | Example | Example |
|---|---|---|---|---|---|---|---|---|---|
| Item | Unit | 103 | 104 | 105 | 106 | 107 | 108 | 109 | 110 |
| HFO-1132(E) | Mass % | 21.0 | 24.0 | 17.0 | 20.0 | 23.0 | 13.0 | 16.0 | 19.0 |
| R32 | Mass % | 24.0 | 24.0 | 27.0 | 27.0 | 27.0 | 30.0 | 30.0 | 30.0 |
| R1234yf | Mass % | 55.0 | 52.0 | 56.0 | 53.0 | 50.0 | 57.0 | 54.0 | 51.0 |
| GWP | — | 164 | 164 | 185 | 185 | 184 | 205 | 205 | 205 |
| COP Ratio | % (relative | 100.9 | 100.6 | 101.1 | 100.8 | 100.6 | 101.3 | 101.0 | 100.8 |
| | to R410A) | | | | | | | | |
| Refrigerating | % (relative | 80.8 | 82.5 | 80.8 | 82.5 | 84.2 | 80.7 | 82.5 | 84.2 |
| Capacity Ratio | to R410A) | | | | | | | | |

TABLE 139

| | | Example | Example | Example | Example | Example | Example | Example | Example |
|---|---|---|---|---|---|---|---|---|---|
| Item | Unit | 111 | 112 | 113 | 114 | 115 | 116 | 117 | 118 |
| HFO-1132(E) | Mass % | 22.0 | 9.0 | 12.0 | 15.0 | 18.0 | 21.0 | 8.0 | 12.0 |
| R32 | Mass % | 30.0 | 33.0 | 33.0 | 33.0 | 33.0 | 33.0 | 36.0 | 36.0 |
| R1234yf | Mass % | 48.0 | 58.0 | 55.0 | 52.0 | 49.0 | 46.0 | 56.0 | 52.0 |
| GWP | — | 205 | 225 | 225 | 225 | 225 | 225 | 245 | 245 |
| COP Ratio | % (relative | 100.5 | 101.6 | 101.3 | 101.0 | 100.8 | 100.5 | 101.6 | 101.2 |
| | to R410A) | | | | | | | | |
| Refrigerating | % (relative | 85.9 | 80.5 | 82.3 | 84.1 | 85.8 | 87.5 | 82.0 | 84.4 |
| Capacity Ratio | to R410A) | | | | | | | | |

TABLE 140

| | | Example | Example | Example | Example | Example | Example | Example | Example |
|---|---|---|---|---|---|---|---|---|---|
| Item | Unit | 119 | 120 | 121 | 122 | 123 | 124 | 125 | 126 |
| HFO-1132(E) | Mass % | 15.0 | 18.0 | 21.0 | 42.0 | 39.0 | 34.0 | 37.0 | 30.0 |
| R32 | Mass % | 36.0 | 36.0 | 36.0 | 25.0 | 28.0 | 31.0 | 31.0 | 34.0 |
| R1234yf | Mass % | 49.0 | 46.0 | 43.0 | 33.0 | 33.0 | 35.0 | 32.0 | 36.0 |
| GWP | — | 245 | 245 | 245 | 170 | 191 | 211 | 211 | 231 |
| COP Ratio | % (relative | 101.0 | 100.7 | 100.5 | 99.5 | 99.5 | 99.8 | 99.6 | 99.9 |
| | to R410A) | | | | | | | | |
| Refrigerating | % (relative | 86.2 | 87.9 | 89.6 | 92.7 | 93.4 | 93.0 | 94.5 | 93.0 |
| Capacity Ratio | to R410A) | | | | | | | | |

TABLE 141

| | | Example | Example | Example | Example | Example | Example | Example | Example |
|---|---|---|---|---|---|---|---|---|---|
| Item | Unit | 127 | 128 | 129 | 130 | 131 | 132 | 133 | 134 |
| HFO-1132(E) | Mass % | 33.0 | 36.0 | 24.0 | 27.0 | 30.0 | 33.0 | 23.0 | 26.0 |
| R32 | Mass % | 34.0 | 34.0 | 37.0 | 37.0 | 37.0 | 37.0 | 40.0 | 40.0 |
| R1234yf | Mass % | 33.0 | 30.0 | 39.0 | 36.0 | 33.0 | 30.0 | 37.0 | 34.0 |
| GWP | — | 231 | 231 | 252 | 251 | 251 | 251 | 272 | 272 |
| COP Ratio | % (relative | 99.8 | 99.6 | 100.3 | 100.1 | 99.9 | 99.8 | 100.4 | 100.2 |
| | to R410A) | | | | | | | | |
| Refrigerating | % (relative | 94.5 | 96.0 | 91.9 | 93.4 | 95.0 | 96.5 | 93.3 | 94.9 |
| Capacity Ratio | to R410A) | | | | | | | | |

TABLE 142

| | | Example | Example | Example | Example | Example | Example | Example | Example |
|---|---|---|---|---|---|---|---|---|---|
| Item | Unit | 135 | 136 | 137 | 138 | 139 | 140 | 141 | 142 |
| HFO-1132(E) | Mass % | 29.0 | 32.0 | 19.0 | 22.0 | 25.0 | 28.0 | 31.0 | 18.0 |
| R32 | Mass % | 40.0 | 40.0 | 43.0 | 43.0 | 43.0 | 43.0 | 43.0 | 46.0 |
| R1234yf | Mass % | 31.0 | 28.0 | 38.0 | 35.0 | 32.0 | 29.0 | 26.0 | 36.0 |
| GWP | — | 272 | 271 | 292 | 292 | 292 | 292 | 292 | 312 |
| COP Ratio | % (relative | 100.0 | 99.8 | 100.6 | 100.4 | 100.2 | 100.1 | 99.9 | 100.7 |
| | to R410A) | | | | | | | | |
| Refrigerating | % (relative | 96.4 | 97.9 | 93.1 | 94.7 | 96.2 | 97.8 | 99.3 | 94.4 |
| Capacity Ratio | to R410A) | | | | | | | | |

TABLE 143

| | | Example | Example | Example | Example | Example | Example | Example | Example |
|---|---|---|---|---|---|---|---|---|---|
| Item | Unit | 143 | 144 | 145 | 146 | 147 | 148 | 149 | 150 |
| HFO-1132(E) | Mass % | 21.0 | 23.0 | 26.0 | 29.0 | 13.0 | 16.0 | 19.0 | 22.0 |
| R32 | Mass % | 46.0 | 46.0 | 46.0 | 46.0 | 49.0 | 49.0 | 49.0 | 49.0 |
| R1234yf | Mass % | 33.0 | 31.0 | 28.0 | 25.0 | 38.0 | 35.0 | 32.0 | 29.0 |
| GWP | — | 312 | 312 | 312 | 312 | 332 | 332 | 332 | 332 |
| COP Ratio | % (relative | 100.5 | 100.4 | 100.2 | 100.0 | 101.1 | 100.9 | 100.7 | 100.5 |
| | to R410A) | | | | | | | | |
| Refrigerating | % (relative | 96.0 | 97.0 | 98.6 | 100.1 | 93.5 | 95.1 | 96.7 | 98.3 |
| Capacity Ratio | to R410A) | | | | | | | | |

TABLE 144

| | | Example | Example |
|---|---|---|---|
| Item | Unit | 151 | 152 |
| HFO-1132(E) | Mass % | 25.0 | 28.0 |
| R32 | Mass % | 49.0 | 49.0 |
| R1234yf | Mass % | 26.0 | 23.0 |
| GWP | — | 332 | 332 |
| COP Ratio | % (relative | 100.3 | 100.1 |
| | to R410A) | | |
| Refrigerating | % (relative | 99.8 | 101.3 |
| Capacity Ratio | to R410A) | | |

The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments IJ, JN, NE, and EI that connect the following 4 points:
   point I (72.0, 0.0, 28.0),
   point J (48.5, 18.3, 33.2),
   point N (27.7, 18.2, 54.1), and
   point E (58.3, 0.0, 41.7),
   or on these line segments (excluding the points on the line segment EI),
the line segment IJ is represented by coordinates (0.0236y²−1.7616y+72.0, y, −0.0236y²+0.7616y+28.0),
the line segment NE is represented by coordinates (0.012y²−1.9003y+58.3, y, −0.012y²+0.9003y+41.7), and
the line segments JN and EI are straight lines, the refrigerant D has a refrigerating capacity ratio of 80% or more relative to R410A, a GWP of 125 or less, and a WCF lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
   point M (52.6, 0.0, 47.4),
   point M′ (39.2, 5.0, 55.8),
   point N (27.7, 18.2, 54.1),
   point V (11.0, 18.1, 70.9), and
   point G (39.6, 0.0, 60.4),
   or on these line segments (excluding the points on the line segment GM),
the line segment MM′ is represented by coordinates (0.132y²−3.34y+52.6, y, −0.132y²+2.34y+47.4),
the line segment M′N is represented by coordinates (0.0596y²−2.2541y+48.98, y, −0.0596y²+1.2541y+51.02),
the line segment VG is represented by coordinates (0.0123y²−1.8033y+39.6, y, −0.0123y²+0.8033y+60.4), and
the line segments NV and GM are straight lines, the refrigerant D according to the present disclosure has a refrigerating capacity ratio of 70% or more relative to R410A, a GWP of 125 or less, and an ASHRAE lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments ON, NU, and UO that connect the following 3 points:
   point O (22.6, 36.8, 40.6),
   point N (27.7, 18.2, 54.1), and
   point U (3.9, 36.7, 59.4),
   or on these line segments,
the line segment ON is represented by coordinates (0.0072y²−0.6701y+37.512, y, −0.0072y²−0.3299y+62.488),
the line segment NU is represented by coordinates (0.0083y²−1.7403y+56.635, y, −0.0083y²+0.7403y+43.365), and
the line segment UO is a straight line, the refrigerant D according to the present disclosure has a refrigerating capacity ratio of 80% or more relative to R410A, a GWP of 250 or less, and an ASHRAE lower flammability.
The results also indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
   point Q (44.6, 23.0, 32.4),
   point R (25.5, 36.8, 37.7),
   point T (8.6, 51.6, 39.8),
   point L (28.9, 51.7, 19.4), and
   point K (35.6, 36.8, 27.6),
   or on these line segments,
the line segment QR is represented by coordinates (0.0099y²−1.975y+84.765, y, −0.0099y²+0.975y+15.235),
the line segment RT is represented by coordinates (0.0082y²−1.8683y+83.126, y, −0.0082y²+0.8683y+16.874),
the line segment LK is represented by coordinates (0.0049y²−0.8842y+61.488, y, −0.0049y²−0.1158y+38.512),
the line segment KQ is represented by coordinates (0.0095y²−1.2222y+67.676, y, −0.0095y²+0.2222y+32.324), and
the line segment TL is a straight line, the refrigerant D according to the present disclosure has a refrigerating capacity ratio of 92.5% or more relative to R410A, a GWP of 350 or less, and a WCF lower flammability.

The results further indicate that under the condition that the mass % of HFO-1132(E), R32, and R1234yf based on their sum is respectively represented by x, y, and z, when coordinates (x,y,z) in a ternary composition diagram in which the sum of HFO-1132(E), R32, and R1234yf is 100 mass % are within the range of a figure surrounded by line segments PS, ST, and TP that connect the following 3 points:

point P (20.5, 51.7, 27.8),
point S (21.9, 39.7, 38.4), and
point T (8.6, 51.6, 39.8),
or on these line segments,
the line segment PS is represented by coordinates (0.0064y²−0.7103y+40.1, y, −0.0064y²−0.2897y+59.9),
the line segment ST is represented by coordinates (0.0082y²−1.8683y+83.126, y, −0.0082y²+0.8683y+16.874), and
the line segment TP is a straight line, the refrigerant D according to the present disclosure has a refrigerating capacity ratio of 92.5% or more relative to R410A, a GWP of 350 or less, and an ASHRAE lower flammability.

### (5-5) Refrigerant E

The refrigerant E according to the present disclosure is a mixed refrigerant comprising trans-1,2-difluoroethylene (HFO-1132(E)), trifluoroethylene (HFO-1123), and difluoromethane (R32).
The refrigerant E according to the present disclosure has various properties that are desirable as an R410A-alternative refrigerant, i.e., a coefficient of performance equivalent to that of R410A and a sufficiently low GWP.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
   point I (72.0, 28.0, 0.0),
   point K (48.4, 33.2, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GI);
the line segment IK is represented by coordinates (0.025z²−1.7429z+72.00, −0.025z²+0.7429z+28.0, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments KB′ and GI are straight lines. When the requirements above are satisfied, the refrigerant according to the present disclosure has WCF lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4 points:
   point I (72.0, 28.0, 0.0),
   point J (57.7, 32.8, 9.5),
   point R (23.1, 67.4, 9.5), and
   point G (38.5, 61.5, 0.0),
   or on these line segments (excluding the points on the line segment GI);
the line segment IJ is represented by coordinates (0.025z²−1.7429z+72.0, −0.025z²+0.7429z+28.0, z),
the line segment RG is represented by coordinates (−0.0491z²−1.1544z+38.5, 0.0491z²+0.1544z+61.5, z), and
the line segments JR and GI are straight lines. When the requirements above are satisfied, the refrigerant according to the present disclosure has WCF lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
   point M (47.1, 52.9, 0.0),
   point P (31.8, 49.8, 18.4),
   point B′ (0.0, 81.6, 18.4),
   point H (0.0, 84.2, 15.8),
   point R (23.1, 67.4, 9.5), and
   point G (38.5, 61.5, 0.0),
   or on these line segments (excluding the points on the line segments B′H and GM);
the line segment MP is represented by coordinates (0.0083z²−0.984z+47.1, −0.0083z²−0.016z+52.9, z),
the line segment HR is represented by coordinates (−0.3123z²+4.234z+11.06, 0.3123z²−5.234z+88.94, z),
the line segment RG is represented by coordinates (−0.0491z²−1.1544z+38.5, 0.0491z²+0.1544z+61.5, z), and
the line segments PB′ and GM are straight lines. When the requirements above are satisfied, the refrigerant according to the present disclosure has ASHRAE lower flammability, a COP ratio of 93% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
   point M (47.1, 52.9, 0.0),
   point N (38.5, 52.1, 9.5),
   point R (23.1, 67.4, 9.5), and
   point G (38.5, 61.5, 0.0),
   or on these line segments (excluding the points on the line segment GM);
the line segment MN is represented by coordinates (0.0083z²−0.984z+47.1, −0.0083z²−0.016z+52.9, z),
the line segment RG is represented by coordinates (−0.0491z²−1.1544z+38.5, 0.0491z²+0.1544z+61.5, z),
the line segments NR and GM are straight lines. When the requirements above are satisfied, the refrigerant according to the present disclosure has ASHRAE lower flammability, a COP ratio of 93% or more relative to that of R410A, and a GWP of 65 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
   point P (31.8, 49.8, 18.4),
   point S (25.4, 56.2, 18.4), and
   point T (34.8, 51.0, 14.2),
   or on these line segments;
the line segment ST is represented by coordinates (−0.0982z²+0.9622z+40.931, 0.0982z²−1.9622z+59.069, z),
the line segment TP is represented by coordinates (0.0083z²−0.984z+47.1, −0.0083z²−0.016z+52.9, z), and
the line segment PS is a straight line. When the requirements above are satisfied, the refrigerant according to the present disclosure has ASHRAE lower flammability, a COP ratio of 94.5% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
   point Q (28.6, 34.4, 37.0),
   point B″ (0.0, 63.0, 37.0),
   point D (0.0, 67.0, 33.0), and
   point U (28.7, 41.2, 30.1),
   or on these line segments (excluding the points on the line segment B″D);
the line segment DU is represented by coordinates (−3.4962z²+210.71z−3146.1, 3.4962z²−211.71z+3246.1, z),
the line segment UQ is represented by coordinates (0.0135z²−0.9181z+44.133, −0.0135z²−0.0819z+55.867, z), and
the line segments QB″ and B″D are straight lines. When the requirements above are satisfied, the refrigerant according to the present disclosure has ASHRAE lower flammability, a COP ratio of 96% or more relative to that of R410A, and a GWP of 250 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc′, c′d′, d′e′, e′a′, and a′O that connect the following 5 points:
   point O (100.0, 0.0, 0.0),
   point c′ (56.7, 43.3, 0.0),
   point d′ (52.2, 38.3, 9.5),
   point e′ (41.8, 39.8, 18.4), and
   point a′ (81.6, 0.0, 18.4),
   or on the line segments c′d′, d′e′, and e′a′ (excluding the points c′ and a′);
the line segment c′d′ is represented by coordinates (−0.0297z²−0.1915z+56.7, 0.0297z²+1.1915z+43.3, z),
the line segment d′e′ is represented by coordinates (−0.0535z²+0.3229z+53.957, 0.0535z²+0.6771z+46.043, z), and
the line segments Oc′, e′a′, and a′O are straight lines. When the requirements above are satisfied, the refrigerant according to the present disclosure has a COP ratio of 92.5% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc, cd, de, ea′, and a′O that connect the following 5 points:
   point O (100.0, 0.0, 0.0),
   point c (77.7, 22.3, 0.0),
   point d (76.3, 14.2, 9.5),
   point e (72.2, 9.4, 18.4), and
   point a′ (81.6, 0.0, 18.4),
   or on the line segments cd, de, and ea′ (excluding the points c and a′);
the line segment cde is represented by coordinates (−0.017z²+0.0148z+77.684, 0.017z²+0.9852z+22.316, z), and
the line segments Oc, ea′, and a′O are straight lines. When the requirements above are satisfied, the refrigerant according to the present disclosure has a COP ratio of 95% or more relative to that of R410A, and a GWP of 125 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc′, c′d′, d′a, and aO that connect the following 5 points:
   point O (100.0, 0.0, 0.0),
   point c′ (56.7, 43.3, 0.0),
   point d′ (52.2, 38.3, 9.5), and
   point a (90.5, 0.0, 9.5),
   or on the line segments c′d′ and d′a (excluding the points c′ and a);
the line segment c′d′ is represented by coordinates (−0.0297z²−0.1915z+56.7, 0.0297z²+1.1915z+43.3, z), and
the line segments Oc′, d′a, and aO are straight lines. When the requirements above are satisfied, the refrigerant according to the present disclosure has a COP ratio of 93.5% or more relative to that of R410A, and a GWP of 65 or less.
The refrigerant E according to the present disclosure is preferably a refrigerant wherein
when the mass % of HFO-1132(E), HFO-1123, and R32 based on their sum is respectively represented by x, y, and z, coordinates (x,y,z) in a ternary composition diagram in which the sum of HFO-1132(E), HFO-1123, and R32 is 100 mass % are within the range of a figure surrounded by line segments Oc, cd, da, and aO that connect the following 4 points:
   point O (100.0, 0.0, 0.0),
   point c (77.7, 22.3, 0.0),
   point d (76.3, 14.2, 9.5), and
   point a (90.5, 0.0, 9.5),
   or on the line segments cd and da (excluding the points c and a);
the line segment cd is represented by coordinates (−0.017z²+0.0148z+77.684, 0.017z²+0.9852z+22.316, z), and
the line segments Oc, da, and aO are straight lines. When the requirements above are satisfied, the refrigerant according to the present disclosure has a COP ratio of 95% or more relative to that of R410A, and a GWP of 65 or less.
The refrigerant E according to the present disclosure may further comprise other additional refrigerants in addition to HFO-1132(E), HFO-1123, and R32, as long as the above properties and effects are not impaired. In this respect, the refrigerant according to the present disclosure preferably comprises HFO-1132(E), HFO-1123, and R32 in a total amount of 99.5 mass % or more, more preferably 99.75 mass % or more, and even more preferably 99.9 mass % or more, based on the entire refrigerant.
Such additional refrigerants are not limited, and can be selected from a wide range of refrigerants. The mixed refrigerant may comprise a single additional refrigerant, or two or more additional refrigerants.

### (Examples of Refrigerant E)

The present disclosure is described in more detail below with reference to Examples of refrigerant E. However, the refrigerant E is not limited to the Examples.
Mixed refrigerants were prepared by mixing HFO-1132(E), HFO-1123, and R32 at mass % based on their sum shown in Tables 145 and 146.
The composition of each mixture was defined as WCF. A leak simulation was performed using National Institute of Science and Technology (NIST) Standard Reference Data Base Refleak Version 4.0 under the conditions for equipment, storage, shipping, leak, and recharge according to the ASHRAE Standard 34-2013. The most flammable fraction was defined as WCFF.
For each mixed refrigerant, the burning velocity was measured according to the ANSI/ASHRAE Standard 34-2013. When the burning velocities of the WCF composition and the WCFF composition are 10 cm/s or less, the flammability of such a refrigerant is classified as Class 2L (lower flammability) in the ASHRAE flammability classification.
A burning velocity test was performed using the apparatus shown in FIG. 1 in the following manner. First, the mixed refrigerants used had a purity of 99.5% or more, and were degassed by repeating a cycle of freezing, pumping, and thawing until no traces of air were observed on the vacuum gauge. The burning velocity was measured by the closed method. The initial temperature was ambient temperature. Ignition was performed by generating an electric spark between the electrodes in the center of a sample cell. The duration of the discharge was 1.0 to 9.9 ms, and the ignition energy was typically about 0.1 to 1.0 J. The spread of the flame was visualized using schlieren photographs. A cylindrical container (inner diameter: 155 mm, length: 198 mm) equipped with two light transmission acrylic windows was used as the sample cell, and a xenon lamp was used as the light source. Schlieren images of the flame were recorded by a high-speed digital video camera at a frame rate of 600 fps and stored on a PC.
Tables 145 and 146 show the results.

TABLE 145

| Item | | Unit | I | J | K | L |
|---|---|---|---|---|---|---|
| WCF | HFO-1132(E) | mass % | 72.0 | 57.7 | 48.4 | 35.5 |
| | HFO-1123 | mass % | 28.0 | 32.8 | 33.2 | 27.5 |
| | R32 | mass % | 0.0 | 9.5 | 18.4 | 37.0 |

| | | | | | |
|---|---|---|---|---|---|
| Burning velocity (WCF) | cm/s | 10 | 10 | 10 | 10 |

TABLE 146

| Item | | Unit | M | N | T | P | U | Q |
|---|---|---|---|---|---|---|---|---|
| WCF | HFO-1132(E) | mass % | 47.1 | 38.5 | 34.8 | 31.8 | 28.7 | 28.6 |
| | HFO-1123 | mass % | 52.9 | 52.1 | 51.0 | 49.8 | 41.2 | 34.4 |
| | R32 | mass % | 0.0 | 9.5 | 14.2 | 18.4 | 30.1 | 37.0 |
| Leak condition that results in WCFF | | | Storage, | Storage, | Storage, | Storage, | Storage, | Storage, |
| | | | Shipping, −40° | Shipping, −40° | Shipping, −40° | Shipping, −40° | Shipping, −40° | Shipping, −40° |
| | | | C., 92%, | C., 92%, | C., 92%, | C., 92%, | C., 92%, | C., 92%, |
| | | | release, on | release, on | release, on | release, on | release, on | release, on |
| | | | the liquid | the liquid | the liquid | the liquid | the liquid | the liquid |
| | | | phase side | phase side | phase side | phase side | phase side | phase side |
| WCFF | HFO-1132(E) | mass % | 72.0 | 58.9 | 51.5 | 44.6 | 31.4 | 27.1 |
| | HFO-1123 | mass % | 28.0 | 32.4 | 33.1 | 32.6 | 23.2 | 18.3 |
| | R32 | mass % | 0.0 | 8.7 | 15.4 | 22.8 | 45.4 | 54.6 |

| | | | | | | | |
|---|---|---|---|---|---|---|---|
| Burning velocity (WCF) | cm/s | 8 or less | 8 or less | 8 or less | 8 or less | 8 or less | 8 or less |
| Burning velocity (WCFF) | cm/s | 10 | 10 | 10 | 10 | 10 | 10 |

The results in Table 1 indicate that in a ternary composition diagram of a mixed refrigerant of HFO-1132(E), HFO-1123, and R32 in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below line segments IK and KL that connect the following 3 points:
   point I (72.0, 28.0, 0.0),
   point K (48.4, 33.2, 18.4), and
   point L (35.5, 27.5, 37.0);
   the line segment IK is represented by coordinates
   (0.025z²−1.7429z+72.00, −0.025z²+0.7429z+28.00, z), and
   the line segment KL is represented by coordinates
   (0.0098z²−1.238z+67.852, −0.0098z²+0.238z+32.148, z),
   it can be determined that the refrigerant has WCF lower flammability.
For the points on the line segment IK, an approximate curve (x=0.025z²−1.7429z+72.00) was obtained from three points, i.e., I (72.0, 28.0, 0.0), J (57.7, 32.8, 9.5), and K (48.4, 33.2, 18.4) by using the least-square method to determine coordinates (x=0.025z²−1.7429z+72.00, y=100−z−x=−0.00922z²+0.2114z+32.443, z).
Likewise, for the points on the line segment KL, an approximate curve was determined from three points, i.e., K (48.4, 33.2, 18.4), Example 10 (41.1, 31.2, 27.7), and L (35.5, 27.5, 37.0) by using the least-square method to determine coordinates.
The results in Table 146 indicate that in a ternary composition diagram of a mixed refrigerant of HFO-1132(E), HFO-1123, and R32 in which their sum is 100 mass %, a line segment connecting a point (0.0, 100.0, 0.0) and a point (0.0, 0.0, 100.0) is the base, the point (0.0, 100.0, 0.0) is on the left side, and the point (0.0, 0.0, 100.0) is on the right side, when coordinates (x,y,z) are on or below line segments MP and PQ that connect the following 3 points:
   point M (47.1, 52.9, 0.0),
   point P (31.8, 49.8, 18.4), and
   point Q (28.6, 34.4, 37.0),
   it can be determined that the refrigerant has ASHRAE lower flammability.
In the above, the line segment MP is represented by coordinates (0.0083z²−0.984z+47.1, −0.0083z²−0.016z+52.9, z), and the line segment PQ is represented by coordinates
   (0.0135z²−0.9181z+44.133, −0.0135z²−0.0819z+55.867, z).
For the points on the line segment MP, an approximate curve was obtained from three points, i.e., points M, N, and P, by using the least-square method to determine coordinates. For the points on the line segment PQ, an approximate curve was obtained from three points, i.e., points P, U, and Q, by using the least-square method to determine coordinates.
The GWP of compositions each comprising a mixture of R410A (R32=50%/R125=50%) was evaluated based on the values stated in the Intergovernmental Panel on Climate Change (IPCC), fourth report. The GWP of HFO-1132(E), which was not stated therein, was assumed to be 1 from HFO-1132a (GWP=1 or less) and HFO-1123 (GWP=0.3, described in WO2015/141678). The refrigerating capacity of compositions each comprising R410A and a mixture of HFO-1132(E) and HFO-1123 was determined by performing theoretical refrigeration cycle calculations for the mixed refrigerants using the National Institute of Science and Technology (NIST) and Reference Fluid Thermodynamic and Transport Properties Database (Refprop 9.0) under the following conditions.
The COP ratio and the refrigerating capacity (which may be referred to as “cooling capacity” or “capacity”) ratio relative to those of R410 of the mixed refrigerants were determined. The conditions for calculation were as described below.
   Evaporating temperature: 5° C.
   Condensation temperature: 45° C.
   Degree of superheating: 5K
   Degree of subcooling: 5K
   Compressor efficiency: 70%
Tables 147 to 166 show these values together with the GWP of each mixed refrigerant.

TABLE 147

| | | | Comparative | Comparative | Comparative | Comparative | Comparative | Comparative |
|---|---|---|---|---|---|---|---|---|
| | | Comparative | Example 2 | Example 3 | Example 4 | Example 5 | Example 6 | Example 7 |
| Item | Unit | Example 1 | A | B | A′ | B′ | A″ | B″ |
| HFO-1132(E) | mass % | R410A | 90.5 | 0.0 | 81.6 | 0.0 | 63.0 | 0.0 |
| HFO-1123 | mass % | | 0.0 | 90.5 | 0.0 | 81.6 | 0.0 | 63.0 |
| R32 | mass % | | 9.5 | 9.5 | 18.4 | 18.4 | 37.0 | 37.0 |
| GWP | — | 2088 | 65 | 65 | 125 | 125 | 250 | 250 |
| COP ratio | % (relative | 100 | 99.1 | 92.0 | 98.7 | 93.4 | 98.7 | 96.1 |
| | to R410A) | | | | | | | |
| Refrigerating | % (relative | 100 | 102.2 | 111.6 | 105.3 | 113.7 | 110.0 | 115.4 |
| capacity ratio | to R410A) | | | | | | | |

TABLE 148

| | | Comparative | Comparative | | Example | | Comparative |
|---|---|---|---|---|---|---|---|
| | | Example 8 | Example 9 | Comparative | 1 | Example | Example 11 |
| Item | Unit | O | C | Example 10 | U | 2 | D |
| HFO-1132(E) | mass % | 100.0 | 50.0 | 41.1 | 28.7 | 15.2 | 0.0 |
| HFO-1123 | mass % | 0.0 | 31.6 | 34.6 | 41.2 | 52.7 | 67.0 |
| R32 | mass % | 0.0 | 18.4 | 24.3 | 30.1 | 32.1 | 33.0 |
| GWP | — | 1 | 125 | 165 | 204 | 217 | 228 |
| COP ratio | % (relative | 99.7 | 96.0 | 96.0 | 96.0 | 96.0 | 96.0 |
| | to R410A) | | | | | | |
| Refrigerating | % (relative | 98.3 | 109.9 | 111.7 | 113.5 | 114.8 | 115.4 |
| capacity ratio | to R410A) | | | | | | |

TABLE 149

| | | Comparative | | Example | Example | Comparative |
|---|---|---|---|---|---|---|
| | | Example 12 | Comparative | 3 | 4 | Example 14 |
| Item | Unit | E | Example 13 | T | S | F |
| HFO-1132(E) | mass % | 53.4 | 43.4 | 34.8 | 25.4 | 0.0 |
| HFO-1123 | mass % | 46.6 | 47.1 | 51.0 | 56.2 | 74.1 |
| R32 | mass % | 0.0 | 9.5 | 14.2 | 18.4 | 25.9 |
| GWP | — | 1 | 65 | 97 | 125 | 176 |
| COP ratio | % (relative | 94.5 | 94.5 | 94.5 | 94.5 | 94.5 |
| | to R410A) | | | | | |
| Refrigerating | % (relative | 105.6 | 109.2 | 110.8 | 112.3 | 114.8 |
| capacity ratio | to R410A) | | | | | |

TABLE 150

| | | Comparative | | | | Comparative |
|---|---|---|---|---|---|---|
| | | Example 15 | | Example 6 | | Example 16 |
| Item | Unit | G | Example 5 | R | Example 7 | H |
| HFO-1132(E) | mass % | 38.5 | 31.5 | 23.1 | 16.9 | 0.0 |
| HFO-1123 | mass % | 61.5 | 63.5 | 67.4 | 71.1 | 84.2 |
| R32 | mass % | 0.0 | 5.0 | 9.5 | 12.0 | 15.8 |
| GWP | — | 1 | 35 | 65 | 82 | 107 |
| COP ratio | % (relative to | 93.0 | 93.0 | 93.0 | 93.0 | 93.0 |
| | R410A) | | | | | |
| Refrigerating | % (relative to | 107.0 | 109.1 | 110.9 | 111.9 | 113.2 |
| capacity ratio | R410A) | | | | | |

TABLE 151

| | | Comparative | Example | Example | | Comparative |
|---|---|---|---|---|---|---|
| | | Example 17 | 8 | 9 | Comparative | Example 19 |
| Item | Unit | I | J | K | Example 18 | L |
| HFO-1132(E) | mass % | 72.0 | 57.7 | 48.4 | 41.1 | 35.5 |
| HFO-1123 | mass % | 28.0 | 32.8 | 33.2 | 31.2 | 27.5 |
| R32 | mass % | 0.0 | 9.5 | 18.4 | 27.7 | 37.0 |
| GWP | — | 1 | 65 | 125 | 188 | 250 |
| COP ratio | % (relative | 96.6 | 95.8 | 95.9 | 96.4 | 97.1 |
| | to R410A) | | | | | |
| Refrigerating | % (relative | 103.1 | 107.4 | 110.1 | 112.1 | 113.2 |
| capacity ratio | to R410A) | | | | | |

TABLE 152

| | | Comparative | Example | Example | Example |
|---|---|---|---|---|---|
| | | Example 20 | 10 | 11 | 12 |
| Item | Unit | M | N | P | Q |
| HFO-1132(E) | mass % | 47.1 | 38.5 | 31.8 | 28.6 |
| HFO-1123 | mass % | 52.9 | 52.1 | 49.8 | 34.4 |
| R32 | mass % | 0.0 | 9.5 | 18.4 | 37.0 |
| GWP | — | 1 | 65 | 125 | 250 |
| COP ratio | % (relative | 93.9 | 94.1 | 94.7 | 96.9 |
| | to R410A) | | | | |
| Refrigerating | % (relative | 106.2 | 109.7 | 112.0 | 114.1 |
| capacity ratio | to R410A) | | | | |

TABLE 153

| | | Comparative | Comparative | Comparative | Example | Example | Example | Comparative | Comparative |
|---|---|---|---|---|---|---|---|---|---|
| Item | Unit | Example 22 | Example 23 | Example 24 | 14 | 15 | 16 | Example 25 | Example 26 |
| HFO-1132(E) | mass % | 10.0 | 20.0 | 30.0 | 40.0 | 50.0 | 60.0 | 70.0 | 80.0 |
| HFO-1123 | mass % | 85.0 | 75.0 | 65.0 | 55.0 | 45.0 | 35.0 | 25.0 | 15.0 |
| R32 | mass % | 5.0 | 5.0 | 5.0 | 5.0 | 5.0 | 5.0 | 5.0 | 5.0 |
| GWP | — | 35 | 35 | 35 | 35 | 35 | 35 | 35 | 35 |
| COP ratio | % (relative | 91.7 | 92.2 | 92.9 | 93.7 | 94.6 | 95.6 | 96.7 | 97.7 |
| | to R410A) | | | | | | | | |
| Refrigerating | % (relative | 110.1 | 109.8 | 109.2 | 108.4 | 107.4 | 106.1 | 104.7 | 103.1 |
| capacity ratio | to R410A) | | | | | | | | |

TABLE 154

| | | Comparative | Comparative | Comparative | Example | Example | Example | Comparative | Comparative |
|---|---|---|---|---|---|---|---|---|---|
| Item | Unit | Example 27 | Example 28 | Example 29 | 17 | 18 | 19 | Example 30 | Example 31 |
| HFO-1132(E) | mass % | 90.0 | 10.0 | 20.0 | 30.0 | 40.0 | 50.0 | 60.0 | 70.0 |
| HFO-1123 | mass % | 5.0 | 80.0 | 70.0 | 60.0 | 50.0 | 40.0 | 30.0 | 20.0 |
| R32 | mass % | 5.0 | 10.0 | 10.0 | 10.0 | 10.0 | 10.0 | 10.0 | 10.0 |
| GWP | — | 35 | 68 | 68 | 68 | 68 | 68 | 68 | 68 |
| COP ratio | % (relative | 98.8 | 92.4 | 92.9 | 93.5 | 94.3 | 95.1 | 96.1 | 97.0 |
| | to R410A) | | | | | | | | |
| Refrigerating | % (relative | 101.4 | 111.7 | 111.3 | 110.6 | 109.6 | 108.5 | 107.2 | 105.7 |
| capacity ratio | to R410A) | | | | | | | | |

TABLE 155

| | | Comparative | Example | Example | Example | Example | Example | Comparative | Comparative |
|---|---|---|---|---|---|---|---|---|---|
| Item | Unit | Example 32 | 20 | 21 | 22 | 23 | 24 | Example 33 | Example 34 |
| HFO-1132(E) | mass % | 80.0 | 10.0 | 20.0 | 30.0 | 40.0 | 50.0 | 60.0 | 70.0 |
| HFO-1123 | mass % | 10.0 | 75.0 | 65.0 | 55.0 | 45.0 | 35.0 | 25.0 | 15.0 |
| R32 | mass % | 10.0 | 15.0 | 15.0 | 15.0 | 15.0 | 15.0 | 15.0 | 15.0 |
| GWP | — | 68 | 102 | 102 | 102 | 102 | 102 | 102 | 102 |
| COP ratio | % (relative | 98.0 | 93.1 | 93.6 | 94.2 | 94.9 | 95.6 | 96.5 | 97.4 |
| | to R410A) | | | | | | | | |
| Refrigerating | % (relative | 104.1 | 112.9 | 112.4 | 111.6 | 110.6 | 109.4 | 108.1 | 106.6 |
| capacity ratio | to R410A) | | | | | | | | |

TABLE 156

| | | Comparative | Comparative | Comparative | Comparative | Comparative | Comparative | Comparative | Comparative |
|---|---|---|---|---|---|---|---|---|---|
| Item | Unit | Example 35 | Example 36 | Example 37 | Example 38 | Example 39 | Example 40 | Example 41 | Example 42 |
| HFO-1132(E) | mass % | 80.0 | 10.0 | 20.0 | 30.0 | 40.0 | 50.0 | 60.0 | 70.0 |
| HFO-1123 | mass % | 5.0 | 70.0 | 60.0 | 50.0 | 40.0 | 30.0 | 20.0 | 10.0 |
| R32 | mass % | 15.0 | 20.0 | 20.0 | 20.0 | 20.0 | 20.0 | 20.0 | 20.0 |
| GWP | — | 102 | 136 | 136 | 136 | 136 | 136 | 136 | 136 |
| COP ratio | % (relative | 98.3 | 93.9 | 94.3 | 94.8 | 95.4 | 96.2 | 97.0 | 97.8 |
| | to R410A) | | | | | | | | |
| Refrigerating | % (relative | 105.0 | 113.8 | 113.2 | 112.4 | 111.4 | 110.2 | 108.8 | 107.3 |
| capacity ratio | to R410A) | | | | | | | | |

TABLE 157

| | | Comparative | Comparative | Comparative | Comparative | Comparative | Comparative | Comparative | Comparative |
|---|---|---|---|---|---|---|---|---|---|
| Item | Unit | Example 43 | Example 44 | Example 45 | Example 46 | Example 47 | Example 48 | Example 49 | Example 50 |
| HFO-1132(E) | mass % | 10.0 | 20.0 | 30.0 | 40.0 | 50.0 | 60.0 | 70.0 | 10.0 |
| HFO-1123 | mass % | 65.0 | 55.0 | 45.0 | 35.0 | 25.0 | 15.0 | 5.0 | 60.0 |
| R32 | mass % | 25.0 | 25.0 | 25.0 | 25.0 | 25.0 | 25.0 | 25.0 | 30.0 |
| GWP | — | 170 | 170 | 170 | 170 | 170 | 170 | 170 | 203 |
| COP ratio | % (relative | 94.6 | 94.9 | 95.4 | 96.0 | 96.7 | 97.4 | 98.2 | 95.3 |
| | to R410A) | | | | | | | | |
| Refrigerating | % (relative | 114.4 | 113.8 | 113.0 | 111.9 | 110.7 | 109.4 | 107.9 | 114.8 |
| capacity ratio | to R410A) | | | | | | | | |

TABLE 158

| | | Comparative | Comparative | Comparative | Comparative | Comparative | Example | Example | Comparative |
|---|---|---|---|---|---|---|---|---|---|
| Item | Unit | Example 51 | Example 52 | Example 53 | Example 54 | Example 55 | 25 | 26 | Example 56 |
| HFO-1132(E) | mass % | 20.0 | 30.0 | 40.0 | 50.0 | 60.0 | 10.0 | 20.0 | 30.0 |
| HFO-1123 | mass % | 50.0 | 40.0 | 30.0 | 20.0 | 10.0 | 55.0 | 45.0 | 35.0 |
| R32 | mass % | 30.0 | 30.0 | 30.0 | 30.0 | 30.0 | 35.0 | 35.0 | 35.0 |
| GWP | — | 203 | 203 | 203 | 203 | 203 | 237 | 237 | 237 |
| COP ratio | % (relative | 95.6 | 96.0 | 96.6 | 97.2 | 97.9 | 96.0 | 96.3 | 96.6 |
| | to R410A) | | | | | | | | |
| Refrigerating | % (relative | 114.2 | 113.4 | 112.4 | 111.2 | 109.8 | 115.1 | 114.5 | 113.6 |
| capacity ratio | to R410A) | | | | | | | | |

TABLE 159

| | | Comparative | Comparative | Comparative | Comparative | Comparative | Comparative | Comparative | Comparative |
|---|---|---|---|---|---|---|---|---|---|
| Item | Unit | Example 57 | Example 58 | Example 59 | Example 60 | Example 61 | Example 62 | Example 63 | Example 64 |
| HFO-1132(E) | mass % | 40.0 | 50.0 | 60.0 | 10.0 | 20.0 | 30.0 | 40.0 | 50.0 |
| HFO-1123 | mass % | 25.0 | 15.0 | 5.0 | 50.0 | 40.0 | 30.0 | 20.0 | 10.0 |
| R32 | mass % | 35.0 | 35.0 | 35.0 | 40.0 | 40.0 | 40.0 | 40.0 | 40.0 |
| GWP | — | 237 | 237 | 237 | 271 | 271 | 271 | 271 | 271 |
| COP ratio | % (relative | 97.1 | 97.7 | 98.3 | 96.6 | 96.9 | 97.2 | 97.7 | 98.2 |
| | to R410A) | | | | | | | | |
| Refrigerating | % (relative | 112.6 | 111.5 | 110.2 | 115.1 | 114.6 | 113.8 | 112.8 | 111.7 |
| capacity ratio | to R410A) | | | | | | | | |

TABLE 160

| | | Example | Example | Example | Example | Example | Example | Example | Example |
|---|---|---|---|---|---|---|---|---|---|
| Item | Unit | 27 | 28 | 29 | 30 | 31 | 32 | 33 | 34 |
| HFO-1132(E) | mass % | 38.0 | 40.0 | 42.0 | 44.0 | 35.0 | 37.0 | 39.0 | 41.0 |
| HFO-1123 | mass % | 60.0 | 58.0 | 56.0 | 54.0 | 61.0 | 59.0 | 57.0 | 55.0 |
| R32 | mass % | 2.0 | 2.0 | 2.0 | 2.0 | 4.0 | 4.0 | 4.0 | 4.0 |
| GWP | — | 14 | 14 | 14 | 14 | 28 | 28 | 28 | 28 |
| COP ratio | % (relative | 93.2 | 93.4 | 93.6 | 93.7 | 93.2 | 93.3 | 93.5 | 93.7 |
| | to R410A) | | | | | | | | |
| Refrigerating | % (relative | 107.7 | 107.5 | 107.3 | 107.2 | 108.6 | 108.4 | 108.2 | 108.0 |
| capacity ratio | to R410A) | | | | | | | | |

TABLE 161

| | | Example | Example | Example | Example | Example | Example | Example | Example |
|---|---|---|---|---|---|---|---|---|---|
| Item | Unit | 35 | 36 | 37 | 38 | 39 | 40 | 41 | 42 |
| HFO-1132(E) | mass % | 43.0 | 31.0 | 33.0 | 35.0 | 37.0 | 39.0 | 41.0 | 27.0 |
| HFO-1123 | mass % | 53.0 | 63.0 | 61.0 | 59.0 | 57.0 | 55.0 | 53.0 | 65.0 |
| R32 | mass % | 4.0 | 6.0 | 6.0 | 6.0 | 6.0 | 6.0 | 6.0 | 8.0 |
| GWP | — | 28 | 41 | 41 | 41 | 41 | 41 | 41 | 55 |
| COP ratio | % (relative | 93.9 | 93.1 | 93.2 | 93.4 | 93.6 | 93.7 | 93.9 | 93.0 |
| | to R410A) | | | | | | | | |
| Refrigerating | % (relative | 107.8 | 109.5 | 109.3 | 109.1 | 109.0 | 108.8 | 108.6 | 110.3 |
| capacity ratio | to R410A) | | | | | | | | |

TABLE 162

| | | Example | Example | Example | Example | Example | Example | Example | Example |
|---|---|---|---|---|---|---|---|---|---|
| Item | Unit | 43 | 44 | 45 | 46 | 47 | 48 | 49 | 50 |
| HFO-1132(E) | mass % | 29.0 | 31.0 | 33.0 | 35.0 | 37.0 | 39.0 | 32.0 | 32.0 |
| HFO-1123 | mass % | 63.0 | 61.0 | 59.0 | 57.0 | 55.0 | 53.0 | 51.0 | 50.0 |
| R32 | mass % | 8.0 | 8.0 | 8.0 | 8.0 | 8.0 | 8.0 | 17.0 | 18.0 |
| GWP | — | 55 | 55 | 55 | 55 | 55 | 55 | 116 | 122 |
| COP ratio | % (relative | 93.2 | 93.3 | 93.5 | 93.6 | 93.8 | 94.0 | 94.5 | 94.7 |
| | to R410A) | | | | | | | | |
| Refrigerating | % (relative | 110.1 | 110.0 | 109.8 | 109.6 | 109.5 | 109.3 | 111.8 | 111.9 |
| capacity ratio | to R410A) | | | | | | | | |

TABLE 163

| | | Example | Example | Example | Example | Example | Example | Example | Example |
|---|---|---|---|---|---|---|---|---|---|
| Item | Unit | 51 | 52 | 53 | 54 | 55 | 56 | 57 | 58 |
| HFO-1132(E) | mass % | 30.0 | 27.0 | 21.0 | 23.0 | 25.0 | 27.0 | 11.0 | 13.0 |
| HFO-1123 | mass % | 52.0 | 42.0 | 46.0 | 44.0 | 42.0 | 40.0 | 54.0 | 52.0 |
| R32 | mass % | 18.0 | 31.0 | 33.0 | 33.0 | 33.0 | 33.0 | 35.0 | 35.0 |
| GWP | — | 122 | 210 | 223 | 223 | 223 | 223 | 237 | 237 |
| COP ratio | % (relative | 94.5 | 96.0 | 96.0 | 96.1 | 96.2 | 96.3 | 96.0 | 96.0 |
| | to R410A) | | | | | | | | |
| Refrigerating | % (relative | 112.1 | 113.7 | 114.3 | 114.2 | 114.0 | 113.8 | 115.0 | 114.9 |
| capacity ratio | to R410A) | | | | | | | | |

TABLE 164

| | | Example | Example | Example | Example | Example | Example | Example | Example |
|---|---|---|---|---|---|---|---|---|---|
| Item | Unit | 59 | 60 | 61 | 62 | 63 | 64 | 65 | 66 |
| HFO-1132(E) | mass % | 15.0 | 17.0 | 19.0 | 21.0 | 23.0 | 25.0 | 27.0 | 11.0 |
| HFO-1123 | mass % | 50.0 | 48.0 | 46.0 | 44.0 | 42.0 | 40.0 | 38.0 | 52.0 |
| R32 | mass % | 35.0 | 35.0 | 35.0 | 35.0 | 35.0 | 35.0 | 35.0 | 37.0 |
| GWP | — | 237 | 237 | 237 | 237 | 237 | 237 | 237 | 250 |
| COP ratio | % (relative | 96.1 | 96.2 | 96.2 | 96.3 | 96.4 | 96.4 | 96.5 | 96.2 |
| | to R410A) | | | | | | | | |
| Refrigerating | % (relative | 114.8 | 114.7 | 114.5 | 114.4 | 114.2 | 114.1 | 113.9 | 115.1 |
| capacity ratio | to R410A) | | | | | | | | |

TABLE 165

| | | Example | Example | Example | Example | Example | Example | Example | Example |
|---|---|---|---|---|---|---|---|---|---|
| Item | Unit | 67 | 68 | 69 | 70 | 71 | 72 | 73 | 74 |
| HFO-1132(E) | mass % | 13.0 | 15.0 | 17.0 | 15.0 | 17.0 | 19.0 | 21.0 | 23.0 |
| HFO-1123 | mass % | 50.0 | 48.0 | 46.0 | 50.0 | 48.0 | 46.0 | 44.0 | 42.0 |
| R32 | mass % | 37.0 | 37.0 | 37.0 | 0.0 | 0.0 | 0.0 | 0.0 | 0.0 |
| GWP | — | 250 | 250 | 250 | 237 | 237 | 237 | 237 | 237 |
| COP ratio | % (relative | 96.3 | 96.4 | 96.4 | 96.1 | 96.2 | 96.2 | 96.3 | 96.4 |
| | to R410A) | | | | | | | | |
| Refrigerating | % (relative | 115.0 | 114.9 | 114.7 | 114.8 | 114.7 | 114.5 | 114.4 | 114.2 |
| capacity ratio | to R410A) | | | | | | | | |

TABLE 166

| | | Example | Example | Example | Example | Example | Example | Example | Example |
|---|---|---|---|---|---|---|---|---|---|
| Item | Unit | 75 | 76 | 77 | 78 | 79 | 80 | 81 | 82 |
| HFO-1132(E) | mass % | 25.0 | 27.0 | 11.0 | 19.0 | 21.0 | 23.0 | 25.0 | 27.0 |
| HFO-1123 | mass % | 40.0 | 38.0 | 52.0 | 44.0 | 42.0 | 40.0 | 38.0 | 36.0 |
| R32 | mass % | 0.0 | 0.0 | 0.0 | 37.0 | 37.0 | 37.0 | 37.0 | 37.0 |
| GWP | — | 237 | 237 | 250 | 250 | 250 | 250 | 250 | 250 |
| COP ratio | % (relative | 96.4 | 96.5 | 96.2 | 96.5 | 96.5 | 96.6 | 96.7 | 96.8 |
| | to R410A) | | | | | | | | |
| Refrigerating | % (relative | 114.1 | 113.9 | 115.1 | 114.6 | 114.5 | 114.3 | 114.1 | 114.0 |
| capacity ratio | to R410A) | | | | | | | | |

The above results indicate that under the condition that the mass % of HFO-1132(E), HFO-1123, and R32 based on their sum is respectively represented by x, y, and z, when coordinates (x,y,z) in a ternary composition diagram in which the sum of HFO-1132(E), HFO-1123, and R32 is 100 mass %, a line segment connecting a point (0.0, 100.0, 0.0) and a point (0.0, 0.0, 100.0) is the base, and the point (0.0, 100.0, 0.0) is on the left side are within the range of a figure surrounded by line segments that connect the following 4 points:
   point O (100.0, 0.0, 0.0),
   point A″ (63.0, 0.0, 37.0),
   point B″ (0.0, 63.0, 37.0), and
   point (0.0, 100.0, 0.0),
   or on these line segments,
   the refrigerant has a GWP of 250 or less.
The results also indicate that when coordinates (x,y,z) are within the range of a figure surrounded by line segments that connect the following 4 points:
   point O (100.0, 0.0, 0.0),
   point A′ (81.6, 0.0, 18.4),
   point B′ (0.0, 81.6, 18.4), and
   point (0.0, 100.0, 0.0),
   or on these line segments,
   the refrigerant has a GWP of 125 or less.
The results also indicate that when coordinates (x,y,z) are within the range of a figure surrounded by line segments that connect the following 4 points:
   point O (100.0, 0.0, 0.0),
   point A (90.5, 0.0, 9.5),
   point B (0.0, 90.5, 9.5), and
   point (0.0, 100.0, 0.0),
   or on these line segments,
   the refrigerant has a GWP of 65 or less.
The results also indicate that when coordinates (x,y,z) are on the left side of line segments that connect the following 3 points:
   point C (50.0, 31.6, 18.4),
   point U (28.7, 41.2, 30.1), and
   point D (52.2, 38.3, 9.5),
   or on these line segments,
   the refrigerant has a COP ratio of 96% or more relative to that of R410A.
In the above, the line segment CU is represented by coordinates (−0.0538z²+0.7888z+53.701, 0.0538z²−1.7888z+46.299, z), and the line segment UD is represented by coordinates
   (−3.4962z²+210.71z−3146.1, 3.4962z²−211.71z+3246.1, z).
The points on the line segment CU are determined from three points, i.e., point C, Comparative Example 10, and point U, by using the least-square method.
The points on the line segment UD are determined from three points, i.e., point U, Example 2, and point D, by using the least-square method.
The results also indicate that when coordinates (x,y,z) are on the left side of line segments that connect the following 3 points:
   point E (55.2, 44.8, 0.0),
   point T (34.8, 51.0, 14.2), and
   point F (0.0, 76.7, 23.3),
   or on these line segments,
   the refrigerant has a COP ratio of 94.5% or more relative to that of R410A.

In the above, the line segment ET is represented by coordinates (−0.0547z²−0.5327z+53.4, 0.0547z²−0.4673z+46.6, z), and the line segment TF is represented by coordinates

(−0.0982z²+0.9622z+40.931, 0.0982z²−1.9622z+59.069, z).
The points on the line segment ET are determined from three points, i.e., point E, Example 2, and point T, by using the least-square method.
The points on the line segment TF are determined from three points, i.e., points T, S, and F, by using the least-square method.
The results also indicate that when coordinates (x,y,z) are on the left side of line segments that connect the following 3 points:
   point G (0.0, 76.7, 23.3),
   point R (21.0, 69.5, 9.5), and
   point H (0.0, 85.9, 14.1),
   or on these line segments,
   the refrigerant has a COP ratio of 93% or more relative to that of R410A.
In the above, the line segment GR is represented by coordinates (−0.0491z²−1.1544z+38.5, 0.0491z²+0.1544z+61.5, z), and the line segment RH is represented by coordinates
   (−0.3123z²+4.234z+11.06, 0.3123z²−5.234z+88.94, z).
The points on the line segment GR are determined from three points, i.e., point G, Example 5, and point R, by using the least-square method.
The points on the line segment RH are determined from three points, i.e., point R, Example 7, and point H, by using the least-square method.
In contrast, as shown in, for example, Comparative Examples 8, 9, 13, 15, 17, and 18, when R32 is not contained, the concentrations of HFO-1132(E) and HFO-1123, which have a double bond, become relatively high; this undesirably leads to deterioration, such as decomposition, or polymerization in the refrigerant compound.

### (6) Specific Embodiment

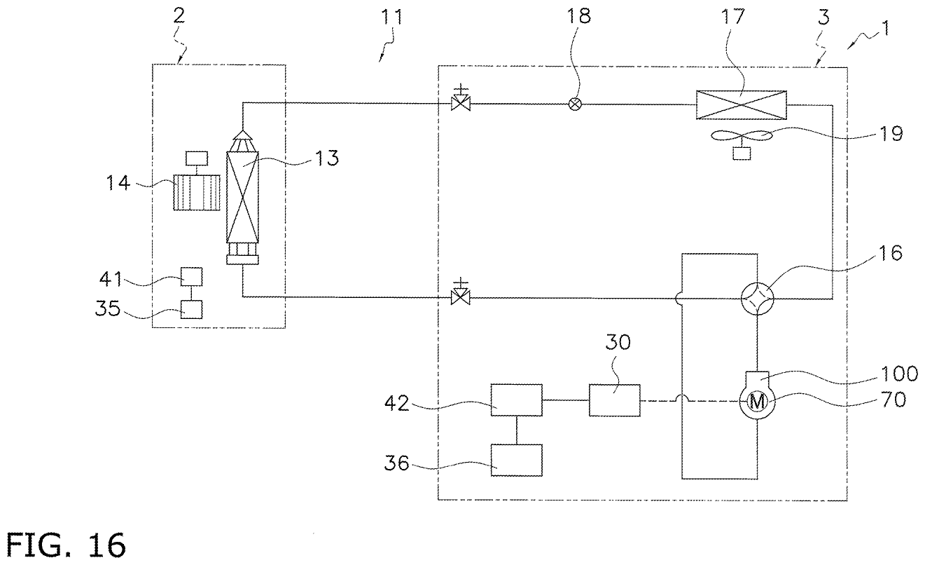

FIG. 16 is a configuration diagram of an air conditioner 1 according to a first embodiment of the present disclosure. In FIG. 16, the air conditioner 1 is constituted by a utilization unit 2 and a heat source unit 3.

### (6-1) Configuration of Air Conditioner 1

The air conditioner 1 has a refrigerant circuit 11 in which a compressor 100, a four-way switching valve 16, a heat-source-side heat exchanger 17, an expansion valve 18 serving as a decompression mechanism, and a utilization-side heat exchanger 13 are connected in a loop shape by refrigerant pipes.

In this embodiment, the refrigerant circuit 11 is filled with refrigerant for performing a vapor compression refrigeration cycle. The refrigerant is a refrigerant mixture containing 1,2-difluoroethylene, and any one of the above-described refrigerant A to refrigerant E can be used. The refrigerant circuit 11 is filled with refrigerating machine oil together with the refrigerant mixture.

### (6-1-1) Utilization Unit 2

In the refrigerant circuit 11, the utilization-side heat exchanger 13 belongs to the utilization unit 2. In addition, a utilization-side fan 14 is mounted in the utilization unit 2. The utilization-side fan 14 generates an air flow to the utilization-side heat exchanger 13.

A utilization-side communicator 35 and a utilization-side microcomputer 41 are mounted in the utilization unit 2. The utilization-side communicator 35 is connected to the utilization-side microcomputer 41.

The utilization-side communicator 35 is used by the utilization unit 2 to communicate with the heat source unit 3. The utilization-side microcomputer 41 is supplied with a control voltage even during a standby state in which the air conditioner 1 is not operating. Thus, the utilization-side microcomputer 41 is constantly activated.

### (6-1-2) Heat Source Unit 3

In the refrigerant circuit 11, the compressor 100, the four-way switching valve 16, the heat-source-side heat exchanger 17, and the expansion valve 18 belong to the heat source unit 3. In addition, a heat-source-side fan 19 is mounted in the heat source unit 3. The heat-source-side fan 19 generates an air flow to the heat-source-side heat exchanger 17.

In addition, a connection unit 30, a heat-source-side communicator 36, and a heat-source-side microcomputer 42 are mounted in the heat source unit 3. The connection unit 30 and the heat-source-side communicator 36 are connected to the heat-source-side microcomputer 42.

(6-2) Configuration of connection unit 30

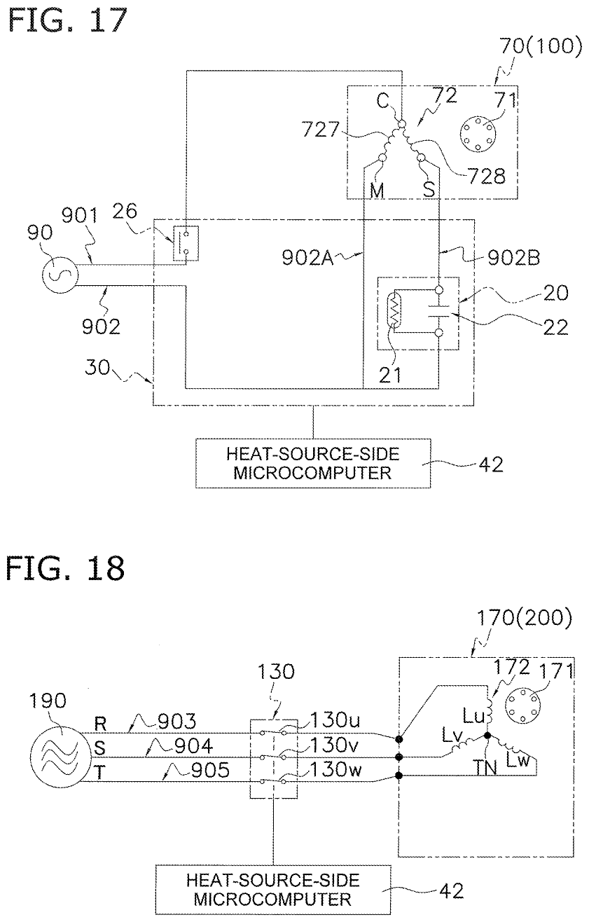

FIG. 17 is an operation circuit diagram of a motor 70 of the compressor 100. In FIG. 17, the connection unit 30 is a circuit that causes power to be supplied from an alternating-current (AC) power source 90 to the motor 70 of the compressor 100 without frequency conversion.

The motor 70 is an induction motor and includes a squirrel-cage rotor 71, and a stator 72 having a main winding 727 and an auxiliary winding 728. The squirrel-cage rotor 71 rotates following a rotating magnetic field generated by the stator 72.

The compressor 100 has an M terminal, an S terminal, and a C terminal. The M terminal and the C terminal are connected by the main winding 727. The S terminal and the C terminal are connected by the auxiliary winding 728.

The AC power source 90 and the compressor 100 are connected by power supply lines 901 and 902 that supply an AC voltage to the compressor 100. The power supply line 901 is connected to the C terminal via a thermostat 26.

The thermostat 26 detects a temperature of a room equipped with the air conditioner 1. The thermostat 26 opens the contact thereof when the room temperature is within a set temperature range and closes the contact when the room temperature is out of the set temperature range.

The power supply line 902 branches off into a first branch line 902A and a second branch line 902B. The first branch line 902A is connected to the M terminal, and the second branch line 902B is connected to the S terminal via an activation circuit 20.

The activation circuit 20 is a circuit in which a positive temperature coefficient (PTC) thermistor 21 and an operation capacitor 22 are connected in parallel to each other.

In this embodiment, the thermostat 26 connected to the power supply line 901 and the activation circuit 20 connected to the power supply line 902 are referred to as the connection unit 30.

### (6-3) Operation

In the operation circuit of the compressor 100 having the above-described configuration, turning on of the AC power source 90 causes a current to flow through the auxiliary winding 728 via the PTC thermistor 21 and the motor 70 to be activated.

After the motor 70 has been activated, the PTC thermistor 21 self-heats by using the current flowing therethrough, and the resistance value thereof increases. As a result, the operation capacitor 22, instead of the PTC thermistor 21, is connected to the auxiliary winding 728, and the state shifts to a stable operation state.

### (6-4) Features

(6-4-1)

In the air conditioner 1 that uses a refrigerant mixture containing at least 1,2-difluoroethylene, the compressor 100 can be driven without interposing a power conversion device between the AC power source 90 and the motor 70. Thus, it is possible to provide the air conditioner 1 that is environmentally friendly and has a relatively inexpensive configuration.

(6-4-2)

In the air conditioner 1 that uses a refrigerant mixture containing at least 1,2-difluoroethylene, the connection between the auxiliary winding 728 and the activation circuit 20, which is a parallel circuit of the PTC thermistor 21 and the operation capacitor 22, makes it possible to achieve a large activation torque of the motor 70 of the compressor 100.

After the compressor 100 has been activated, the PTC thermistor 21 self-heats and the resistance value thereof increases, the state changes to a state where the operation capacitor 22 and the auxiliary winding 728 are substantially connected to each other, and the compressor 100 is operated at a constant rotation rate (power source frequency). Thus, the compressor 100 enters a state of being capable of outputting a rated torque. As described above, in the air conditioner 1, switching of connection to the operation capacitor 22 is performed at appropriate timing, and thus the efficiency of the compressor 100 can be increased.

(6-4-3)

The motor 70 is an induction motor and is capable of high output with relatively low cost, and thus the efficiency of the air conditioner 1 can be increased.

### (6-5) Modification Example

FIG. 18 is an operation circuit diagram of a motor 170 of a compressor 200 in the air conditioner 1 according to a modification example. In FIG. 18, the motor 170 is a three-phase induction motor and is connected to a three-phase AC power source 190 via a connection unit 130.

The connection unit 130 is a relay having contacts 130u, 130v, and 130w. The contact 130u opens or closes a power supply line 903 between an R terminal of the three-phase AC power source 190 and a U-phase winding Lu of the motor 170. The contact 130v opens or closes a power supply line 904 between an S terminal of the three-phase AC power source 190 and a V-phase winding Lv of the motor 170. The contact 130w opens or closes a power supply line 905 between a T terminal of the three-phase AC power source 190 and a W-phase winding Lw of the motor 170.

AC voltages are supplied from the R terminal, the S terminal, and the T terminal of the three-phase AC power source 190 to the corresponding U-phase winding Lu, the V-phase winding Lv, and the W-phase winding Lw of the motor 170. The AC voltage supplied to the V-phase winding Lv of the motor 170 has a phase difference of 120 degrees with respect to the AC voltage supplied to the U-phase winding Lu. Also, the AC voltage supplied to the W-phase winding Lw of the motor 170 has a phase difference of 120 degrees with respect to the AC voltage supplied to the V-phase winding Lv.

Thus, only the supply of AC voltages from the three-phase AC power source 190 to the motor 170 causes a rotating magnetic field to be generated in the stator 172, and the rotor 171 rotates following the rotating magnetic field. As a result, the compressor 200 is operated at a constant rotation rate (power source frequency). Thus, the operation circuit of the motor 170 does not require the activation circuit 20 according to the foregoing embodiment, and only a relay circuit of the connection unit 130 is used.

### (6-6) Features of Modification Example

(6-6-1)

In the air conditioner 1 that uses a refrigerant mixture containing at least 1,2-difluoroethylene, the compressor 200 can be driven without interposing a power conversion device between the three-phase AC power source 190 and the motor 170. Thus, it is possible to provide the air conditioner 1 that is environmentally friendly and has a relatively inexpensive configuration.

(6-6-2)

The motor 170 is an induction motor and is capable of high output with relatively low cost, and thus the efficiency of the air conditioner 1 can be increased.

An embodiment of the present disclosure has been described above. It is to be understood that various changes of the embodiment and details are possible without deviating from the gist and scope of the present disclosure described in the claims.

### REFERENCE SIGNS LIST

1: air conditioner
20: activation circuit
21: positive temperature coefficient thermistor
22: operation capacitor
30: connection unit
70: motor
90: single-phase AC power source
100: compressor
130: connection unit
170: motor
190: three-phase AC power source
200: compressor

### CITATION LIST

### Patent Literature

PTL 1: Japanese Unexamined Patent Application Publication No. 2013-124848

1. An air conditioner comprising:
a compressor that compresses a refrigerant containing at least 1,2-difluoroethylene;
a motor that drives the compressor; and
a connection unit that causes power to be supplied from an alternating-current (AC) power source to the motor without frequency conversion.

2. The air conditioner according to claim 1, wherein the connection unit directly applies an AC voltage of the AC power source between at least two terminals of the motor.

3. The air conditioner according to claim 1, wherein the AC power source is a single-phase power source.

4. The air conditioner according to claim 1, wherein one terminal of the motor is connected in series to an activation circuit.

5. The air conditioner according to claim 4, wherein the activation circuit is a circuit in which a positive temperature coefficient thermistor and an operation capacitor are connected in parallel to each other.

6. The air conditioner according to claim 1, wherein the AC power source is a three-phase power source.

7. The air conditioner according to claim 1, wherein the motor is an induction motor.

8. The air conditioner according to claim 1,
wherein
the refrigerant comprises trans-1,2-difluoroethylene (HFO-1132(E)), trifluoroethylene (HFO-1123), and 2,3,3,3-tetrafluoro-1-propene (R1234yf).

9. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments AA′, A′B, BD, DC′, C′C, CO, and OA that connect the following 7 points:
point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0),
point C (32.9, 67.1, 0.0), and
point O (100.0, 0.0, 0.0),
or on the above line segments (excluding the points on the line segments BD, CO, and OA);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments BD, CO, and OA are straight lines.

10. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments GI, IA, AA′, A′B, BD, DC′, C′C, and CG that connect the following 8 points:
point G (72.0, 28.0, 0.0),
point I (72.0, 0.0, 28.0),
point A (68.6, 0.0, 31.4),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments IA, BD, and CG);
the line segment AA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments GI, IA, BD, and CG are straight lines.

11. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PN, NK, KA′, A′B, BD, DC′, C′C, and CJ that connect the following 9 points:
point J (47.1, 52.9, 0.0),
point P (55.8, 42.0, 2.2),
point N (68.6, 16.3, 15.1),
point K (61.3, 5.4, 33.3),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments BD and CJ);
the line segment PN is represented by coordinates (x, −0.1135x²+12.112x−280.43, 0.1135x²−13.112x+380.43),
the line segment NK is represented by coordinates (x, 0.2421x²−29.955x+931.91, −0.2421x²+28.955x−831.91),
the line segment KA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, BD, and CG are straight lines.

12. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments JP, PL, LM, MA′, A′B, BD, DC′, C′C, and CJ that connect the following 9 points:
point J (47.1, 52.9, 0.0),
point P (55.8, 42.0, 2.2),
point L (63.1, 31.9, 5.0),
point M (60.3, 6.2, 33.5),
point A′ (30.6, 30.0, 39.4),
point B (0.0, 58.7, 41.3),
point D (0.0, 80.4, 19.6),
point C′ (19.5, 70.5, 10.0), and
point C (32.9, 67.1, 0.0),
or on the above line segments (excluding the points on the line segments BD and CJ);
the line segment PL is represented by coordinates (x, −0.1135x²+12.112x−280.43, 0.1135x²−13.112x+380.43)
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment DC′ is represented by coordinates (x, 0.0082x²−0.6671x+80.4, −0.0082x²−0.3329x+19.6),
the line segment C′C is represented by coordinates (x, 0.0067x²−0.6034x+79.729, −0.0067x²−0.3966x+20.271), and
the line segments JP, LM, BD, and CG are straight lines.

13. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LM, MA′, A′B, BF, FT, and TP that connect the following 7 points:
point P (55.8, 42.0, 2.2),
point L (63.1, 31.9, 5.0),
point M (60.3, 6.2, 33.5),
point A′ (30.6, 30.0, 39.4),
point B (0.0, 58.7, 41.3),
point F (0.0, 61.8, 38.2), and
point T (35.8, 44.9, 19.3),
or on the above line segments (excluding the points on the line segment BF);
the line segment PL is represented by coordinates (x, −0.1135x²+12.112x−280.43, 0.1135x²−13.112x+380.43),
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TP is represented by coordinates (x, 0.00672x²−0.7607x+63.525, −0.00672x²−0.2393x+36.475), and
the line segments LM and BF are straight lines.

14. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments PL, LQ, QR, and RP that connect the following 4 points:
point P (55.8, 42.0, 2.2),
point L (63.1, 31.9, 5.0),
point Q (62.8, 29.6, 7.6), and
point R (49.8, 42.3, 7.9),
or on the above line segments;
the line segment PL is represented by coordinates (x, −0.1135x²+12.112x−280.43, 0.1135x²−13.112x+380.43),
the line segment RP is represented by coordinates (x, 0.00672x²−0.7607x+63.525, −0.00672x²−0.2393x+36.475), and
the line segments LQ and QR are straight lines.

15. The air conditioner according to claim 8,
wherein
when the mass % of HFO-1132(E), HFO-1123, and R1234yf based on their sum in the refrigerant is respectively represented by x, y, and z, coordinates (x,y,z) in a ternary composition diagram in which the sum of HFO-1132(E), HFO-1123, and R1234yf is 100 mass % are within the range of a figure surrounded by line segments SM, MA′, A′B, BF, FT, and TS that connect the following 6 points:
point S (62.6, 28.3, 9.1),
point M (60.3, 6.2, 33.5),
point A′ (30.6, 30.0, 39.4),
point B (0.0, 58.7, 41.3),
point F (0.0, 61.8, 38.2), and
point T (35.8, 44.9, 19.3),
or on the above line segments,
the line segment MA′ is represented by coordinates (x, 0.0016x²−0.9473x+57.497, −0.0016x²−0.0527x+42.503),
the line segment A′B is represented by coordinates (x, 0.0029x²−1.0268x+58.7, −0.0029x²+0.0268x+41.3),
the line segment FT is represented by coordinates (x, 0.0078x²−0.7501x+61.8, −0.0078x²−0.2499x+38.2),
the line segment TS is represented by coordinates (x, −0.0017x²−0.7869x+70.888, −0.0017x²−0.2131x+29.112), and
the line segments SM and BF are straight lines.

16. The air conditioner according to claim 1,
wherein
the refrigerant comprises trans-1,2-difluoroethylene (HFO-1132(E)) and trifluoroethylene (HFO-1123) in a total amount of 99.5 mass % or more based on the entire refrigerant, and
the refrigerant comprises 62.0 mass % to 72.0 mass % of HFO-1132(E) based on the entire refrigerant.

17. The air conditioner according to claim 1,
wherein
the refrigerant comprises trans-1,2-difluoroethylene (HFO-1132(E)) and trifluoroethylene (HFO-1123) HFO 1132(E) and HFO 1123 in a total amount of 99.5 mass % or more based on the entire refrigerant, and
the refrigerant comprises 45.1 mass % to 47.1 mass % of HFO-1132(E) based on the entire refrigerant.

18. The air conditioner according to claim 1,
wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines GI, IA, AB, BD′, D′C, and CG that connect the following 6 points:
point G (0.026a²−1.7478a+72.0, −0.026a²+0.7478a+28.0, 0.0),
point I (0.026a²−1.7478a+72.0, 0.0, −0.026a²+0.7478a+28.0),
point A (0.0134a²−1.9681a+68.6, 0.0, −0.0134a²+0.9681a+31.4),
point B (0.0, 0.0144a²−1.6377a+58.7, −0.0144a²+0.6377a+41.3),
point D′ (0.0, 0.0224a²+0.968a+75.4, −0.0224a²−1.968a+24.6), and
point C (−0.2304a²−0.4062a+32.9, 0.2304a²−0.5938a+67.1, 0.0),
or on the straight lines GI, AB, and D′C (excluding point G, point I, point A, point B, point D′, and point C);
if 11.1<a≤18.2, coordinates (x,y,z) in the ternary composition diagram are within the range of a figure surrounded by straight lines GI, IA, AB, BW, and WG that connect the following 5 points:
point G (0.02a²−1.6013a+71.105, −0.02a²+0.6013a+28.895, 0.0),
point I (0.02a²−1.6013a+71.105, 0.0, −0.02a²+0.6013a+28.895),
point A (0.0112a²−1.9337a+68.484, 0.0, −0.0112a²+0.9337a+31.516),
point B (0.0, 0.0075a²−1.5156a+58.199, −0.0075a²+0.5156a+41.801), and
point W (0.0, 100.0−a, 0.0),
or on the straight lines GI and AB (excluding point G, point I, point A, point B, and point W);
if 18.2<a≤26.7, coordinates (x,y,z) in the ternary composition diagram are within the range of a figure surrounded by straight lines GI, IA, AB, BW, and WG that connect the following 5 points:
point G (0.0135a²−1.4068a+69.727, −0.0135a²+0.4068a+30.273, 0.0),
point I (0.0135a²−1.4068a+69.727, 0.0, −0.0135a²+0.4068a+30.273),
point A (0.0107a²−1.9142a+68.305, 0.0, −0.0107a²+0.9142a+31.695),
point B (0.0, 0.009a²−1.6045a+59.318, −0.009a²+0.6045a+40.682), and
point W (0.0, 100.0−a, 0.0),
or on the straight lines GI and AB (excluding point G, point I, point A, point B, and point W);
if 26.7<a≤36.7, coordinates (x,y,z) in the ternary composition diagram are within the range of a figure surrounded by straight lines GI, IA, AB, BW, and WG that connect the following 5 points:
point G (0.0111a²−1.3152a+68.986, −0.0111a²+0.3152a+31.014, 0.0),
point I (0.0111a²−1.3152a+68.986, 0.0, −0.0111a²+0.3152a+31.014),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines GI and AB (excluding point G, point I, point A, point B, and point W); and
if 36.7<a≤46.7, coordinates (x,y,z) in the ternary composition diagram are within the range of a figure surrounded by straight lines GI, IA, AB, BW, and WG that connect the following 5 points:
point G (0.0061a²−0.9918a+63.902, −0.0061a²−0.0082a+36.098, 0.0),
point I (0.0061a²−0.9918a+63.902, 0.0, −0.0061a²−0.0082a+36.098),
point A (0.0085a²−1.8102a+67.1, 0.0, −0.0085a²+0.8102a+32.9),
point B (0.0, 0.0012a²−1.1659a+52.95, −0.0012a²+0.1659a+47.05), and
point W (0.0, 100.0−a, 0.0),
or on the straight lines GI and AB (excluding point G, point I, point A, point B, and point W).

19. The air conditioner according to claim 1,
wherein
the refrigerant comprises trans-1,2-difluoroethylene (HFO-1132(E)), trifluoroethylene (HFO-1123), 2,3,3,3-tetrafluoro-1-propene (R1234yf), and difluoromethane (R32),
wherein
when the mass % of HFO-1132(E), HFO-1123, R1234yf, and R32 based on their sum in the refrigerant is respectively represented by x, y, z, and a,
if 0<a≤11.1, coordinates (x,y,z) in a ternary composition diagram in which the sum of HFO-1132(E), HFO-1123, and R1234yf is (100−a) mass % are within the range of a figure surrounded by straight lines JK′, K′B, BD′, D′C, and CJ that connect the following 5 points:
point J (0.0049a²−0.9645a+47.1, −0.0049a²−0.0355a+52.9, 0.0),
point K′ (0.0514a²−2.4353a+61.7, −0.0323a²+0.4122a+5.9, −0.0191a²+1.0231a+32.4),
point B (0.0, 0.0144a²−1.6377a+58.7, −0.0144a²+0.6377a+41.3),
point D′ (0.0, 0.0224a²+0.968a+75.4, −0.0224a²−1.968a+24.6), and
point C (−0.2304a²−0.4062a+32.9, 0.2304a²−0.5938a+67.1, 0.0),
or on the straight lines JK′, K′B, and D′C (excluding point J, point B, point D′, and point C);
if 11.1<a≤18.2, coordinates (x,y,z) in the ternary composition diagram are within the range of a figure surrounded by straight lines JK′, K′B, BW, and WJ that connect the following 4 points:
point J (0.0243a²−1.4161a+49.725, −0.0243a²+0.4161a+50.275, 0.0),
point K′ (0.0341a²−2.1977a+61.187, −0.0236a²+0.34a+5.636, −0.0105a²+0.8577a+33.177),
point B (0.0, 0.0075a²−1.5156a+58.199, −0.0075a²+0.5156a+41.801), and
point W (0.0, 100.0−a, 0.0),
or on the straight lines JK′ and K′B (excluding point J, point B, and point W);
if 18.2<a≤26.7, coordinates (x,y,z) in the ternary composition diagram are within the range of a figure surrounded by straight lines JK′, K′B, BW, and WJ that connect the following 4 points:
point J (0.0246a²−1.4476a+50.184, −0.0246a²+0.4476a+49.816, 0.0),
point K′ (0.0196a²−1.7863a+58.515, −0.0079a²−0.1136a+8.702, −0.0117a²+0.8999a+32.783),
point B (0.0, 0.009a²−1.6045a+59.318, −0.009a²+0.6045a+40.682), and
point W (0.0, 100.0−a, 0.0),
or on the straight lines JK′ and K′B (excluding point J, point B, and point W);
if 26.7<a≤36.7, coordinates (x,y,z) in the ternary composition diagram are within the range of a figure surrounded by straight lines JK′, K′A, AB, BW, and WJ that connect the following 5 points:
point J (0.0183a²−1.1399a+46.493, −0.0183a²+0.1399a+53.507, 0.0),
point K′ (−0.0051a²+0.0929a+25.95, 0.0, 0.0051a²−1.0929a+74.05),
point A (0.0103a²−1.9225a+68.793, 0.0, −0.0103a²+0.9225a+31.207),
point B (0.0, 0.0046a²−1.41a+57.286, −0.0046a²+0.41a+42.714), and
point W (0.0, 100.0−a, 0.0),
or on the straight lines JK′, K′A, and AB (excluding point J, point B, and point W); and
if 36.7<a≤46.7, coordinates (x,y,z) in the ternary composition diagram are within the range of a figure surrounded by straight lines JK′, K′A, AB, BW, and WJ that connect the following 5 points:
point J (−0.0134a²+1.0956a+7.13, 0.0134a²−2.0956a+92.87, 0.0),
point K′ (−1.892a+29.443, 0.0, 0.892a+70.557),
point A (0.0085a²−1.8102a+67.1, 0.0, −0.0085a²+0.8102a+32.9),
point B (0.0, 0.0012a²−1.1659a+52.95, −0.0012a²+0.1659a+47.05), and
point W (0.0, 100.0−a, 0.0),
or on the straight lines JK′, K′A, and AB (excluding point J, point B, and point W).

20. The air conditioner according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments IJ, JN, NE, and EI that connect the following 4
points:
point I (72.0, 0.0, 28.0),
point J (48.5, 18.3, 33.2),
point N (27.7, 18.2, 54.1), and
point E (58.3, 0.0, 41.7),
or on these line segments (excluding the points on the line segment EI;
the line segment IJ is represented by coordinates (0.0236y²−1.7616y+72.0, y, −0.0236y²+0.7616y+28.0);
the line segment NE is represented by coordinates (0.012y²−1.9003y+58.3, y, −0.012y²+0.9003y+41.7); and
the line segments JN and EI are straight lines.

21. The air conditioner according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments MM′, M′N, NV, VG, and GM that connect the following 5 points:
point M (52.6, 0.0, 47.4),
point M′(39.2, 5.0, 55.8),
point N (27.7, 18.2, 54.1),
point V (11.0, 18.1, 70.9), and
point G (39.6, 0.0, 60.4),
or on these line segments (excluding the points on the line segment GM);
the line segment MM′ is represented by coordinates (0.132y²−3.34y+52.6, y, −0.132y²+2.34y+47.4);
the line segment M′N is represented by coordinates (0.0596y²−2.2541y+48.98, y, −0.0596y²+1.2541y+51.02);
the line segment VG is represented by coordinates (0.0123y²−1.8033y+39.6, y, −0.0123y²+0.8033y+60.4); and
the line segments NV and GM are straight lines.

22. The air conditioner according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y and z, coordinates (x,y,z) in a ternary composition diagram in which the sum of HFO-1132(E), R32, and R1234yf is 100 mass % are within the range of a figure surrounded by line segments ON, NU, and UO that connect the following 3 points:
point O (22.6, 36.8, 40.6),
point N (27.7, 18.2, 54.1), and
point U (3.9, 36.7, 59.4),
or on these line segments;
the line segment ON is represented by coordinates (0.0072y²−0.6701y+37.512, y, −0.0072y²−0.3299y+62.488);
the line segment NU is represented by coordinates (0.0083y²−1.7403y+56.635, y, −0.0083y²+0.7403y+43.365); and
the line segment UO is a straight line.

23. The air conditioner according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments QR, RT, TL, LK, and KQ that connect the following 5 points:
point Q (44.6, 23.0, 32.4),
point R (25.5, 36.8, 37.7),
point T (8.6, 51.6, 39.8),
point L (28.9, 51.7, 19.4), and
point K (35.6, 36.8, 27.6),
or on these line segments;
the line segment QR is represented by coordinates (0.0099y²−1.975y+84.765, y, −0.0099y²+0.975y+15.235);
the line segment RT is represented by coordinates (0.0082y²−1.8683y+83.126, y, −0.0082y²+0.8683y+16.874);
the line segment LK is represented by coordinates (0.0049y²−0.8842y+61.488, y, −0.0049y²−0.1158y+38.512);
the line segment KQ is represented by coordinates (0.0095y²−1.2222y+67.676, y, −0.0095y²+0.2222y+32.324); and
the line segment TL is a straight line.

24. The air conditioner according to claim 1,
wherein
the refrigerant comprises trans-1,2-difluoroethylene (HFO-1132(E)), difluoromethane (R32), and 2,3,3,3-tetrafluoro-1-propene (R1234yf),
wherein
when the mass % of HFO-1132(E), R32, and R1234yf based on their sum in the refrigerant is respectively represented by x, y, and z, coordinates (x,y,z) in a ternary composition diagram in which the sum of HFO-1132(E), R32, and R1234yf is 100 mass % are within the range of a figure surrounded by line segments PS, ST, and TP that connect the following 3 points:
point P (20.5, 51.7, 27.8),
point S (21.9, 39.7, 38.4), and
point T (8.6, 51.6, 39.8),
or on these line segments;
the line segment PS is represented by coordinates (0.0064y²−0.7103y+40.1, y, −0.0064y²−0.2897y+59.9);
the line segment ST is represented by coordinates (0.0082y²−1.8683y+83.126, y, −0.0082y²+0.8683y+16.874); and
the line segment TP is a straight line.

25. The air conditioner according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IK, KB′, B′H, HR, RG, and GI that connect the following 6 points:
point I (72.0, 28.0, 0.0),
point K (48.4, 33.2, 18.4),
point B′ (0.0, 81.6, 18.4),
point H (0.0, 84.2, 15.8),
point R (23.1, 67.4, 9.5), and
point G (38.5, 61.5, 0.0),
or on these line segments (excluding the points on the line segments B′H and GI);
the line segment IK is represented by coordinates
(0.025z²−1.7429z+72.00, −0.025z²+0.7429z+28.0, z),
the line segment HR is represented by coordinates
(−0.3123z²+4.234z+11.06, 0.3123z²−5.234z+88.94, z),
the line segment RG is represented by coordinates
(−0.0491z²−1.1544z+38.5, 0.0491z²+0.1544z+61.5, z), and
the line segments KB′ and GI are straight lines.

26. The air conditioner according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments IJ, JR, RG, and GI that connect the following 4
points:
point I (72.0, 28.0, 0.0),
point J (57.7, 32.8, 9.5),
point R (23.1, 67.4, 9.5), and
point G (38.5, 61.5, 0.0),
or on these line segments (excluding the points on the line segment GI);
the line segment IJ is represented by coordinates
(0.025z²−1.7429z+72.0, −0.025z²+0.7429z+28.0, z),
the line segment RG is represented by coordinates
(−0.0491z²−1.1544z+38.5, 0.0491z²+0.1544z+61.5, z), and
the line segments JR and GI are straight lines.

27. The air conditioner according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MP, PB′, B′H, HR, RG, and GM that connect the following 6 points:
point M (47.1, 52.9, 0.0),
point P (31.8, 49.8, 18.4),
point B′ (0.0, 81.6, 18.4),
point H (0.0, 84.2, 15.8),
point R (23.1, 67.4, 9.5), and
point G (38.5, 61.5, 0.0),
or on these line segments (excluding the points on the line segments B′H and GM);
the line segment MP is represented by coordinates
(0.0083z²−0.984z+47.1, −0.0083z²−0.016z+52.9, z),
the line segment HR is represented by coordinates
(−0.3123z²+4.234z+11.06, 0.3123z²−5.234z+88.94, z),
the line segment RG is represented by coordinates
(−0.0491z²−1.1544z+38.5, 0.0491z²+0.1544z+61.5, z), and
the line segments PB′ and GM are straight lines.

28. The air conditioner according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments MN, NR, RG, and GM that connect the following 4 points:
point M (47.1, 52.9, 0.0),
point N (38.5, 52.1, 9.5),
point R (23.1, 67.4, 9.5), and
point G (38.5, 61.5, 0.0),
or on these line segments (excluding the points on the line segment GM);
the line segment MN is represented by coordinates
(0.0083z²−0.984z+47.1, −0.0083z²−0.016z+52.9, z),
the line segment RG is represented by coordinates
(−0.0491z²−1.1544z+38.5, 0.0491z²+0.1544z+61.5, z), and
the line segments JR and GI are straight lines.

29. The air conditioner according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments PS, ST, and TP that connect the following 3 points:
point P (31.8, 49.8, 18.4),
point S (25.4, 56.2, 18.4), and
point T (34.8, 51.0, 14.2),
or on these line segments;
the line segment ST is represented by coordinates
(−0.0982z²+0.9622z+40.931, 0.0982z²−1.9622z+59.069, z),
the line segment TP is represented by coordinates
(0.0083z²−0.984z+47.1, −0.0083z²−0.016z+52.9, z), and
the line segment PS is a straight line.

30. The air conditioner according to claim 1,
wherein
the refrigerant comprises trans-1,2-difluoroethylene (HFO-1132(E)), trifluoroethylene (HFO-1123), and difluoromethane (R32),
wherein
when the mass % of HFO-1132(E), HFO-1123, and R32 based on their sum in the refrigerant is respectively represented by x, y, and z, coordinates (x,y,z) in a ternary composition diagram in which the sum of HFO-1132(E), HFO-1123, and R32 is 100 mass % are within the range of a figure surrounded by line segments QB″, B″D, DU, and UQ that connect the following 4 points:
point Q (28.6, 34.4, 37.0),
point B″ (0.0, 63.0, 37.0),
point D (0.0, 67.0, 33.0), and
point U (28.7, 41.2, 30.1),
or on these line segments (excluding the points on the line segment B″D);
the line segment DU is represented by coordinates
(−3.4962z²+210.71z−3146.1, 3.4962z²−211.71z+3246.1, z),
the line segment UQ is represented by coordinates
(0.0135z²−0.9181z+44.133, −0.0135z²−0.0819z+55.867, z), and
the line segments QB″ and B″D are straight lines.
